(19) United States
(12) Patent Application Publication
(10) Pub. No.: US 2015/0149544 A1
(43) Pub. Date: May 28, 2015

(54) CHANNEL-BASED MANAGEMENT OF CALENDAR DATA

(71) Applicant: Jack Ke Zhang, Ijamsville, MD (US)

(72) Inventor: Jack Ke Zhang, Ijamsville, MD (US)

(21) Appl. No.: 14/256,785

(22) Filed: Apr. 18, 2014

Related U.S. Application Data
(63) Continuation-in-part of application No. 14/101,056, filed on Dec. 9, 2013.
Application No. 14/101,056 is a continuation-in-part of application No. 14/101,103, filed on Dec. 9, 2013.
(60) Provisional application No. 61/908,899, filed on Nov. 26, 2013.
(60) Provisional application No. 61/908,899, filed on Nov. 26, 2013.

(51) Int. Cl. H04L 29/06

(52) U.S. Cl. CPC H04L 65/403
USPC 709/204

(57) ABSTRACT

Techniques for providing calendar data to devices associated with subscriptions to an electronic channel may be provided. Data from an electronic calendar associated with a channel is accessed. The channel is associated with a plurality of content items that are transmitted to each of a set of subscriber computing devices for display while the subscriber computing device is in a display state. The set of subscriber computing devices is identified. Each subscriber computing device in the set of subscriber computing devices is associated with a subscription to the channel. Calendar information is transmitted to each of the set of subscriber computing devices. The calendar information identifies an availability in the calendar.

### CROSS-REFERENCE TO RELATED APPLICATIONS

This application is a continuation-in-part of U.S. application Ser. No. 14/101,056, filed on Dec. 9, 2013, which claims the benefit of and priority to U.S. Provisional Application No. 61/908,899, filed on Nov. 26, 2013. This application is a continuation-in-part of U.S. application Ser. No. 14/101,103, filed on Dec. 9, 2013, which claims the benefit of and priority to U.S. Provisional Application No. 61/908,899, filed on Nov. 26, 2013. Each of the above-referenced applications is incorporated by reference in its entirety for all purposes.

### BACKGROUND

Electronic devices provide a variety of useful functions. However, users are not able to continuously actively engage any given electronic device. Consequentially, electronic devices frequently default into a power-saving mode. A power-saving mode may cause a display of an electronic device to turn off or to resort to a pre-defined screen saver. Thus, the display ceases to display timely and pertinent information, and—should the user remain nearby—the utility of the device is frequently greatly diminished.

### SUMMARY

In some embodiments, techniques can provide calendar data to devices associated with subscriptions to an electronic channel. In some embodiments, a method may be provided where data from an electronic calendar associated with a channel is accessed. The channel can be associated with a plurality of content items that are transmitted to each of a set of subscriber computing devices for display while the subscriber computing device is in a display state. The set of subscriber computing devices can be identified. Each subscriber computing device in the set of subscriber computing devices can be associated with a subscription to the channel. Calendar information can be transmitted to each of the set of subscriber computing devices. The calendar information can identify an availability in the calendar.

A communication can be received from a subscriber computing device of the set of subscriber computing devices. The communication can correspond to a request to claim the availability in the calendar. Claiming the availability can include scheduling an appointment during the availability or making a reservation for the availability. The method can include causing the calendar to be updated (e.g. by updating the calendar or sending a communication to a device that indicates that the calendar is to be updated) based on the communication. The updated calendar may no longer includes the availability. In response to receiving the communication, a second communication can be transmitted to at least one subscriber computing device in the set of subscriber computing devices that inhibits subsequent presentation identifying the availability in the calendar.

In some instances, the availability in the calendar is detected, and it can be determined that the availability is associated with a time or date within a defined time period (e.g., within an upcoming two-week period or within a current day). The calendar information can be transmitted in response to the determination. In some instances, a new cancellation corresponding to a calendar time slot associated with the availability may be detected, and the calendar information may be transmitted in response to the detection.

The calendar information can include an image of a calendar. Each subscriber computing device in the set of subscriber computing devices may be in the display state at a time corresponding to the identification (e.g., just prior to the identification or in the display state during a defined time period prior to the identification). The availability is associated with a date, time of day (e.g., start time of a time slot) and/or duration.

Some embodiments of the present application include a system comprising at least one memory that stores computer-executable instructions and one or more processors configured to access the memory. The one or more processors may be configured to execute the computer-executable instructions to collectively at least process the method above.

Some embodiments of the present application include one or more computer-readable non-transitory media storing computer-executable instructions that, when executed by one or more computer systems, configure the one or more computer systems to perform operations according to the method above.

### BRIEF DESCRIPTION OF THE DRAWINGS

FIG. 1 shows a block diagram illustrating a system of providing dynamic content transmissions according to an embodiment of the present invention.

FIG. 2 illustrates an example flow diagram of a process for transmitting content between a computing device and a server according to an embodiment of the present invention.

FIG. 3 shows a block diagram illustrating a system of providing dynamic content transmissions according to an embodiment of the present invention.

FIG. 4 illustrates an example architecture for one or more servers in the dynamic content transmission system, including a publishing server and a content delivery/receiving server, according to an embodiment of the present invention.

FIG. 5 illustrates an example flow diagram of a process for transmitting content to a computing device according to an embodiment of the present invention according to an embodiment of the present invention.

FIG. 6 shows an illustration of a graphical user interface for editing a channel according to an embodiment of the present invention.

FIG. 7 illustrates an example flow diagram of a process for transmitting generating and using a playlist.

FIGS. 8A-8D show illustrations of interfaces configured to receive publisher inputs pertinent to a playlist according to an embodiment of the invention.

FIG. 9A shows an illustration of a graphical user interface (GUI) that allows a user to select channels for inclusion in a user playlist according to an embodiment of the present invention.

FIG. 9B shows an illustration of a graphical user interface (GUI) for providing more detailed playlist customization according to an embodiment of the present invention.

FIG. 10 shows an illustration of a playlist, an identification of a set of content items, an order for the content items, a presentation duration for each content item and a source of each content item.

FIG. 11 illustrates a block diagram illustrating a system on a computing device for triggering a presentation of content channels according to an embodiment of the present invention.

FIG. 12 illustrates an example flow diagram of a process for presenting channel content items according to an embodiment of the present invention.

FIG. 13 illustrates an example flow diagram of a process for receiving displaying interactive channel content at a computing device according to an embodiment of the present invention.

FIG. 14 illustrates an interaction between a computing device and server for displaying a destination according to an embodiment of the present invention.

FIG. 15 illustrates an example flow diagram of a process for updating a channel-associated calendar based on subscriber input according to an embodiment of the present invention.

FIG. 16A shows an example of a displayed content item with a calendar option.

FIG. 16B shows an example of displayed calendar content displayed in response to selection of a calendar option.

FIG. 16C shows an example of a reservation interface displayed in response to a user selection of an availability indicator.

FIG. 17 illustrates an example flow diagram of a process for updating a channel-associated calendar based on subscriber input according to an embodiment of the present invention.

FIG. 18 shows an example of a displayed content item identifying a calendar opening.

FIG. 19 illustrates an example flow diagram of a process for using a channel-associated calendar to update a user calendar according to an embodiment of the present invention.

FIG. 20 illustrates an example flow diagram of a process for identifying a channel-associated physical location according to an embodiment of the present invention

FIG. 21 illustrates an example flow diagram of a process for selecting and presenting channel content based on a location of a computing device according to an embodiment of the present invention.

FIG. 22 illustrates an example flow diagram of a process for availing ordering capabilities from each of a set of restaurant channels according to an embodiment of the present invention.

FIG. 23 shows an example of a displayed content item including a variety of options.

FIG. 24 shows an example of a displayed identifying action options and alerts for a plurality of channels.

FIG. 25 illustrates an example flow diagram of a process for using channel technology to distribute electronic pet identification cards.

FIG. 26 illustrates an example flow diagram of a process for managing channel-associated points according to an embodiment of the present invention.

### DETAILED DESCRIPTION

In some embodiments, systems and methods are provided for allowing third parties (e.g., “publishers”) to specify content items to be transmitted, via channels, to a plurality of devices. Content items can include, e.g., video, images, text for various purposes product information, promotion details or institution-level notifications and can dynamically change in time. In one instance, a publisher can periodically update content (e.g., images, videos or text) based on, e.g., current or future promotions, new product launches or recent events. In some embodiments, a publisher can upload content to server from a memory storage, such as the hard disk of a computer. The publisher can provide instruct via an to automatically upload and publish content from a predefined source, such as the featured product image on a home page of an online store associated with the publisher. When a new image is added to the home page, the image can then be automatically uploaded to and displayed in the publisher channel. One or more content items can then be transmitted via a channel to devices of subscribers of the channel (e.g., simultaneously or asynchronously). When inactivity is detected at a particular subscriber's device, the device can present one or more content items from the channel. In some instances, the channel's content item(s) is sequential to or interleaved with content items from another channel.

Channels can facilitate content interaction. For example, a user can enter a particular type of input (e.g., selection of a specific key) to indicatively request more information about the content. A publisher can specify a destination (e.g., a webpage, such as an ordering webpage, an event-registration webpage, an informational webpage, or a file stored on the device) for each of one or more content items. In some cases, there can be a default destination to a content item if no instruction is given by the publisher. The user input can cause the device to route to the destination. Displays and/or interactions with one or more content items can be tracked to support generation of, e.g., marketing statistics for a publisher.

In a non-limiting example, a publisher may generate a golf channel. The publisher can enter channel-defining information about the channel, such as a title, description, and keywords. The publisher can further identify content items (e.g., images or videos) for the channel. In one instance, the publisher can periodically upload content items (e.g., images identifying results of recent golf tournaments, videos promoting sales on golf clubs, text about golfers, or text and images identifying weather conditions at nearby golf courses) to a server. In one instance, the publisher can identify a content source (e.g., a webpage, such as a home page of an online store, as discussed above).

The golf channel can be identified to one or more users (e.g., via an automatic recommendation, a subscription-recommendation push from the publisher to specific user identifiers or email addresses, SMS messages, social media, or as a result for user queries). The users can then subscribe a device (e.g., a workstation, computer, or mobile electronic device) to the channel. Once subscribed, content items from the channel can be displayed on the device when a trigger event is detected. For example, it can be detected that the user's device (e.g., workstation, mobile device) is idle, that a key on a keyboard of the user's device has been selected, that a mobile user device is connected for charging, or that a device has completed or is working on a task (e.g., a phone call has been completed).

Content items for the golf channel can be transmitted from the server to the user's device (e.g., periodically, when the device is entering a channel state, when the device is in a channel state, or when the device is otherwise available to accept content items). When the device enters a display state, one or more content items (e.g., images) from the golf channel may display on the device.

A publisher can further identify a destination (e.g., a webpage) for each of one or more content items. Particular input actions can cause the user device to be directed to the destination. For example, pressing a particular key during display of a content item can cause the user device to request and display a destination webpage that provides additional information pertaining to the item displayed.

A “subscription request” may be a message requesting content items from one or more channels. In some embodiments, the subscription request may be received from a computing device at a server.

A “channel” may be a pipeline between a server and a computing device that provides one or more content items to the computing device. A computing device may be in a channel state when the computing device is able to receive one or more content items via the channel. Similarly, the computing device may be in a display state when the computing device is able to display the one or more content items the computing device received while in the channel state. In a non-limiting example, an action (e.g., a one-button action, such as pressing F10) can cause a device to enter into display state (e.g., regardless of the current state the computing device is in). In another or same example, a same or different action (e.g., a one-button action, such as pressing F9) can cause a device to temporarily suspend the display state during a channel-content display. Such suspend action may also or alternatively be used to prevent the display state from occurring (e.g., even when a device is not in the display state at a time of the suspend action). To illustrate, a cash-register user device may be used to display channel advertising content to one or more customers. When the cashier is processing an order, by pressing F9, the display can be prevented from showing advertising content. In some instances, the suspension can stop when the F10 button is pressed.

A “device playlist” may include one or more identifiers, where each identifier can identify one or more content items received through a channel that are displayed by the computing device or can identify a particular channel. For example, the playlist may include one identifier for an item from the golf channel, two identifiers for two items from a company events channel, and one identifier for an item from an internal medicine channel. The playlist may also include one or more playlist customization parameters to define whether an identifier for a particular channel or content item is active (e.g., in a playlist, presented for display during a display state) and/or associate a priority (e.g., high/low priority, ordered priority) of the item, such that higher priority content items and/or channels may display before other content items and/or channels.

A “channel playlist” may include one or more identifiers, where each identifier can identify one or more content items to be provided within a particular channel. For example, a channel playlist for a jazz channel can include an identifier for each of: five audio-video tracks, a table listing upcoming jazz events and an image with an advertisement for composition software. The playlist may include a sequence or order. In some instances, a portion of a device playlist includes a portion of or all of a channel playlist (e.g., such that it is played in sequence without interruption or such that it is interleaved with other channels' contents). A publisher may be able to set the channel playlist or input information (e.g., content-item prioritization) that can be used to generate the channel playlist.

A “content item” or “content” (used interchangeably) may include an image, video, stream of data, audio, text, or other data provided to a computing device in an electronic format. As shown, content items can include product information, promotion details, or institution-level notifications and can dynamically change in time. In one instance, a publisher can periodically update content based on current or future promotions, new product launches, or recent events. In another instance, when a channel is programmatically linked to a source, the content can be updated when a designated source, such a webpage, receives new updates.

An “event” may be an indication of a changed status at a computing device. For example, an event can include an indication that content items have been transmitted via a channel from a server. In another example, an event can include a notification that the computing device has entered a channel state for receiving content items or a display state for displaying content items. An event may also include a specific key on a key pad being pressed on a computer. An event may also include when an image displayed on a mobile device (or a portion of the image or a portion of a screen) is pressed by a user, which may indicate the user is interested in getting more information.

A “destination” may be a location on a network page that is provided to the computing device or a directory location on the computing device memory by the server when the user of the computing device interacts with a content item. For example, a content item may include an item for sale, such as a pair of shoes. When a specific interaction with the computing device is detected, the computing device may be directed to the destination that sells the shoes, including a network page at a particular uniform resource locator (URL).

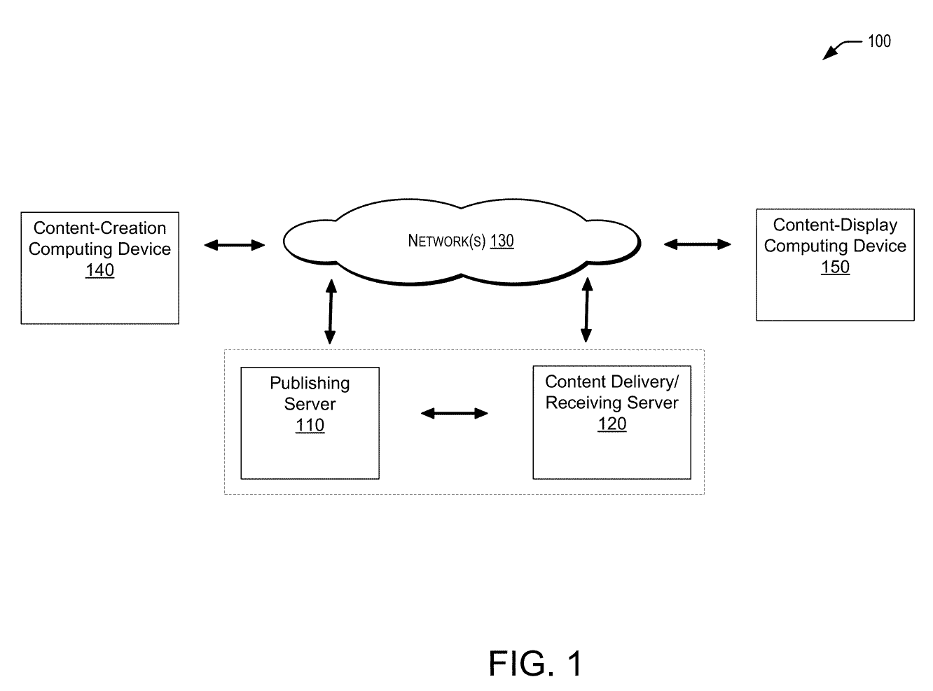

FIG. 1 shows a block diagram illustrating a system for providing dynamic content transmissions according to an embodiment of the present invention. In a non-limiting example, the system 100 can include a publishing server 110, a content delivery/receiving server 120, a network 130, a content-creation computing device 140, and a content-display computing device 150. It will be appreciated that the publishing server 110 and a content delivery/receiving server 120 may be combined into a single server (e.g., as illustrated by the dashed box around the publishing server 110 and content delivery/receiving server 120). Further, while disclosures herein may refer to a single server or computing device, embodiments can be extended to apply to multiple (e.g., joint-operation) servers or computing devices, including mobile computing devices such as mobile phones and tablet computers.

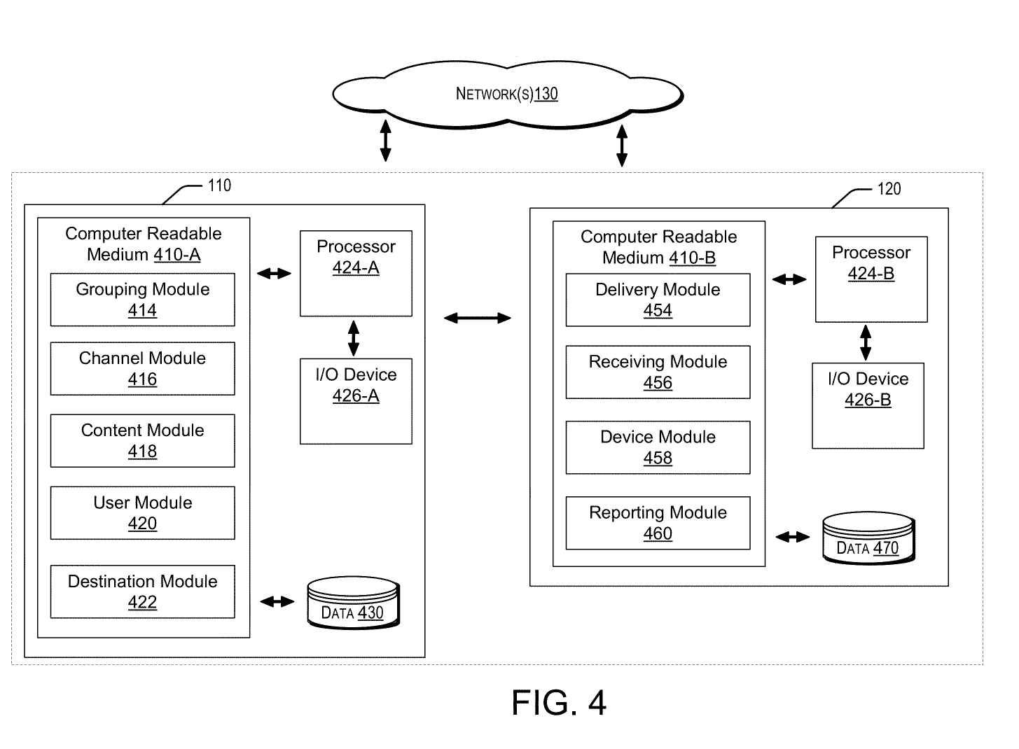

The publishing server 110 can be configured to receive content, associate a destination with the content, generate channels and/or groups, enable channel playlists (e.g., a compilation of content items) to be updated for a device, and provide the content to a content delivery/receiving server 120. Details and function of the publishing server 110 can include those as discussed at greater length in reference to FIG. 4.

The content delivery/receiving server 120 can be configured to provide content items to a computing device, manage a device's profile, a user's profile, provide an administrative platform for content provider devices, and/or manage credentials. Details and function of the content delivery/receiving server 120 can include those further discussed in reference to FIG. 4.

In some embodiments, the publishing server 110 and a content delivery/receiving server 120 may be implemented as a single server with multiple interfaces (e.g., one interface for a publisher, one interface for a user/consumer), a single server with a single interface (e.g., one interface for both a publisher and for a user/consumer, with authentication functionality to distinguish the users), or multiple servers with one or more interfaces.

The network 130 can include one or more networks that allow the publishing server 110, content delivery/receiving server 120, content-creation computing device 140, and/or content-display computing device 150 to communicate. For example, the computing devices may access an application (e.g., a web browser) to communicate with one or more servers via the network 130. In some aspects, the application may be hosted, managed, and/or provided by a computing service or service provider. The network 130 may also include any one or a combination of many different types of networks, such as cable networks, the Internet, wireless networks, cellular networks, private and/or public networks. In some embodiments, the computing devices can interact with servers over a landline phone, via a kiosk, or in any other manner.

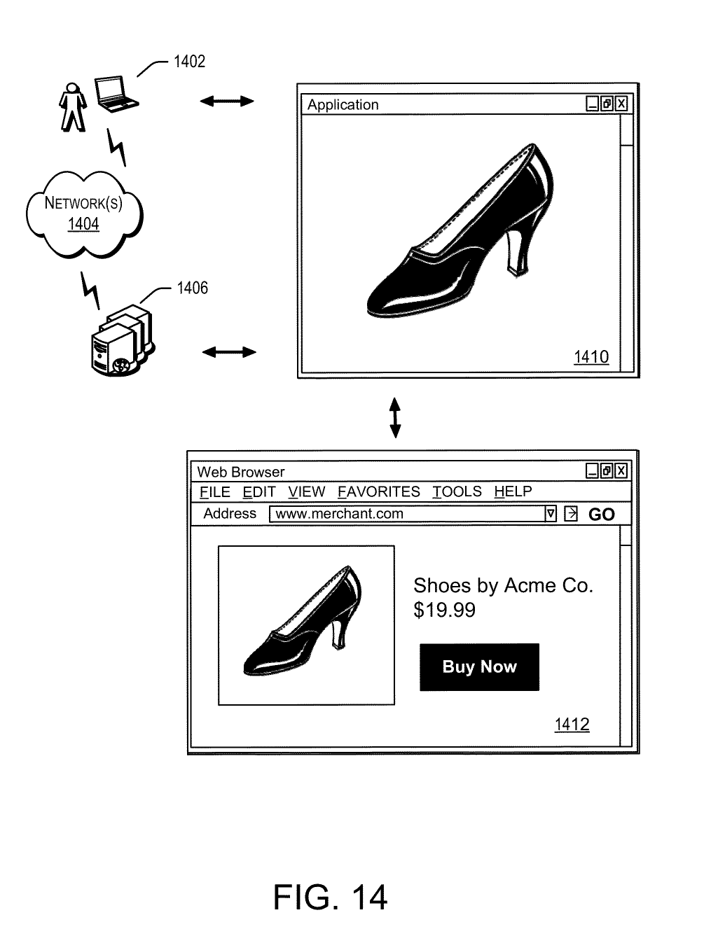

The content-creation computing device 140 can generate content and provide the content to the content delivery/receiving server 120. Details and function of the content-creation computing device 140 can include those discussed at greater length in reference to FIG. 14.

The content-display computing device 150 can automatically request and/or receive content from a content delivery/receiving server 120 and display the content for a user at a computing device. Details and function of the content-display computing device 150 can include those discussed at greater length in reference to FIG. 14.

A user web portal component can further be provided, which can allow a user to enter information pertaining to channel subscriptions. The web portal component can be configured such that a user can access the portal component irrespective as to whether he is using a device that has been, is or will be used to display channel content. The web portal component can nonetheless allow a user to identify information related to channel display. For example, he can identify details for a user profile (e.g., contact information or interests) or channel subscription (e.g., requesting, modifying, removing or prioritizing channels). One, more or all of user inputs described herein and/or reports to a user can be provided via the web portal. Similarly, a publisher may be able to upload and manage content items and channels and view reports pertaining to channels using a web portal.

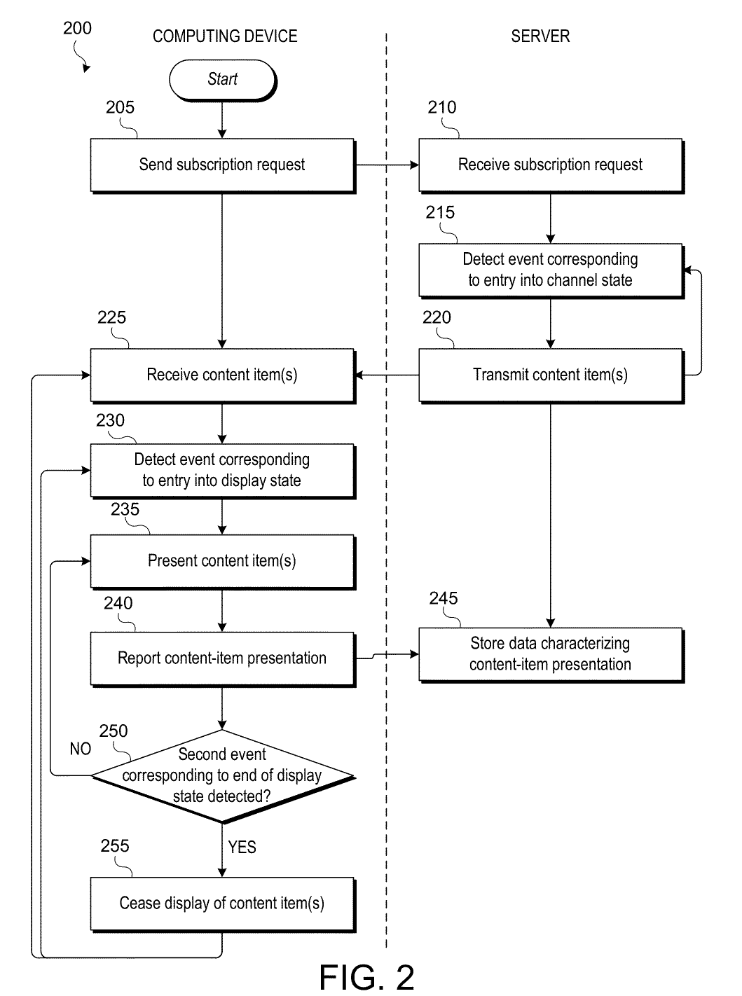

FIG. 2 illustrates an example flow diagram of a process 200 for displaying of a channel's content items on a computing device. As shown, various portions of process 200 can be performed by a computing device (e.g., a content-creation computing device 140, a content-display computing device 150), and other portions can be performed by a server (e.g. a publishing server 110 and/or a content delivery/receiving server 120).

In some embodiments, the user may browse to a webpage and/or graphical user interface (GUI) to find content item(s) and/or channels provided by a server. For example, the user can operate a computing device to search for a channel (e.g., a “Recipes” channel). In other examples, the user can receive a recommendation for a channel (e.g., automatically based on a user profile indicating user's interest, user's interaction history with other content, other channels considered by the user or subscribed to by the user, or based on a publisher's invitation to join the channel). The user may register for or request one or more content items associated with one or more channels.

The process 200 may begin at block 205 when a computing device sends a subscription request to a server (e.g., after a content-displaying computing device installed an application with instructions that, when executed by one or more processors, can perform a method described herein). The subscription request can be a message including device identification and channel identification information from a computing device to a server that requests one or more content items to be transmitted to the computing device. In a non-limiting example, the subscription request contains information about the requester or request, including one or more identifiers of the user (e.g., name, email address, phone number), identifiers of the computing device (e.g., an IP address), identifiers of a type of device (e.g., mobile device, laptop, desktop, tablet or particular brand thereof), identifiers of the content item(s) and/or channel, operating system(s), channel-related preferences (e.g., when content items are to be received, a limit on a number of content items, a type of content item such as image or video, whether to accept sound-inclusive content items, size of screen, a number of current channel subscriptions, historical time in display mode, where the channel will be ranked amongst other channels, etc.), or other information.

In some embodiments, the subscription request may correspond to a user for one or more computing devices, rather than corresponding with a particular computing device. For example, the server may associate a user identifier dynamically with a computing device (e.g., through providing authentication credentials to a login webpage). The server may determine the type of computing device that the user is operating at the time (e.g., by interacting with the device, by requesting information from the user) and provide content item(s) to the computing device based in part on the dynamic determination of the computing device.

The computing device may send the subscription request to a server. The computing device accesses an application (e.g., a web browser, a software “app” on a mobile device) to communicate with one or more servers via the network to submit the subscription request. The application can present a form (e.g., via an application programming interface (API)) or similar type of graphical user interface (GUI) to accept user input that is relevant to the one or more content items. The user may interact with the application and prompt a generation of a subscription request that includes the information. The subscription request can be transmitted to the server via a network (e.g., the Internet). In other examples, the user can send a communication message (e.g., email, phone call) that includes the relevant information, which the server can analyze (e.g., parse, store).

At complimentary block 210, a server receives the transmitted subscription request. For example, the server may receive the completed form from the software application at the computing device and store the information in a data store (e.g., for future use).

In some instances, the server extracts data from the subscription request (e.g., a user or device identifier) to search for a user profile amongst a set of profiles. When no profile is found, a new profile may be generated. Profile data can be based on inputs received from the user (e.g., during a request for the channel service or a subscription request), automatically detected data (e.g., detected from a subscription request), and/or data retrieved from another server (e.g., a social networking server). For example, a user may have provided login information for a social networking website, and a channel-providing service may then retrieve account data associated with the social network to include in the profile.

Each profile can include, for example, some or all of: a user's name, an identifier of each of one or more devices, a user's phone number, a user's email address, a type of each of one or more devices, an operating system of each of one or more devices, an identification of each of one or more channels that a user is subscribed to, one or more user preferences (e.g., display durations for individual content items, across-channel sequence type, triggers for entering display state, etc.), a point total, interests, login information (e.g., for a social networking website, for an email account and/or for a calendar account), identifications of one or more contacts (e.g., email addresses), etc.

In some embodiments, the server may establish one or more rules corresponding with the subscription request. For example, when the subscription request includes a request for weather information when the device enters an idle state, the server may generate a rule that will be activated when an event notification is received that identifies that the device has entered an idle and/or display state. The rule can include establishing a connection to initiate a transmission of content item(s) via a channel, transmitting the content items, or any other commands that may be activated based in part on the subscription request.

At block 215, the server detects an event corresponding to entry into a channel state. The event may include an indication of a changed status at a computing device. For example, the event may include an indication that the computing device has access to the network and can accept content from the content delivery/receiving server 120. The communication can be received at the server from the computing device upon entry into display mode, during display mode, upon entry into a channel mode, during channel mode, after a certain amount of time (e.g., a reoccurring event every hour), upon receipt of a subscription request, or other communications that would notify the server of such an event.

The event may also or alternatively include an indication that a new content item was created, received or uploaded for a channel. For example, a publisher can provide (e.g., upload) a new content item to a server and/or data storage. The server may receive a notification that the content item(s) is available for transmission and/or placement into a channel. In other examples, the content item(s) can correlate with webpage content, such that the event can be identified when the webpage content changes and/or new webpage content is added. The server may incorporate the new webpage content with the channel.

In some embodiments, the event includes a notification of a temporal event. A temporal event can include a particular time during a day/week (e.g., at midnight each night). In some examples, the temporal event is the time between when the content item is received at a computing device (e.g., updated once per day) and the current time, the time a channel is updated (e.g., updated every hour), the moment a bill or subscription fee is paid, or other events that may correspond with a particular time or interval.

The event may also or alternatively include a notification that a subscription has been received. For example, the detected event may include a notification that a subscription request form was accessed or completed by a user operating the computing device, a computing device provided credentials to access a user account, the computing device completed a registration process to receive content item(s) from the server, and other similar subscription events.

At block 220, the server transmits the content item(s). For example, the content delivery/receiving server 120 can receive content items from a publishing server 110 and transmit the content item(s) to a computing device. The transmitted content items may include all content items associated with a particular channel, a subset of the content items in a channel, only new content items, recently submitted content items (e.g., associated with a particular fixed time period, a publisher-defined time period, a user-defined time period), or a specific number of content items (e.g., fixed or defined by a publisher/user).

In some embodiments, the server may maintain a record of transmissions associated with content items. For example, the server can review the record to determine when a content item was received from a publisher and/or when the server transmitted the content item to the computing device. The record may be associated with an identifier for the content item (e.g., content item #100 was transmitted January 2 at 1:00 PM to device #200). The server may analyze the record before transmitting the content items to the computing device and/or limit the transmissions based in part on the analysis (e.g., only transmit items to the device once per day).

In some embodiments, the computing device may be associated with user preferences, and the server may identify the preferences before transmitting the content item(s). For example, a computing device may identify that a particular user does not want to receive football scores at a work computing device, may identify that a user is not interested in promotion content items for a particular brand of item, or may not wish to receive video items. The server may analyze preferences for the computing device to determine which types of content items to send before the content item(s) are transmitted.

The transmission of the content item may include additional information associated with the content item, including an identification of a destination (e.g., URL or HTML identifier). In another instance and/or later in the process, upon receiving a selection of the content item by the computing device, the server may provide an identification of a destination. For example, the computing device can transmit a communication (e.g., including an identification of the content item) to the server. The server may respond to the communication with an identifier of the destination.

At block 225, the computing device receives the content item(s). In one embodiment, the content item(s) may be received by the computing device and/or saved at the computing device. When received, the content item(s) can be hidden from other programs behind active content. In some examples, active content may include one or more software applications that the user is interacting with on the computing device. In other examples, the active content may include a default screen (e.g., desktop) or background.

In some embodiments, the content items are stored in a data store (e.g., while the active content is displayed and the content items are hidden). For example, the data store can include a particular file structure to store and organize the content item(s) (e.g., by file name, date, size, file type, channel-type). In another example, the data store can include a single location (e.g., folder, hash table, queue, array, stack) where all content is stored. The content items may be sorted or retrieved dynamically from the data store. In yet another example, the data store can be a transitive data store where content items are stored temporarily (e.g., cache) and/or deleted after a determined amount of time.

In some embodiments, one or more content item(s) can be stored in association with one or more timestamps. For example, the timestamp can identify a time when the content item was transmitted to a computing device, a time that the content item was received or detected at the computing device, a time when the item was uploaded at a server from a publisher, a time when a content item was displayed by the computing device, or a time when a user interacted with a content item and visited a destination associated with the content item. In another example, a timestamp can be included with an identifier of a channel or other identifying information.

The content item(s) may include an association with an expiration time. The expiration time can be determined based in part on publisher input (e.g., allow use during life of a copyright or license, allow use for 1 month because the user paid for 1 month of use, remove the item when the item is no longer the latest product available), user preference (e.g., available during employment with a company, during a fantasy football league seasons, or during a holiday season or a promotional period), or fixed (e.g., expires after 1 week from transmission). The expiration of a content item can help ensure that the content items displayed at the computing device are relatively new and/or relevant to the user. The expiration of a content item may also affect local storage requirements by limiting the number or size of content item(s) stored at a computing device to a particular amount of storage available. In some embodiments, the expiration of a content item may be affected by a particular event at the computing device (e.g., remove content items when computing device is restarted). In some embodiments, the expiration of a content item may be based on an absolute time (e.g., December 31, the last day of the month), a time uploaded by the publisher, a time that is received from a third party, or a time that is received from the user (e.g., remove holiday content after January 1).

In some embodiments, the computing device may include remote updates by the content delivery/receiving server 120 without substantially interfering with the processing actively running on the computing device. For example, the server may have access to a portion of the memory at the computing device, so that the server may add or remove the information stored in the memory without interacting with or waiting for confirmation from the computing device that those items can be added or removed. In another example, the server may review central processing unit (CPU) usage or other resources at the computing device and update the content item(s) when a device is not using some portion of its resources (e.g., items removed when the computing device CPU is running at 5% usage).

At block 230, the computing device detects an event corresponding to entry into a display state. For example, when the event includes some predetermined amount of time and/or time period of inactivity at the computing device, the computing device may enter a display state. For example, the inactivity at a device could include a lack of interaction between a user and a computing device, including key strokes, cursor movements, selections, dragging, tapping, and/or clicks. In another example, the inactivity can include identifying when particular programs or software applications are not active (e.g., video conference call, teleconference call, streaming media) to help ensure that the device is idle or otherwise less used for a particular amount of time. In another example, an event corresponding to entry into a display state may be termination of a phone call on a mobile phone, or connection of a power charging device to a mobile computing device.

The predetermined amount of time of inactivity at the computing device can include a predetermined amount of time, such as 10 seconds, 30 seconds, 1 minute, 3 minutes or 1 hour. In some examples, the time period can be specified based on settings on the computing device (e.g., power-saving settings) or based on global or specific channel data (e.g., a server can define that the time period is 1 minute, or a user can enter input specifying a time after which channel content items should be displayed). In some examples, the predetermined amount of time can include the amount of time after an activity or event has ended (e.g., presentation of content items could begin after a call has ended on a mobile device).

In another example, the event can correspond to the user's request to enter a display state. In some embodiments, when the computing device is a desktop or similar device associated with a keyboard I/O device, the computing device may enter a display state in response to an interaction. For example, the interaction may include a selection of a predefined key, like an F10 key to enter the display state, and an F9 key to exit the display state. In some embodiments, the user may press Alt-Tab to activate a graphical user interface (GUI) that allows the user to provide commands to enter and ESC to exit the display state through the GUI.

At block 235, the computing device presents the content item(s). For example, the computing device may display the content item so that the content item is actively running on the computing device on top of the previously actively running application. The content item may be actively running when a content item is presented at the computing device. For example, the graphic, text, or series of graphics (e.g., in a video) can be presented on all or part of a display. When portions of the display are used to provide different content items at the same time, one or more of the portions of the display may provide one or more content items. When the content item includes sounds (e.g., an audio track, an audio/visual file), the sound can be output via a speaker at the computing device. In some examples, portions of the display at the computing device can be turned into a link area, such that an input corresponding to the area (e.g., a cursor click on the area) can cause destination information to be presented (e.g., an ecommerce page associated with the item presented as a content item). In some examples, user profile information can determine specific content presented to a user device. For example, a user may specify a number of companies' stocks in a profile of the user, which can cause the device to display these stocks' information in a channel. In another example, a fantasy sport user can specify, in a profile of the user, a number of football players to follow, which can cause the device to display channel content that includes these specific players' information.

The content item(s) provided by the channels may be shown sequentially, in a particular order, or based on a priority rating provided by the computing device (e.g., based in part on a playlist or instructions from a server, user, or computing device). For example, if a user is concurrently subscribed to two channels on one computing device, including a medicine channel that provides information on new drugs and clinical trials and a company event channel that provides information from a user's employer about new events provided by the company, the user may choose to show the content items associated with the medicine channel before the any content items associated with the company event channel.

In some embodiments, the computing device may determine which items to present. For example, upon detecting an event to visit a destination associated with a content, the computing device may access the stored location of the received content items and present (e.g., display on the entire screen or a portion of the screen associated with the computing device, play audio content items via a speaker) any received content items. The presented content items can include a sequential or interleaved presentation of all content items received from the server, all content items associated with a particular channel, a subset of the content items in one or more channels, only new content items (e.g., content items received in the most recent transmission), recently received content items (e.g., over the past day regardless of the number of content items received the most recent transmission), or a specific number of content items.

The determination of which content items to present can consider a variety of factors. For example, one or more channels may be ranked (e.g., based on the user's priority for viewing the content associated with the channel). The content items associated with a particular highly-ranked channel may be displayed before other channels that are not as highly-ranked. In another example, the content items within the channel may be ranked (e.g., based on the user's priority for viewing particular types of content within a particular channel, including weather content items before player statistic content items in a golf channel), and the content items associated with a particular high ranking in the channel may be displayed before other content items in the same or other channels that are not as highly-ranked.

In some embodiments, the determination of which content items to present can be based on a user's past interaction with the computing device. For example, a content item associated with women's shoes may be displayed and selected by the user, directing the computing device to access the destination associated with the content item to purchase the shoes (e.g., an ecommerce shopping webpage). The computing device can determine that the user is more interested in women's shoes than weather. In a subsequent presentation of content items, the content items associated with women's shoes, women's fashion, and/or another related topic can be ranked higher than other content items and displayed before other content items.

In some embodiments, the presenting of content items at the computing device can be associated with a temporal factor. For example, the temporal factor can include a time (e.g., an hour, minute, day, or date) at which the content item was uploaded to or otherwise received at the server (e.g., from a publisher), a time at which the content item was transmitted to or received at the computing device, a time at which the content item was displayed at the computing device, or the time at which the content item was transmitted from the server to the computing device. These times can be used (globally or within a channel) to, e.g., bias towards showing older content items first or showing newer content items first. In some examples, the higher-ranked content items may be presented in association with the time. In some examples, the content items can be presented in association with upcoming sales, events, or other specified times.

In some embodiments, the ranking of a content item can help determine other factors associated with presenting the content item. For example, the highly-ranked content items can include displaying or presenting the content item for one second longer than the content items that are not as highly ranked. In another example, the highly-ranked channels can include displaying the content item more than once (e.g., looped, repeated) before other channels are presented.

The determination of which content items to present may include a random selection and/or sequential ordering. For example, the content items may be presented in the order that the items were received from the server during the channel state (e.g., most recent items first). In another example, the content items may be presented based on alphabetical listing, identifier ordering, or purely random ordering.

In some embodiments, the server may determine which items to present (e.g., instead of the computing device). For example, the server may determine which content item to place first and for how long, determine which content item to place second, and transmit one or more content items based on the determination to the computing device. The server may also determine whether to loop items and/or the time duration to present the content items, so that the computing device merely presents the items in the order it is given by the server.

The computing device may present content items from a device playlist. A device playlist may include one or more identifiers, where an identifier can identify one or more content items received through a channel that are displayed by the computing device. For example, the playlist may include one identifier for a content item from the golf channel, two identifiers for two content items from a company events channel, and one identifier for a content item from an internal medicine channel.

In some embodiments, the device playlist may be identified before the computing device sends the subscription request to the server (block 205). For example, the computing device can identify identifier(s) for one or more channels to add to the playlist, identifier(s) for one or more types of content items in a channel, or identifier(s) for individual content items. The computing device may associate the channel, types of content items, or individual content items with a priority and/or ranking, so that particular content items or channels are presented more/less frequently, for a longer/shorter duration, at a particular time, etc. The identified priority and/or ranking of the channel, type of content item(s), or individual content items can be transmitted via a channel (block 220).

In some embodiments, the playlist may be generated, modified, or appended to an existing playlist. The server may include the new identifiers to the playlist intermittently or at a particular time (e.g., at the beginning, middle, end).

The playlist may be used to help determine which content items to present. For example, when using a playlist, if the play stops, the content items may resume at the same point in the playlist next time. In another example, when using a playlist, if the play stops, a new playlist may be generated and/or used.

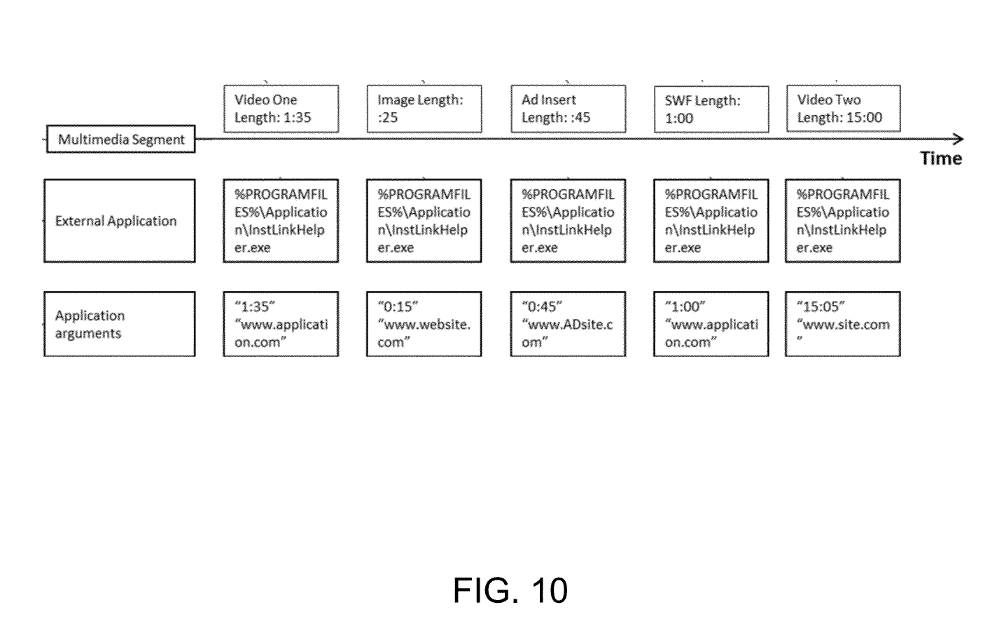

The playlist may also include playlist customization to define whether a particular channel or content item is active and/or associated with a priority (e.g., high/low priority, ordered priority) of the item, such that higher priority content items and/or channels may display before other content items and/or channels. Additional details and functions of the playlist can include those as discussed at greater length in reference to FIGS. 10-13.

Returning to block 235, the content item(s) can be presented for a particular duration. For example, when the content item is a video clip and/or audio segment, the content item can be presented for the duration of the video or audio segment (e.g., 5 seconds, 1 minute). The content item may be repeated or restricted to present the content item for more or less time than the full duration available as well. In another example, when the content item is a still image, the content item can be presented for a fixed duration determined by a publisher, server administrator, and/or user, or presented for a fixed duration time (e.g., all still images are presented for 10 seconds). In yet another example, the content item(s) are presented based in part on the ranking of the content item(s) or channels, so that the higher-ranked content items or channels are presented for a longer or dynamic duration in comparison to the lower-ranked content items or channels.

The duration may be affected by the amount of text or information displayed by the content item. For example, when the content item displays more than 100 words of text, the content item may be displayed for at least 30 seconds so that the user can have time to review (e.g., read, comprehend) the text presented.

In some instances, a displayed content item can be saved to a user device (e.g., into a file folder), such that the content item can be subsequently retrieved locally at the device. Such saving can occur in response to a user action (e.g., a click of a particular button or touching a screen). In some instances, a publisher can specify content items for which saving is to automatically occur and/or for which saving is to be allowed. Saving a content item can be of particular interest, e.g., when a content item includes a promotion or discount. A user can then retrieve the item to review promotion details and/or use the discount. For example, a user can indicate that a content item with a discount coupon for a restaurant is to be saved. When the user later visits the restaurant, the saved item can be automatically retrieved (e.g., in response to detecting that a device of the user is geographically near the restaurant) or retrieved upon user request to redeem the discount. A user device can report the information associated with the saving, retrieving and/or redeeming actions to server 110 and/or 120. The information can include times of the saving, retrieving and/or redeeming.

In yet another embodiment of the invention, a user can send a saved content item to another person (e.g., to refer that person to this restaurant). A user device can track the activities associated to the referral (e.g., such that a user can be credited with the referral or such that a publisher can be informed as to an occurrence of the referral).

In some embodiments, one or more reward points can be assigned to activities of a user. Reward points can be associated with a specific channel or a group (e.g., all) of channels. Whether reward points are awarded and/or a quantity of reward points awarded can be based on an amount of time displaying channel content, a number of interactions with the displayed content (e.g., requesting a destination, saving a content item, and/or sending a content item to another user), a number of content destinations visited, a frequency of referring content to others, a number of other users invited by the user to a channel or to a channel-viewing application, etc. The reward points can be updated and periodically displayed on a screen of a user device and a user web portal. Reward points can be redeemed, e.g., online or offline for discounted or free products and services. In cases of online product advertising displayed on user computing device, a server can collect information associated with user activities and purchases as a result of user exposure to displayed adverting through data from sources such as the API's from destination websites. This information can be sent (in a user-specific or user-aggregated manner) to a publisher.

In some embodiments, the computing device may present more than one content item at a time. For example, the computing device may show a first content item in the upper right-hand corner of the screen, a second item in the lower-right hand corner of the screen, and a third content item along the left-hand side of the screen. The computing device or server may determine where content items are placed (e.g., based in part on priority, channel affiliation, the timestamp of when the transmission was received from the server, timestamp of when the content item was received from a publisher). In other embodiments, the computing device will present one content item at a time (e.g., one visual image content item on the screen, one audio content item played via speakers at the computing device).

In some embodiments, the computing device may present additional information with the content item. The additional information may identify the source information of the content item (e.g., publisher, timestamp), explicitly identify a destination associated with the content item (e.g., the location on a network page that is provided when the computing device interacts with a content item), channel information (e.g., publishers, subscribers, last updated information), or other relevant information. The information may be presented in a layered format on top of the content item on the display, next to the content item, overlapping with the content item, interleaved with the content item presentation, or otherwise organized by the computing device and/or server.

At block 240, the computing device reports the occurrence of content-item presentation to the server. The report can include any metrics associated with the channel state and/or display state at the computing device. The report can identify information for the content-item presentation, including the computing device that received the content items during the channel state, the computing device that presented the content items during the display state, an identifier of a presented content item, a channel, any interaction (e.g., whether a destination was visited, whether the visit tied to a purchase), a total time in a display-mode session, or other relevant information for a publisher and/or server. The report can be transmitted to a server and/or publisher after presentation of each content item, at routine intervals, or at an end of a display state.

At block 245, the computing device stores data characterizing the presentation of the content item(s). This stored data can immediately or subsequently be used by the server or another device (e.g., having received the data from the server). A data can include a number of times a content item was displayed, a number of times content from a particular channel was displayed, the duration that a content item/channel was displayed, whether users selected an identifier of a destination, or whether users purchased items subsequent to presentation of the content item.

In some embodiments, the server may use the data to identify patterns, statistics, and/or reports. For example, the data can generate one or more new statistics and/or modify one or more existing statistics (e.g., to increment a count) based in part on the content-item presentation, including statistics for a given channel or content item. The patterns, statistics, and/or reports can also be stored with the original data.

At block 250, the computing device determines whether a second event corresponding to the end of the display state is detected. For example, the computing device may no longer be inactive. The event may include, for example, a keystroke, cursor movement, voice command, selection of a content item that directs the computing device to a destination, or a pre-determined amount of time. In some embodiments, for example, the computing device ceases display of the content item when an interaction with the content item at the computing device causes the information from the destination to be sent to the computing device. The computing device may be directed to the destination (e.g., a browser application may provide a network page associated with the content item to provide more information about the item). If the second event is not detected, the process may return to block 235, such that another content item can be displayed. If the second event is detected, the process may proceed to block 255.

At block 255, in response to the detection of the second event, the computing device ceases display of the content item(s). In some embodiments, the content items are, at least temporarily, no longer displayed on a screen of the computing device, audio is no longer played by the computing device speakers, and other forms of presentation are terminated. In some embodiments, the computing device can return to block 225 to receive one or more new content items or return to block 230 to detect an event corresponding to the entry into a display state.

It will be appreciated that the order of blocks in process 200 is illustrative, and alternative orders are contemplated. For example, block 230 may occur before blocks 220 and 225. In another example, blocks 240 and/or 245 may occur after blocks 250 and/or 255. In one embodiment, this order may allow content items to be effectively streamed, which can reduce or eliminate local storing of content items on the computing device. In other embodiments, the content items are still locally stored, but the order can improve the probability that the stored content items will be displayed and/or recent.

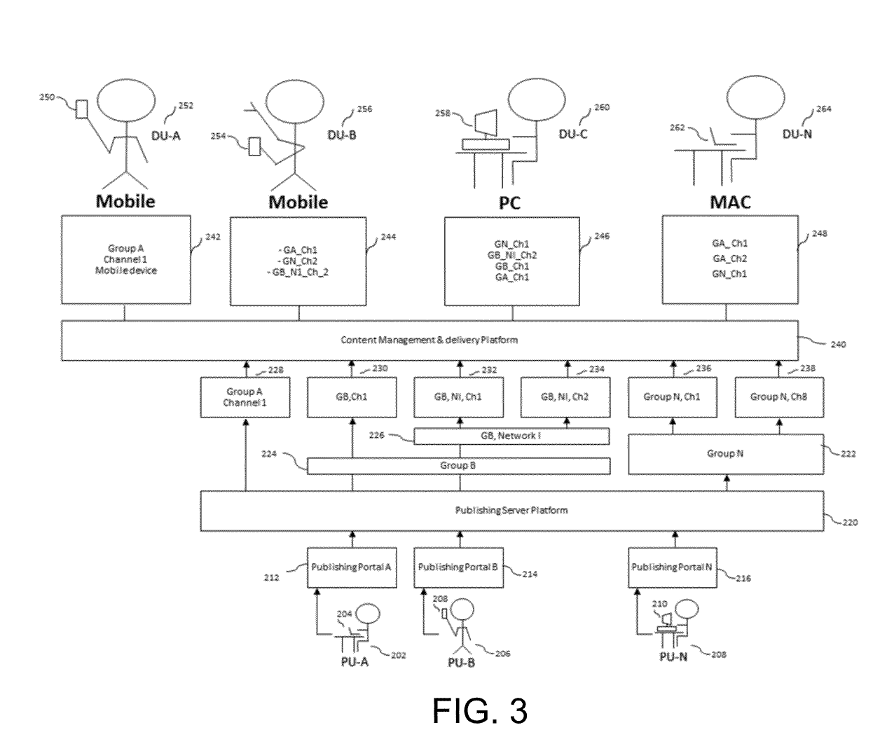

FIG. 3 shows a block diagram illustrating a system of providing dynamic content transmissions according to an embodiment of the present invention. The system can include one or more publishing servers, content delivery/receiving servers, content-creation computing devices, and content-display computing devices.

The one or more content-creation computing devices can access the one or more publishing servers through one or more publishing portals. The one or more publishing portals can include computer-readable media and instructions to determine information about the content-creation computing device accessing the publishing portal, the user operating the content-creation computing device, or related information for the user and/or computing device (e.g., correlated groups, content items, playlists, subscription requests). In some embodiments, the one or more publishing portals can be a web-based graphical user interface (GUI) or a mobile-based GUI.

A publishing portal can receive credentials (e.g., user name, login information, password, shared key, internet protocol (IP) address, approved computing device identifier) from the computing device and/or authenticate the computing device. In some embodiments, the content-creation computing device can actively provide the information (e.g., by typing, tapping, directing on a screen, or speaking the information into a microphone) or passively provide the information (e.g., by providing an IP address in response to a request from the publishing portal).

The content-creation computing device can provide (e.g., upload, save, identify) content items via the one or more publishing portals. In some embodiments, content items from more than one content-creation computing device (e.g., data feeds) can be used to generate a channel. For example, in a fantasy-sports channel, one content-creation computing device can provide pictures of players, one content-creation computing device can provide scores, and one content-creation computing device can provide injury reports. The information from each of those sources may be assembled as potential content items for the fantasy-sports channel.

The content-creation computing device can identify one or more groups and/or one or more channels for the content at the publishing server. In some embodiments, the information available at the publishing server can automatically identify groups of users, computing devices, content items, channels, or other information.

In some embodiments, the one or more groups may be identified by a particular geographic location. For example, a first computing device and a second computing device may request substantially identical content items and/or channels, but the first computing device is associated to USA and the second computing device is associated to Canada. In this example, the first computing device may be included in a first group and the second computing device can be included in a second group, even though each group may request substantially similar content items. In another example, the computing devices associated with two groups may request the same images and text, but the language of the text included with the content item(s) may be altered to satisfy a dominate language and/or the user's preferred language based in part on the geographic location.

The content-creation computing device can also use the one or more publishing servers to generate a request to join (e.g., subscribe to, submit a subscription request) a channel for one or more content-display computing devices. The request can include recommendations for one or more particular channels, including information about the channel (e.g., title, sample content items) for the one or more content-display computing devices to accept or reject.

The recommendations for a particular channel can be based on a variety of factors. For example, the recommendation can be based in part on a content-display computing device's past history (e.g., subscription, destination access), past preferences (e.g., priorities, playlists), likes/dislikes, explicit searches (e.g., received prior to a subscription request), or location-based searches (e.g., zip code of the location of a computing device, address of a user, identification of nearby stores to a user that provide content items).

After the groups, content, channels, or other information has been initially identified, the content delivery/receiving servers can prepare the content for delivery. For example, one or more content items can be prepared for the computing devices that are mobile devices associated with Group A and Channel 1. The content items may include images, videos, audio, text, or other information particularly formatted or optimized for mobile devices. In another example, one or more content items can be prepared for the computing devices that are desktop computers associated with Group A and Channel 1. It should be appreciated that any combination of computing device, group, and channel can be created.

The content-display computing devices can receive the content items from the content delivery/receiving servers. For example, the content-display computing devices can receive the content items when the content-display computing device is in a channel state and/or available to accept the content items from the content delivery/receiving servers.

The content-display computing devices can display the content items when the content-display computing device is in a display state and/or available to provide the content items. For example, the computing device may enter into a display state after some predetermined amount of time and/or time period of inactivity (e.g., lack of interaction between a user and a computing device, identifying that particular programs or software applications is not active).

FIG. 4 illustrates an example architecture for one or more servers in the dynamic content transmission system, including a publishing server 110 and a content delivery/receiving server 120, according to an embodiment of the present invention. The publishing server 110 and a content delivery/receiving server 120 (hereinafter “Servers”) may communicate directly (e.g., wired or wireless connection) or through a network 130. In some embodiments, the servers may be implemented as a single server computer (as illustrated by the dashed box) or multiple servers.

In one illustrative configuration, the servers may include at least one memory 410 (herein shown as 410-A and 410-B) and one or more processing units (or processor(s)) 424 (herein shown as 424-A and 424-B). The processor(s) 424 may be implemented as appropriate in hardware, computer-executable instructions, firmware, or combinations thereof. Computer-executable instruction or firmware implementations of the processor(s) may include computer-executable or machine-executable instructions written in any suitable programming language to perform the various functions described.

The servers may also include computer-readable non-transitory media 410, including memory and/or additional storage. For example, the computer-readable non-transitory media may include volatile or non-volatile, removable or non-removable media implemented in any method or technology for storage of information such as computer-readable instructions, data structures, program modules, or other data. The computer-readable non-transitory media may store program instructions that are loadable and executable on the processor(s), as well as data generated during the execution of these programs. The computer-readable non-transitory media may be volatile (such as RAM) and/or non-volatile (such as ROM, flash memory, etc.). The servers may also include additional storage, which may include removable storage and/or non-removable storage. The additional storage may include, but is not limited to, magnetic storage, optical disks and/or tape storage. The disk drives and their associated computer-readable non-transitory media may provide non-volatile storage of computer-readable instructions, data structures, program modules and other data for the computing devices. In some implementations, the memory may include multiple different types of memory, such as SRAM, DRAM, or ROM.

Turning to the contents of the publishing server 110 memory in more detail, the memory may include an operating system, one or more data stores, and/or one or more application programs or services for implementing the features disclosed herein, including a grouping module 414, channel module 416, content module 418, user module 420, and/or destination module 422.

In some examples, the grouping module 414 may be configured to determine a group of one or more computing devices, including one or more mobile computing devices and/or desktop computing devices, for receiving a channel. For example, the computing devices for a particular organization may be included in a group. In another example, each computing device that has submitted a subscription request to receive a particular channel may be included in a group. In another example, each computing device in a region that runs a particular operating system may be included in a group.

The grouping module 414 may also be configured to correlate one or more computing devices with information included with a subscription request. For example, the server may receive the subscription request from a computing device, determine other computing devices that are associated with substantially similar subscription requests and/or rules resulting from a subscription request, and associate similar users or devices with a group when those users or devices can receive similar content item(s). The server may determine the type of computing device that the user is operating at the time (e.g., by interacting with the device, by requesting information from the user) and provide content item(s) to the computing device based in part on the dynamic determination of the computing device.

In some examples, the channel module 416 may be configured to generate a channel. The channel can be a pipeline between a server and computing device that provides one or more content items. In some embodiments, the channel may be associated with a unique name, so that the users can search for a particular channel and/or receive all or part of the content items associated with the particular channel.

The channel module 416 may also be configured to manage a payment associated with reserving a channel. For example, a content-creation computing device can provide a payment of fees (e.g., one-time, monthly, annually, for a particular duration) in order to have the opportunity to provide content for a particular channel. The payment may distinguish the amount of space, bandwidth, different levels of web hosting, or other features. A payment may also be received from a user operating a content-display computing device 150 for the opportunity to present one or more content items (e.g., fee-based presentation, free content, subscription-based).

The channel module 416 may also be configured to identify a computing device that is configured to display channel content. For example, the computing device may be associated with a subscription request that asks for particular content item(s). In another example, the computing device may include physical specifications to provide the content item(s) to a user, including a screen to display the one or more content items, a media card to process the video associated with the content item(s), or speakers to emit the sound associated with the audio-based content items. In yet another example, the channel module 416 can be configured to provide the content based on the type of computing device that will display the content item(s) (e.g., limit the content item(s) to particular dimensions for a mobile device, limit the content item(s) to a particular file type for a Microsoft® Windows® operating system). In some embodiments, the server may deliver the content item(s) without identifying the specifications of the computing device.

The channel module 416 may also be configured to identify a channel that is associated with the computing device. For example, the computing device may have submitted a subscription request to a server, the server may have associated a rule with the computing device, or any other methods of identifying a computing device that is configured to display channel content.

The channel module 416 may also be configured to detect an event corresponding to entry into a channel state. The event may include an indication of a changed status at a computing device. For example, the event may include an indication that the computing device has access to the network and can accept content from the content delivery/receiving server 120. The communication can be received at the server from the computing device upon entry into display mode, during display mode, upon entry into a channel mode, during channel mode, after a certain amount of time (e.g., a reoccurring event every hour), upon receipt of a subscription request, or other communications that would notify the server of such an event.

In some examples, the content module 418 may be configured to identify a content item that is associated with a channel. For example, the content item(s) may be received from a publisher, a content-creation computing device, or other source. The content item may be initially identified as a file name or link that the content module 418 can retrieve and use to create the content item. The content module 418 may also identify an initial duration to display the content item at the computing device.

The content module 418 may also be configured to determine one or more content items to transmit to a computing device. For example, a similar content item may be transmitted to all computing devices, a subset of all content items may be transmitted to all computing devices, or some portion of the content items may be transmitted to the computing devices in a group (e.g., determined by the grouping module 414).

The content module 418 may be also be configured to identify content items requested from a subscription request. The subscription request can be a message from a computing device that requests a transmission of one or more content items to the computing device. In a non-limiting example, content module 418 can aggregate user profile information to define a group to transmit an update of a specific football player. In another non-limiting example, the subscription request contains information that can identify content items, including information about the requester or request, including one or more identifiers of the user (e.g., name, email address, phone number), identifiers of the computing device (e.g., an IP address), identifiers of a type of device (e.g., mobile device, laptop, desktop, tablet or particular brand thereof), identifiers of the content item(s) and/or channel, operating system(s), channel-related preferences (e.g., when content items are to be received, a limit on a number of content items, a type of content item such as image or video, whether to accept sound-inclusive content items, size of screen, a number of current channel subscriptions, historical time in display mode, where the channel will be ranked amongst other channels, etc.), or other information.

The content module 418 may be also be configured to provide content based in part on the event detected at the computing device. For example, the event may include an indication that the computing device has access to the network and can accept content from the content delivery/receiving server 120. The content module 418 may be configured to interact with the channel module 416 (e.g., to provide content items for a particular channel) or the destination module 422 (e.g., to associate a destination with a particular content item). The content module 418 may be also be configured to provide the content to a content delivery/receiving server 120 via the delivery module 454 (e.g., to provide the content item via a channel to the computing device).

In some examples, the user module 420 may be configured to identify a user associated with a computing device. The identification can include a name, email, phone number, or particular access rights for the user and/or computing device (e.g., administrator, publisher, sales). For example, a user with sales access rights can review the content items, users, and/or computing devices for a group. In another example, a user with publisher access rights can submit content items for a group, remove content items for a group, and/or any access rights of a sales profile. In another example, a user with administrator access rights can add/remove users from a group, add/remove channels from the system, alter delivery information, alter display information, and/or any access rights of a sales or publisher profile.

The user module 420 may be also be configured to identify rules and/or playlists associated with a user. These rules and/or playlists can include ones determined at a server or computing device. For example, the subscription request received from a computing device may have requested weather information when the device enters an idle state. The user module may be configured to identify a weather rule and/or determine whether the computing device has entered the idle state. The user module 420 may interact with a delivery module 254 to establish a connection with the computing device to initiate a transmission of content item(s) via a channel, transmit the content items, or any other commands that may be activated based in part on the subscription request.

The user module 420 may be also be configured to ensure that a playlist is up-to-date for a particular computing device. For example, the user module 420 may be configured to determine a particular version, download date, or timestamp of a playlist, determine whether another playlist is available for the computing device, and/or update the playlist for a computing device, when applicable.

In some examples, the destination module 422 may be configured to identify a destination associated with the content item. In some examples, an interaction with the content item at the computing device can cause information from the destination to be sent to the computing device. In some examples, the destination module 422 can be configured to instantly display information from a destination such as a webpage or a file.

Turning to the contents of the content delivery/receiving server 120 memory in more detail, the memory may include an operating system, one or more data stores, and/or one or more application programs or services for implementing the features disclosed herein, including an delivery module 454, a receiving module 456, a device module 458, and/or a reporting module 460.

In some examples, the delivery module 454 may be configured to transmit the content item(s) to a computing device. For example, transmission may include accessing a network 130 via a particular protocol (e.g., transmission control protocol (TCP)) to transmit packets, information, or other formatted data to the computing device. In some embodiments, the delivery module 454 can be configured to receive content items from a publishing server 110 (e.g., via the content module 418) and transmit the content item(s) to a computing device. The transmitted content items may include all content items associated with a particular channel, a subset of the content items in a channel, only new content items, recently submitted content items (e.g., associated with a particular fixed time period, a publisher-defined time period, a user-defined time period), or a specific number of content items (e.g., fixed or defined by a publisher/user).

The delivery module 454 can also be configured to associate user preferences with a computing device before transmitting the content item(s). For example, a computing device may identify that a particular user does not want to receive football scores at a work computing device, may identify that a user is not interested in promotion content items for a particular brand of item, or may not wish to receive video items. The delivery module 454 may be configured to analyze preferences for the computing device to determine which types of content items to send before the content item(s) are transmitted.

The delivery module 454 can also be configured to maintain a record of transmissions. For example, the record of transmissions can be associated with content items. The delivery module 454 can review the record to determine when a content item was received from a publisher and/or when the content item was transmitted to the computing device. The record may be associated with an identifier for the content item (e.g., content item #100 was transmitted January 2 at 1:00 PM to device #200). The delivery module 454 may analyze the record before transmitting the content items to the computing device and/or limit the transmissions based in part on the analysis (e.g., only transmit items to the device once per day).

The delivery module 454 can also be configured to include additional information with the transmission of the content item. For example, the additional information can include an identification of a destination (e.g., HTML identifier). In another instance and/or later in the process, upon receiving a selection of the content item by the computing device, the delivery module 454 may provide an identification of a destination (e.g., via an interaction with the destination module 422). For example, the computing device can transmit a communication (e.g., including an identification of the content item) to the delivery module 454 and the delivery module 454 may respond to the communication with an identifier of the destination.

In some examples, the receiving module 456 may be configured to receive the transmitted subscription request. For example, the server may receive the completed form from the software application at the computing device and store the information in a data store (e.g., for future use).

The receiving module 454 can also be configured to establish one or more rules corresponding with the subscription request. For example, when the subscription request includes a request for weather information when the device enters an idle state, the receiving module 454 may generate (e.g., or interact with the user module 420 to help generate) a rule that will be activated when an event notification is received that identifies that the computing device has entered an idle state. The rule can include establishing a connection to initiate a transmission of content item(s) via a channel, transmitting the content items, or any other commands that may be activated based in part on the subscription request.

In some examples, the device module 458 may be configured to detect an event at the computing device (e.g., entry into a channel state, entry into display state) and/or a changed status at a computing device. For example, the event may include an indication that the computing device has access to the network and can accept content. In another example, the event may include an indication that the computing device has entered a display state, is about to enter a display state, has been in a display state for a particular amount of time, or is exiting a display state.

The device module 458 may also be configured to receive an indication that a new content item was created, received, or uploaded for a channel (e.g., via a content-creation computing device 140) and correlate the status of the computing device with the delivery of the content (e.g., while the computing device is in a channel state). For example, a publisher can provide (e.g., upload) a new content item to a server and/or data store. The device module 458 may receive a notification that the content item(s) is available for transmission and/or placement into a channel. In other examples, the content item(s) can correlate with webpage content, such that the event can be identified when the webpage content changes and/or new webpage content is added. The server may incorporate the new webpage content with the channel.

In some examples, the reporting module 460 may be configured to store data characterizing the presentation of the content item(s) (for a single user device or across multiple user devices). This stored data can immediately or subsequently be used by the server or another device (e.g., having received the data from the server). Data can include a number of times a content item was displayed, a number of times content from a particular channel was displayed, the duration that a content item/channel was displayed, whether users selected an identifier of a destination, whether users purchased items subsequent to presentation of the content item, or other relevant information.

The reporting module 460 may also be configured to identify patterns, statistics, and/or reports. For example, the data can generate one or more new statistics and/or modify one or more existing statistics (e.g., to increment a count) based in part on the content-item presentation, including statistics for a given channel or content item. The patterns, statistics, and/or reports can also be stored with the original data.

The servers may also include one or more I/O (input/output) devices 426 (herein shown as 426-A and 426-B), such as a keyboard, a mouse, a pen, a voice input device, a touch input device, a display, speakers, a printer, and the like.

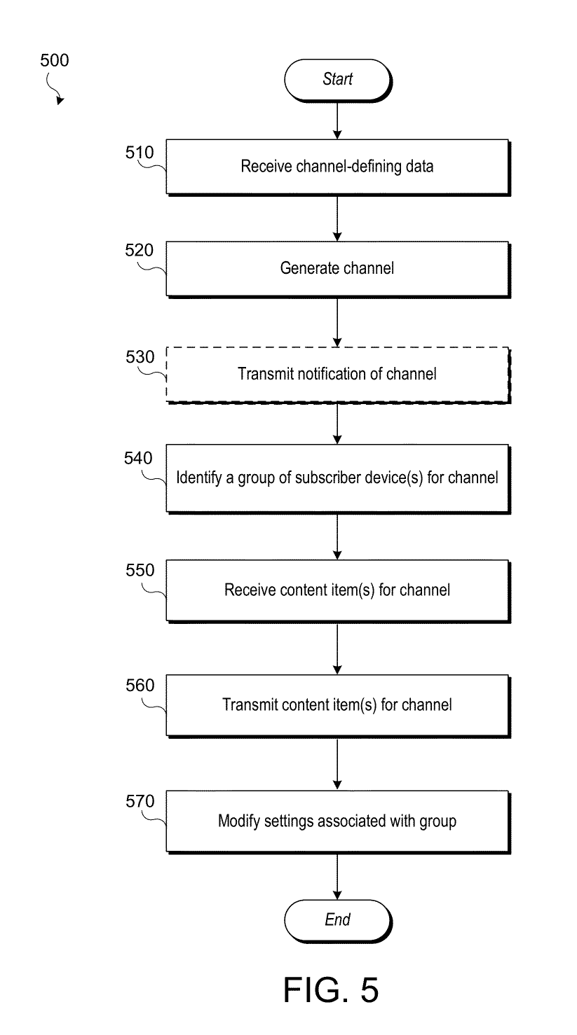

FIG. 5 illustrates an example flow diagram of a process 500 for transmitting content to a computing device according to an embodiment of the present invention. In some examples, one or more servers, such as the publishing server 110 (e.g., utilizing at least one of the grouping module 414, channel module 416, content module 418, user module 420, and/or destination module 422) and/or a content delivery/receiving server 120 (e.g., utilizing at least one of the delivery module 454, a receiving module 456, a device module 458, and/or a reporting module 460) shown in FIG. 4 may perform the process 500 of FIG. 5.

The process 500 may begin at block 510 by receiving channel-defining data. For example, the channel-defining data can be provided by a publisher (e.g., operating a publishing server 110, operating a content-creation computing device 140). The publisher can enter channel-defining data (e.g., at an interface provided by publishing server 110) about which channel-defining data the users may search for in order to request a new channel and/or content items provided via a channel (e.g., at an interface provided by content delivery/receiving server 120).

The channel-defining data can include various information about a channel. For example, the channel-defining data can include information to initiate a channel, including a title (e.g., “Golf” or a brand name like Macy's®), a generic description of content items provided by the channel, a description of the content provider, one or more examples of the types of content items that are available on the channel, metadata, or keywords (e.g., to assist with a text-based search of channels). In some examples, the channel-defining data can include an identification of one or more users who can submit content for the channel or a frequency at which new content is to be added to the channel. In some examples, the channel-defining data can include which users can subscribe to the channel (e.g., all users, a list of specific users, all users except those on a black-list), the cost of a channel (e.g., available for free or for a fee), or any rewards/loyalty points earned by viewing the channel.

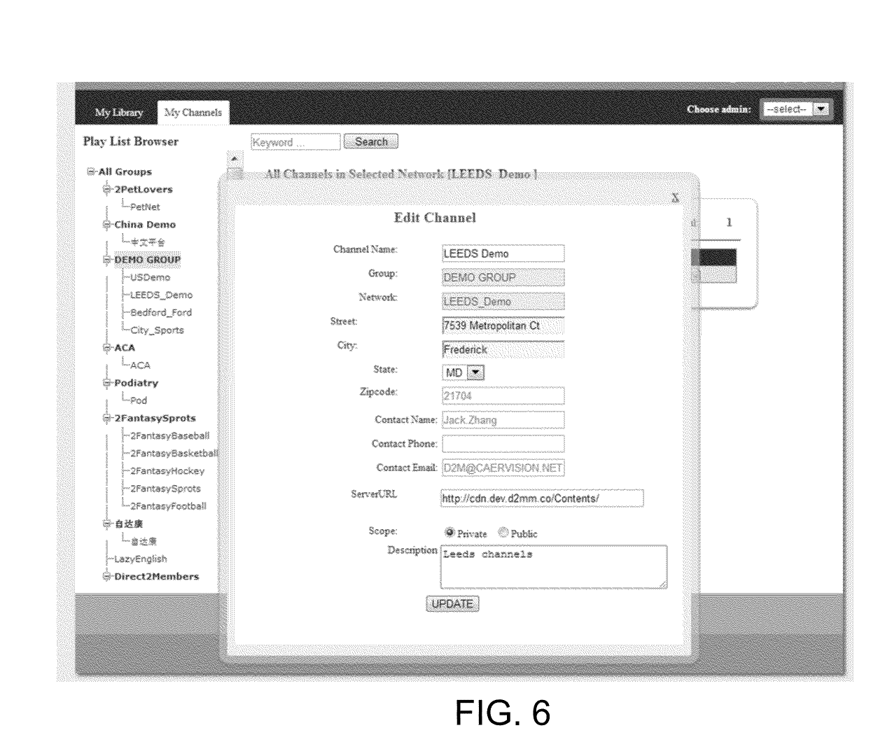

An example of a graphical user interface (GUI) that is used to receive channel-defining data is shown in FIG. 6. FIG. 6 shows an illustration of a graphical user interface for editing a channel according to an embodiment of the present invention. As shown, the GUI can include one or more text boxes to accept information. Alternative GUI input-receiving elements can include, e.g., a list of radio elements or a drop-down menu. The input-receiving elements may receive input for, e.g., a channel name, group, publisher's contact information, accessibility of the channel (e.g., whether it is to be searchable such that the channel is to be identified to members of the public responsive to a query or private), a description of the channel, or other information. In some embodiments, the information provided in the GUI may be pre-populated so that the publisher can update the information previously related with the channel.

In some embodiments, channel-defining information can include identification of one or more users. For example, the channel-defining information can identify information for a particular user and/or computing device (e.g., name, user name, identifier, email address, phone number). The channel-defining information may also identify that a user is associated with one or more groups (e.g., all mobile devices in the U.S. that subscribe to the Golf Channel, all desktop computers in the U.S. that subscribe to the Acme Co. Channel). In some embodiments, channel-defining information can associate information with the publisher-side of a channel, so that a publisher, content provider, and/or administrator can manage the channel-defining information based in part on access rights.

The channel-defining information may also include a role and/or authorization of the user associated with particular access rights (e.g., administrator, publisher, sales). For example, a user with sales access rights can review the content items, users, and/or computing devices for a group, a user with publisher access rights can submit content items for a group, remove content items for a group, and a user with administrator access rights can add/remove users from a group, add/remove channels from the system, alter delivery information, alter display information. In some examples, one or more groups may share access rights (e.g., both administrators and publishers may submit content).

In some embodiments, the channel-defining information may be accessible via a user interface (e.g., GUI) at the publishing server and/or content delivery/receiving server. The GUI may also provide functionality for a user with administrator access rights to add/remove/alter access rights of other users (e.g., changing user A from sales access rights to publisher access rights).

Returning to FIG. 5 at block 520, the process 500 includes generating a channel. The channel may establish a pipeline between a server and computing device that provides one or more content items. Upon generation, the channel can be configured accept new content items (e.g., from a publisher or from a location identified by a publisher) and to transmit the content items to one or more computing devices.

At block 530, the process 500 includes transmitting a notification of the channel. In some embodiments, block 530 may be optional, such that a notification of a channel will not be transmitted. In some embodiments, the notification of the channel may be a transmission that includes information about the channel and/or can include information corresponding to channel-defining information received at block 510. For example, the notification of the channel may include the title of the channel, one or more keywords of the channel, a brief description of the channel, sample content items included in the channel, expected frequency of transmissions content items in the channel (e.g., when new content items are provided to the computing device), frequency of updates (e.g., when new content items are provided by publishers to update content available in a channel), identifications of one or more affiliated users, publishers that provided content items, or other information that may be useful for a user.

The method of transmission may vary. For example, when the computing device has access to a software application (e.g., a software “app” on a mobile device), the app may notify the computing device by an icon, flashing notification, or other indication that the app has received an update. In some examples, the computing device may receive a message (e.g., email, text, short message service (SMS), voice message, push notification) that the user can access to receive the notification that a channel is available. In some examples, the user may browse to a webpage and/or data store to view, search, query, explore, or otherwise find a listing of channels.

The transmission may be provided at various intervals. For example, transmitting the notification can occur automatically (e.g., daily, monthly, every-other Tuesday), upon request (e.g., filling out a request to receive reoccurring or one-time notifications), after a search for a channel has been initiated (e.g., search for “golf” and receive a notification that includes all “golf” channels, after a search for a term that corresponds to the channel's title, keyword, or description), after a channel has been generated (e.g., by a publisher), after a channel has been identified as a public channel (e.g., by a publisher), or other times. Thus, it will be appreciated that, in various embodiments, multiple users may be notified of a given channel simultaneously or at different times.

In some instances, information about the channel can be presented along with an option to subscribe for the channel (e.g., by submitting a subscription request). The information can also indicate whether a fee is due for subscribing to the channel.

At block 540, the process 500 includes identifying a group of subscriber device(s) for the channel. Each device in the group of subscriber devices can correspond to a user who subscribed to the channel. A given subscribing user may correspond to one or more subscriber devices. It will be appreciated that the group can be dynamic, such that devices are added or deleted from the group as corresponding users subscribe or unsubscribe to the channel.

A particular subscriber device (e.g., computing device) in the group may be may be identified. In some embodiments, the user can explicitly identify one or more devices in a subscription request that should receive one or more content items. The request may include the computing device internet protocol (IP) address, a device name, or other information that may identify a particular device by a user. For example, a user can access a profile while operating a first computing device in the morning to submit a subscription request for a new channel. Later the same day, the user may access his profile while operating a second computing device. The user may choose to restrict the golf channel from the second computing device and/or add the same channel to the first computing device. In some embodiments, the user may be associated with two different groups (e.g., one group for the first device and one group for the second device).

In another example, the user may operate one computing device, but provide various identifiers (e.g., user identifier, device identifier, IP address) and/or authentication credentials to operate the device. Each identifier may be associated with a particular group, so that when the user provides a first identifier, a first set of content items are provided, and when the user provides a second identifier, a second set of content items are provided.

In some embodiments, the server may detect which device is sending the subscription request and associate the content item(s) requested through the subscription request with the device that requested them. In some embodiments, the server may detect which device is operational when a user logs into an account, provided credentials for authentication, passively interacts with the server (e.g., cookies, IP address), or other methods of detection.

At block 550, the process 500 includes receiving content item(s) for the channel. For example, the content item may be received from a publisher, a data store, or other source. In another example, the content item can be provided to one or more computing devices at substantially the same time.

The content item(s) may be associated with each subscriber device in the group of subscriber device(s). For example, the subscriber device may be a content-display computing device enabled to display one or more content item(s). The publisher can further or alternatively identify content items (e.g., images or videos) for the channel. In one instance, the publisher can upload (at one or multiple times) one or more content items (e.g., images identifying results of recent golf tournaments, videos promoting sales on golf clubs, text about golfers, or text and images identifying weather conditions at nearby golf courses) to a server. In an alternative or additional instance, the publisher can identify a content source (e.g., a webpage) and/or destination.

At block 560, at least one of the received content items is transmitted to at least one of the subscriber devices. In one embodiment, all received content items are transmitted to all subscriber devices. In one embodiment, only a portion of the received content items is transmitted. The portion can include a fixed number of content items, content items matching a user's preferences, content items with dates meeting a criterion (e.g., pertaining to an upcoming event), and/or content items with a high transmission priority (e.g., identified by a publisher as being an item to push). In one embodiment the content item(s) are transmitted to only a portion of the subscribing users. The portion can be selected based on states of the users (e.g., only sending content items to those users entering a display state), a preference of the users (e.g., only sending content items to those users with a “content-push” preference), channel content items already on the users' devices (e.g., to keep a number or size of cross-channel or channel-specific content items below a threshold), and/or a channel access characteristic of users (e.g., biasing transmission towards users/devices with frequent access or recent access of channels or of a specific channel). Thus, it will be appreciated that, in various embodiments, a given channel content item can be transmitted to multiple users simultaneously or at different times. It will also be appreciated that, as used herein, actions or conditions disclosed with reference to “a user” can alternatively or additionally apply to a user device.

The transmissions may occur at a triggered time. For example, one or more content items can be transmitted upon receipt of a new content item, receiving more than a threshold number of content items for a given channel or for a user (e.g., or computing device), identification that a subscriber device is about to enter or has entered a display mode, or a request from a subscriber device. In one instance, a server tracks an accumulation of new content items not yet transmitted to a particular computing device. Upon receiving an indication that the computing device has entered a display mode, it can push a particular number of these new content items (e.g., 10) every 5 minutes so long as the computing device remains in the display state.

It will be appreciated that process 500 can include a repetition of multiple blocks. For example, notifications of a channel be repeatedly transmitted (e.g., to new users, in response to new searches, etc.). As a group of subscriber devices can be dynamic, block 540 can be repeatedly performed. As another example, blocks 550-560 can be repeated as new content items are repeatedly received.

Upon collecting a group of content items, it can be important to sort these into an order. The order can be include an order for transmitting items from a server to a device (e.g., a precise order or a grouping of content items into batches for ordered transmission) and/or an order for displaying the content items on a computing device. In some instances, an order is determined for content items of a particular channel, and in some alternative or additional instances, an order is determined for cross-channel content items. The latter can include determining an order for channels (e.g., to thereby create a cross-channel content-item sequence by combining intra-channel sequences).

A playlist relates to a sequence for displaying a set of content items on one or more computing devices. Thus, the playlist can include a sequence (e.g., ordered list) and a set of content-item identifiers. The playlist can specifically identify content items or can more generally identify them (e.g., a “weather-update” content item for the Golf channel, or an “educational video clip” content item for a Math channel). In the latter instance, a computing device can use the playlist's constraint to select an appropriate content item (e.g., using a pseudo-random selection or by selecting a matching content item with the most recent publishing date). In some instances, the playlist further includes a duration (which may be the same for all content items, for all content items of a given type or all content items for a channel or which may be specific to a content item) for which a content item is to be displayed.

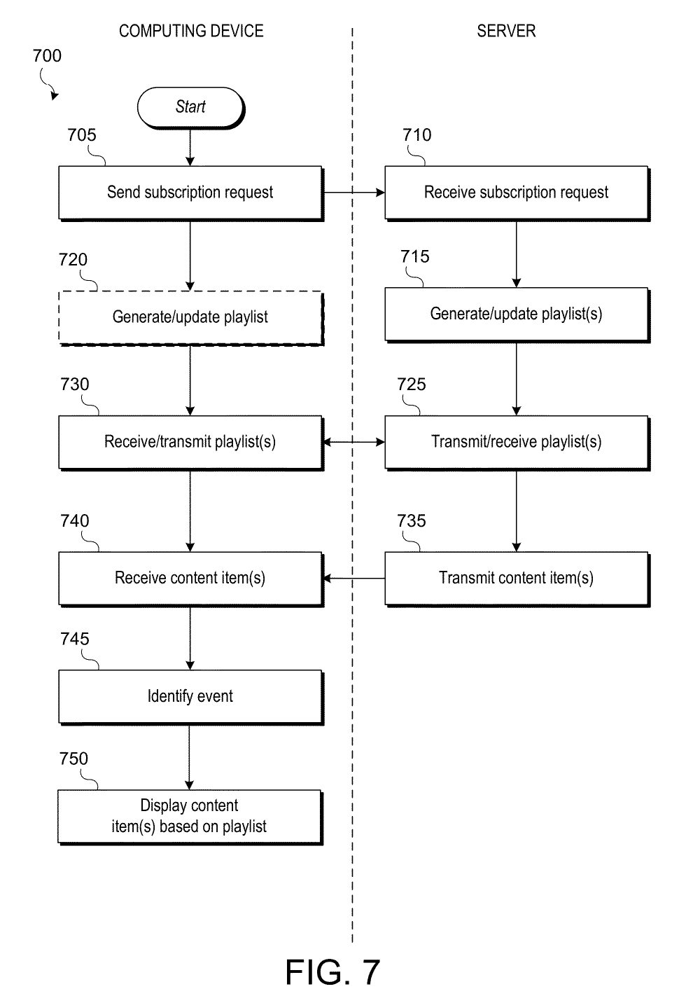

FIG. 7 illustrates an example flow diagram of a process 700 for generating and using a playlist according to an embodiment of the present invention. As shown, various portions of process 700 can be performed by a computing device (e.g., a content-creation computing device 140, a content-display computing device 150), and other portions can be performed by a server (e.g. a publishing server 110 and/or a content delivery/receiving server 120). Blocks 705 and 710 of process 700 can parallel blocks 205 and 210 of process 200.

At block 715, the server generates or updates a playlist, and at block 1020, the computing device generates or updates a playlist. The playlist generated or updated at blocks 715 and 720 can be the same or different. It will be appreciated that, in some embodiments, process 700 does not include block 715 or 720, such that management of a playlist is managed by a single device.

The playlist can be applicable to a specific channel and/or to a computing device/user. In the latter instance, the playlist can include a multi-channel sequence. Developing a user-specific playlist can utilize information corresponding to a particular user or device, such as which channels are subscribed to; a ranking of channels; preferences, restrictions or ranking of types of content items; a type of even that is to trigger channel content-item display; and/or inter- or intra-channel preferences or restrictions of content-item sequences. The playlist can further use information corresponding to a particular publisher. For example, a publisher may indicate that a given content item is to be presented before another content item, or a publisher may identify a proportion of time to be allocated to content items of given characteristics (e.g., spend 50% of the channel's time showing “clothing” content items; 20% for “shoes” content items and 30% for “jewelry” content items).

In one instance, multiple playlists influence a transmission or display order. For example, an intra-channel playlist can be generated for each channel, which identifies an order for content items of the channel to be transmitted or displayed. An inter-channel playlist can then identify an order for channels (e.g., channel 1 content item, channel 2 content item, channel 3 content item, channel 1 content item, channel 3 content item, etc.; or all of channel 1's content items, all of channel 2's content items, etc.). The lists can then be combined to identify a sequence of specific items.

A playlist may include one or more identifiers. Each identifier can identify a specific content item, a publisher, a type of content item and/or a channel. For example, the playlist may include one identifier for item ABC from the golf channel, a channel-specific identifier (not specifying a particular item but merely specifying the channel) for a company events channel, and one identifier for a graphic item from an internal medicine channel. In one instance, the playlist includes a single type of identifier (e.g., such that all identifiers are for specific content objects). In one instance, the playlist includes multiple types of identifiers.

Playlist generation can depend on which content items are active (e.g., such that an expiration date has not yet passed) and/or a publisher's or user's priorities. For example, a user can prioritize channels and/or types of content items. As another example, a publisher can indicate that content items are to be displayed in a particular order or an order corresponding to an upload date. As yet another example, a publisher can identify each of some or all of a set of content items for a channel as being of a particular priority level (low, medium or high). An order of the publisher's content items within a playlist can then accordingly reflect the priorities. As yet another example, a user or publisher can define target proportions for channel display. To illustrate, a user can indicate that 50% of channel-display time is to be devoted to Channel A, or a publisher can indicate that 25% of content items displayed for Channel A are to be news reports.

Blocks 725 and 730 are complementary, where the computing device or the server transmits part or all of the generated/updated playlist (or information about the playlist) to the other of the computing device or server, which then receives the transmitted data. In some instances, the communicated data identify a change to an existing playlist or inputs that prompted a generation or update of a playlist.

The communication can occur via a network (e.g., the Internet).). The transmitted data can include an electronic file recognizable by the receiving device (e.g., a text or proprietary file extension, including instructions for the presentation duration or destination of a content item), or a communication message (e.g., email, text message) that includes the relevant information. The receiving device can analyze (e.g., parse, store) the transmitted data in order to update a playlist or identify which content items are to be displayed. In some embodiments, the transmitting device and/or receiving device accesses an application (e.g., a web browser, a software “app” on a mobile device) to communicate with the other device via the network.

In some instances, the receiving device can use the transmitted data to update a locally stored playlist. Updating the playlist can include replacing the locally stored playlist with the playlist received from the server. Updating the playlist can alternatively include appending a stored playlist with the received playlist. In one instance, updating the playlist includes generating a new playlist. For example, a transmitted playlist can include a sequence of channel identifiers. The receiving device can then generate a playlist of content identifiers (e.g., by selecting using an order and/or pseudo-random process amongst content items for a channel) with the sequence of content items corresponding to the sequence of channels. As another example, the transmitted playlist can include a sequence of content items for a specific channel. The receiving device can then generate a playlist that includes the channel's sequence (e.g., as a blocked portion or interleaved throughout the sequence).

It will be appreciated that, in some instances, blocks 1025 and 1030 are omitted from process 1000. This can be appropriate in instances in which a single device manages and uses a playlist.

At block 735, the server transmits the content item(s). The server can transmit one or more content item(s) to the computing device via a network (e.g., the Internet). In some instances, which content items are transmitted and/or an order of the transmission it based on the playlist. For example, a transmission can be limited to only include content items identified in or matching part or all of a playlist, or an order of the transmission can correspond to a playlist order. Multiple content items can be transmitted individually or in one or more batches. One or both of the computing device and server can influence which content items are transmitted and/or an order of transmission (e.g., which can be influenced by batch assignments). For example, a computing device can request specific content items or a server can determine the transmission specifics locally. Which content items are transmitted can also be influenced based on information (stored at the server or stored at or determined by the computing device) indicating which content items are already stored at the computing device.

At block 740, the computing device receives content item(s). The content item(s) may arrive as an electronic file recognizable by the computing device (e.g., a text or proprietary file extension), or a communication message (e.g., email, text message) that includes the relevant information. The computing device can analyze (e.g., parse, store) the content item(s) in order to identify the content items received from the server (e.g., identifiers, receipt date). In some instances, metadata for a content item is analyzed to determine, e.g., a name of the content item, a channel for the content item, a type of the content item and/or a duration of the content item. The content item can be stored at a destination corresponding to a particular channel or general across channels. In some instances, receiving or storing a new content item initiates deletion of a previously stored content item (e.g., to keep a channel-specific or cross-channel item storage below a size threshold or item count). In some embodiments, the computing device accesses an application (e.g., a web browser, a software “app” on a mobile device) to communicate with one or more servers via the network to receive the content item(s).

At block 745, the computing device identifies a display-trigger event. For example, the computing device may identify an event indicative of entering a display state (e.g., some predetermined amount of time and/or time period of inactivity at the computing device). In some examples, the event is indicative of entering a display state corresponding with the user's request to enter a display state (e.g., detecting a selection of a predefined key (F10, F9), requesting to activate a GUI that allows the user to provide commands to enter and exit the display state through the GUI).

At block 750, the computing device displays one or more received content item(s). Which content items are displayed and/or an order in which they are displayed can depend on or be specified by one or more playlist. For example, a playlist may identify an ordered list of specific content items, and the computing device can then display the content items accordingly. As another example, the playlist may identify an ordered list, where each list item corresponds to a content-item constraint (e.g., indicating that the content item is to be selected from amongst a specified group of items, is to correspond to a specified channel and/or is to be of a specified type).

In some instances, content items will continue to be received from the server during a display. For example, a server can push a first two content items in a playlist to a computing device. The computing device can then request additional content items upon entering display mode. The server can then push a batch of content items corresponding to a next portion (or a remaining portion) of the playlist.

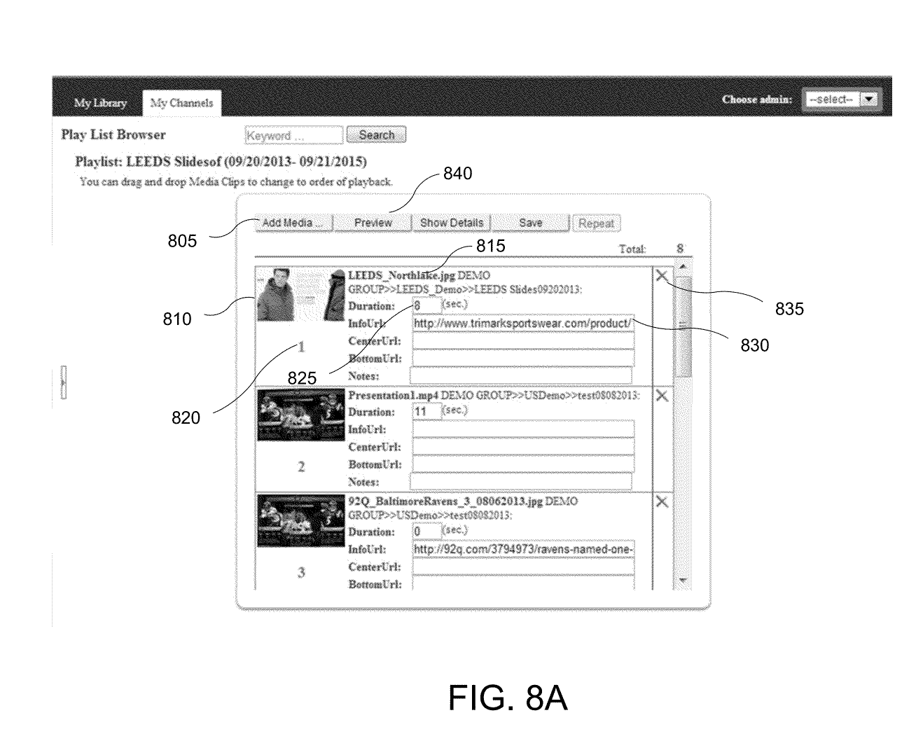

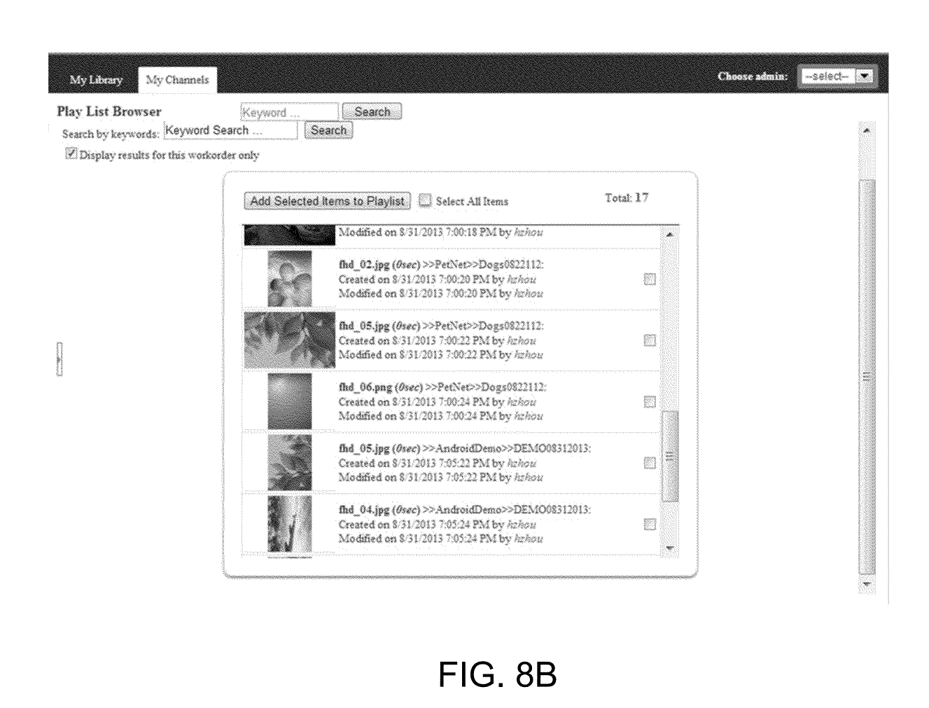

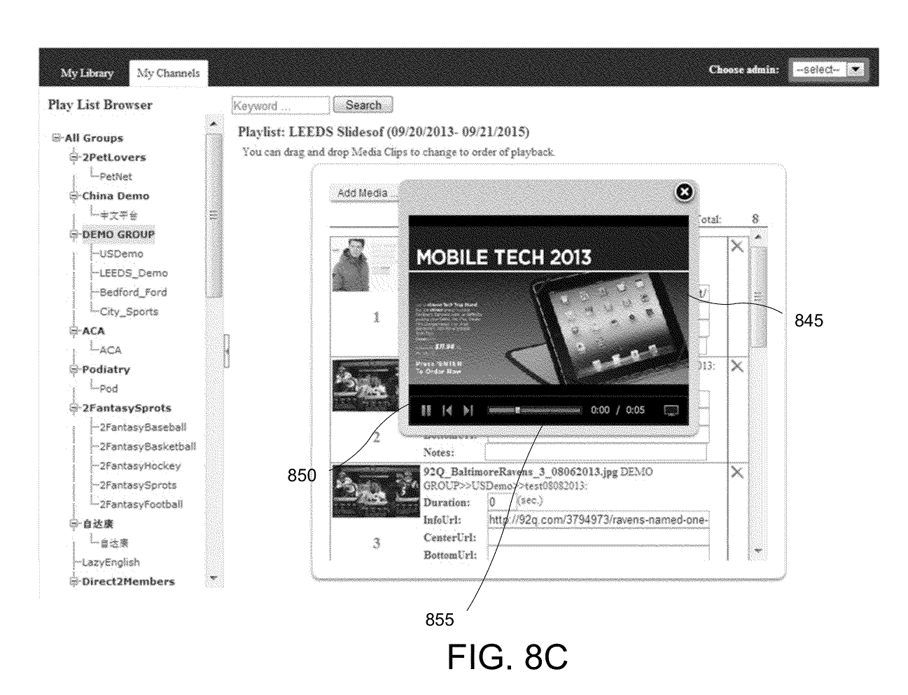

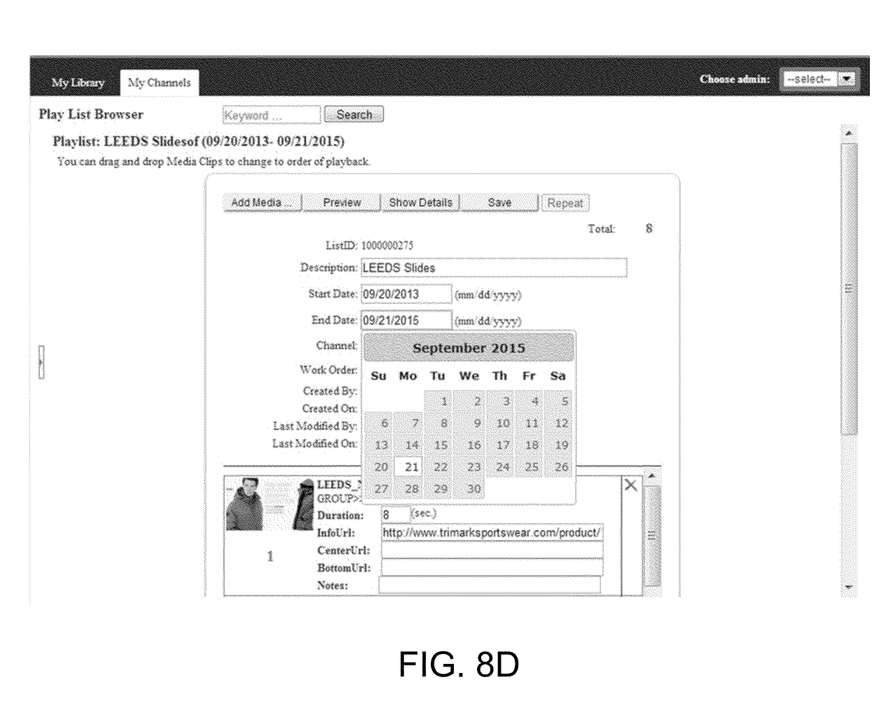

As mentioned, a playlist can be influenced based on inputs provided by one or more publishers and/or a user. FIGS. 8A-8D show illustrations of interfaces configured to receive publisher inputs pertinent to a playlist according to an embodiment of the invention.

FIG. 8A presents identifiers of content items in a playlist and allows a publisher to modify the playlist. A publisher can press the “add media” button 805 to locate a content item to add to the playlist. Upon selection of the button, a list of content items that are available for addition to the playlist can be presented. FIG. 8B illustrates an example of a display that can be presented responsive to the selection of the add-media button. As shown, the list can include, for each of one or more content items, a representative image (e.g., an image itself or screenshot), a title, a creation date, a publisher that uploaded the item, a modification date and/or a file type. In some instances, the list can include some or all content items associated with one or more particular channels or publishers. The list can include content items uploaded to a channel or identified as being associated with a channel. In some instances, an opportunity to upload or identify a new content item can also be provided.

Upon selecting a content item, a representation of the item can be added to the interface. The representation can include a graphic 810 (e.g., an image or screenshot) and/or a name 815. The representation can be associated with a playlist position 820 (e.g., specifying where it is to stand within a playlist's order). In some instances, each added item is added to an end position (e.g., to an end of a sequence in the playlist). In some instances, a playlist position can be specified by the publisher upon adding the item. The item positions can be subsequently adjusted (e.g., by dragging and dropping item representations or reordering a list).

The GUI can include an item-duration input field 825. Thus, a publisher can be allowed to specify a duration for which a particular item (or a set of items or all items) is to be displayed. For images, the image can be statically presented for this time. For a video or audio stream, a clip of the video or audio stream (e.g., starting from the beginning or from a specified starting point) that is of the duration can be shown.

The GUI can include an option 835 that allows a publisher to remove a given content item from the playlist. Upon selecting the option 835, a representation of the item can be removed or reduced in the GUI.

A preview option 840 can allow a publisher to view a sequence of content items as specified by the playlist. Thus, the represented content items can be displayed in an order corresponding to the identified order positions and for durations as specified by publisher-defined durations. In one instance, a preview box 845 is displayed, as shown in FIG. 8C. The box includes a display section 850 that shows the playlist's content items, a set of player controls to allow a publisher to control the playlist's play (e.g., to play, pause, or skip forward/backwards) and a timer bar 855 that indicates a progression within the playlist. In various embodiments, a preview can allow a publisher to view a specific content item or a playlist-defined sequence of content items.

For a given publisher or channel, the temporal applicability of various content items may not conform across a playlist. For example, one item may relate to a sale that ends in a week and another may relate to a timeless customer-service philosophy of a company. To accommodate such variation, details of an individual content item can be adjusted to specify its temporal relevance. As shown in FIG. 8D, a publisher can select a start date and an end date specifying a time period during which a content item is to be included in a playlist. When a current time is not within the time period, other items with playlist positions below the item can be moved up in their playlist positions, and the item can be removed from the playlist.

FIGS. 8A-8D illustrate how information from publishers can be used to determine sequences for content items. However, whether this information is relevant to channel display of a given user can depend on channel selections or rankings In one instance, a playlist can be generated specifically for a user. That playlist can depend on and/or include a playlist as defined by a publisher. For example, a user's playlist can include a sequence of in-full playlists defined by publishers or an interleaved sequence (e.g., such that a first item is the first item of Channel 1's playlist and a second item is the first item of Channel 2's playlist).

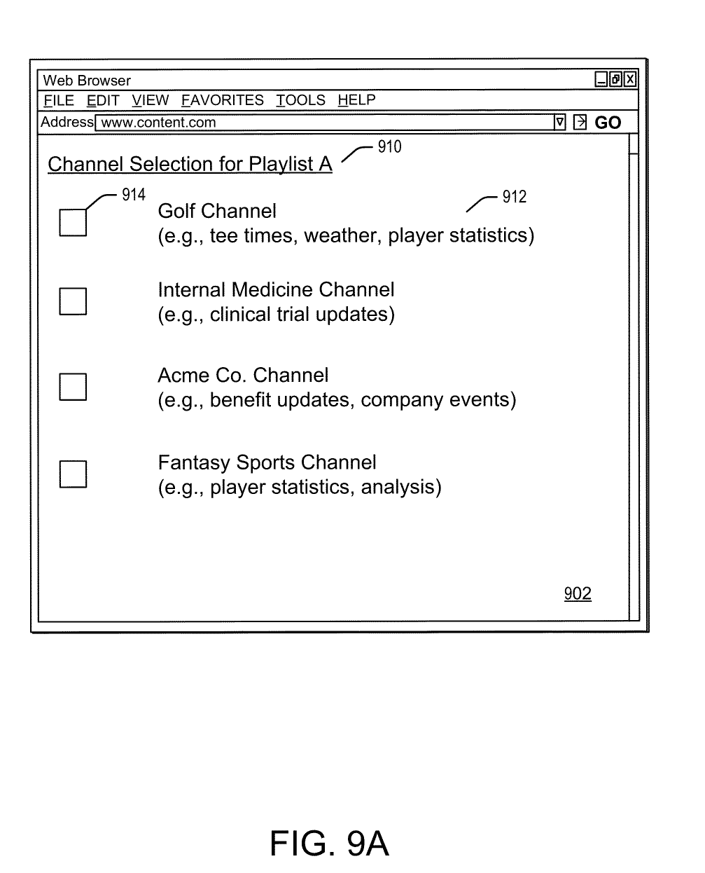

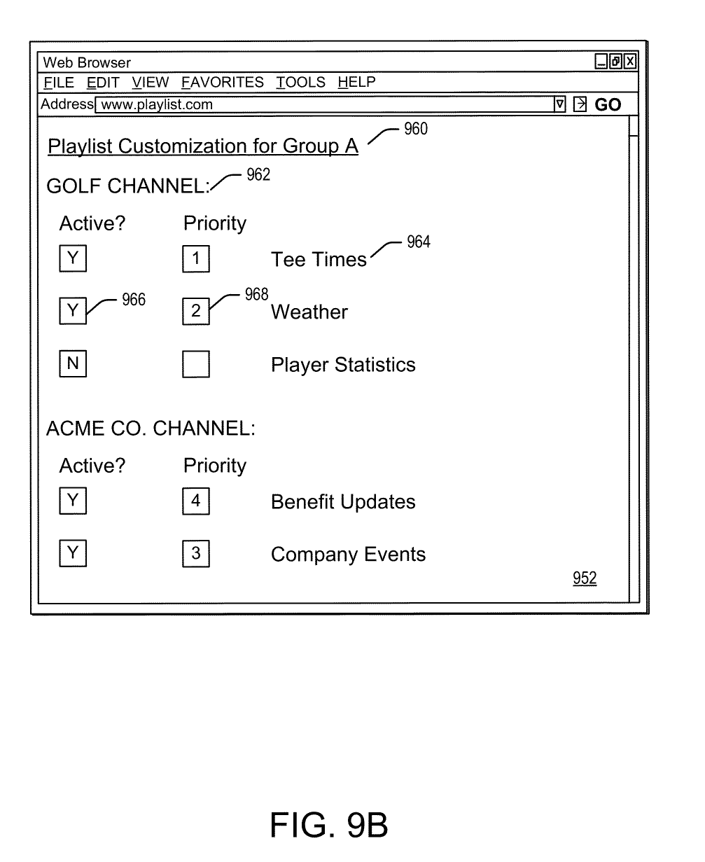

FIG. 9A shows an illustration of a graphical user interface (GUI) that allows a user to select channels for inclusion in a user playlist according to an embodiment of the present invention. In some embodiments, the GUI 902 may be provided via a network interface, web browser, or software application.

The GUI 902 can provide a list 910 of one or more channels available for user selection. In some embodiments, the list 910 can include some or all channels that the user or that a computing device is subscribed to. In some embodiments, the list 910 can include one or more channels that are recommended for a user. In the depicted example, the list 910 can include a golf channel, internal medicine channel, a company's channel (e.g., Acme Co.), or a fantasy sports channel. It will be appreciated that the list 910 of one or more channels is illustrative, and alternative channels, settings, options, or layouts are contemplated.

The list 910 may include information 912 about one or more channels. For example, a channel may include a title (e.g., golf channel) and illustrative content items provided via the channel (e.g., tee times, weather, player statistics). Alternatively or additionally, list 910 can include, for each channel, a brief description, one or more keywords, a channel fee and/or one or more types of content items. Multiple channels and summaries of information about the channel may be provided.

A user operating a computing device may interact with the list 910. For example, the user may select, tap, click, or otherwise activate a portion of the GUI 902 to identify one or more channels with which the user would like to receive content items.

The selections made via GUI 902 can serve to act as a preference or restriction (depending on the embodiment) influencing a structure of the playlist. In some instances, the playlist will only include content items for the selected channels. In some instances, the playlist will primarily include content items for the selected channels. Additional content items can include, e.g., advertising content items. In some instances, weights can be assigned to channels or content items in accordance with the selection (e.g., heavily weighting items for selected channels), and playlists can be generated based on the weights.

In response to the interaction, the GUI 902 may activate a channel and/or content item for a playlist. The playlist may be stored at the server and/or computing device, and include a listing of identifiers associated with the channel and/or content item. The GUI 902 may be configured to transmit the playlist to the computing device. The playlist can cause content items for the channel to be periodically presented at the computing device (e.g., based on instructions and/or identifiers in the playlist).

FIG. 9A shows a binary response to channel inclusion: either a channel is to be included in a playlist or it is not. A more detailed specification can subsequently or alternatively be provided. For example, the GUI may be configured to allow a user to rank the channels in terms of priority, set an order that the channels are to be included in a playlist (e.g., such that one, some or all items of a low-order channel are to be shown before one, some or all items of a high-order channel), set inclusion proportions or weights, and/or restrict (in or out) content-item types for one, some or all channels.

FIG. 9B shows an illustration of a graphical user interface (GUI) for providing more detailed playlist customization according to an embodiment of the present invention. In the illustrated embodiment, GUI 952 can be presented in response to a user selecting the Golf and ACME channels identified in GUI 902, though it will be appreciated that this more detailed interface may be presented prior to initial selections (e.g., including information pertaining to all subscribed, recommended or query-responsive channels).

The GUI 952 can provide a list 960 of one or more channels (e.g., that the user selected using GUI 902) for the user to customize with relation a playlist. The list 960 may include a list of channels 962. The channels can include those previously selected for playlist inclusion, those subscribed to and/or those recommended ro a user. For each channel, one or more categories 964 can be presented.

For each category, a user can interactive with an “active” option 966 to indicate whether the category is to be included at all in the playlist. The active option 966 may initially be set to a default value. For example, an opt-out protocol can be used, such that it is assumed that a user wishes to receive content from the category unless the user provides contrary indications.

The user can further prioritize each category using a prioritization option 968. In the depicted instance, the prioritizations can be relative to all categories. In another instance, the prioritizations can be relative to all categories for a given channel (which themselves may be prioritized relative to each other). In the illustrated example, the prioritization is numeric. It will be appreciated that alternative embodiments could include a level-based prioritization, such that a category can be assigned to, e.g., a high, medium or low priority, and multiple channel categories can be assigned to a given priority level.

In response to interactions with publisher and/or user GUIs, a detailed user-specific playlist can be generated. FIG. 10 shows an illustration of a playlist, an identification of a set of content items, an order for the content items, a presentation duration for each content item and a source of each content item. The playlist can further include a destination location for one or more content items.

The multimedia segment of the playlist identifies a type and duration for each content item. An order of the content items is further represented. An external application portion of the playlist identifies, for each content item, an application that is to be used to execute or otherwise display the content item. An application argument portion of the playlist identifies a destination for each content item. Thus, it will be appreciated that variables such as a display-enabling application, destination location and/or display duration can vary across content items.

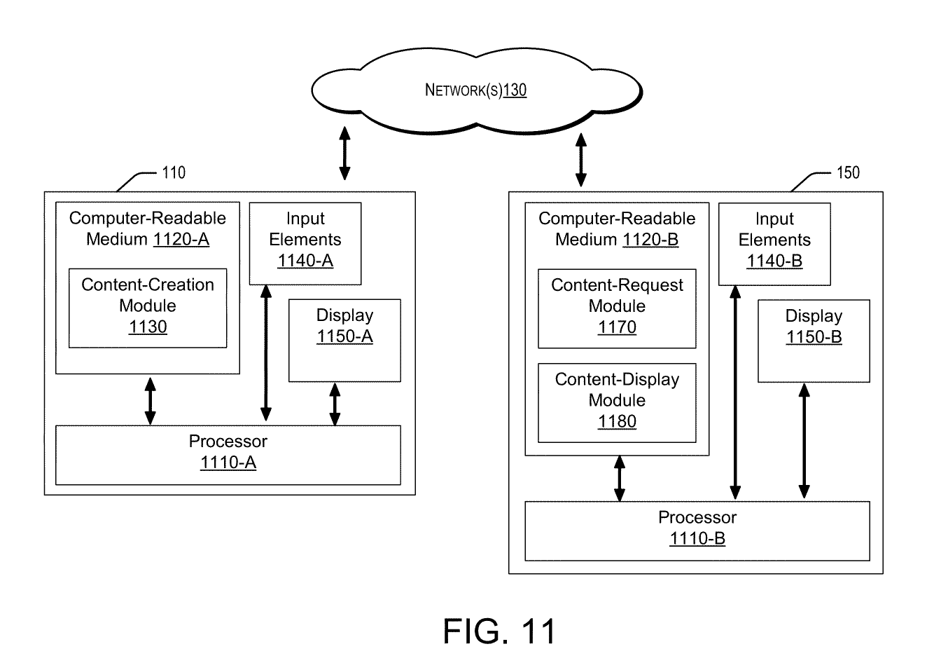

FIG. 11 illustrates a block diagram illustrating a system on a computing device for triggering presentation of content channels according to an embodiment of the present invention. The content-creation computing device 140 and a content-display computing device 150 (hereinafter “Devices”) may communicate directly (e.g., wired or wireless connection) or through a network 130.

In one illustrative embodiment, the devices may be any type of computing device such as, but not limited to, a mobile phone, a smart phone, a personal digital assistant (PDA), a laptop computer, a desktop computer, a thin-client device, a tablet PC, an electronic book (e-book) reader, etc. In some examples, the devices may be in communication with the servers via the network, or via other network connections. Additionally, the devices may be part of a distributed system managed by, controlled by, or otherwise part of the servers (e.g., a console device integrated with the publishing server 110 and/or the content delivery/receiving server 120).

The devices may include one or more processing units 1110 (e.g., 1110-A and 1110-B), at least one computer-readable non-transitory media 1120 (e.g., 1120-A and 1120-B), one or more input elements 1140 (e.g., 1140-A and 1140-B), and one or more displays 1150 (e.g., 1150-A and 1150-B).

The processor(s) 1110 may be implemented as appropriate in hardware, computer-executable instructions, firmware, or combinations thereof. Computer-executable instruction or firmware implementations of the processor(s) may include computer-executable or machine-executable instructions written in any suitable programming language to perform the various functions described. The processor 1110 may process the functions of the computing device.

The computing device may also be configured to include computer-readable non-transitory media 1120. The computer-readable non-transitory media 1120 may be in the form of a memory that stores program instructions that are loadable and executable on the processor(s) 1110, as well as data generated during the execution of these programs. Depending on the configuration and type of devices, the memory may be volatile (such as random access memory (RAM)) and/or non-volatile (such as read-only memory (ROM), flash memory, etc.). The devices may also include additional removable storage and/or non-removable storage including, but not limited to, magnetic storage, optical disks, and/or tape storage. The disk drives and their associated computer-readable non-transitory media may provide non-volatile storage of computer-readable instructions, data structures, program modules, and other data for the computing devices. In some implementations, the memory may include multiple different types of memory, such as static random access memory (SRAM), dynamic random access memory (DRAM), or ROM.

Turning to the contents of the content-creation computing device 140 memory in more detail, the memory may include an operating system, one or more application programs or services for implementing the features disclosed herein including at least providing and/or displaying content (e.g., through a content-creation module 1130), such as via a browser application or dedicated applications (e.g., smart phone applications, tablet applications, etc.). The browser application may be configured to receive, store, and/or display a website or other interface for interacting with the servers. Additionally, the memory may store access credentials and/or other user information such as, but not limited to, user IDs, passwords, and/or other user information. In some examples, the user information may include information for authenticating an account access request such as, but not limited to, a device ID, a cookie, an IP address, a location, or the like.

In some embodiments, the content-creation module 1130 can be configured to generate new content. For example, the content-creation module 1130 can be configured to capture an image, identify a file (e.g., stored locally on the computing device, stored remotely on a data store or distributed storage device), provide a link to a file (e.g., audio, image, video, text), or otherwise identify a new content. In some embodiments, the content may be available on the server's data store or previously provided to a channel so that the new content is “new” for a new or amended channel although not necessarily new to the server and/or data store.

The content-creation module 1130 may also be configured to upload the new content item. For example, once the new content is identified, the content may be uploaded, provided, and/or stored at the server as a new content item. The uploaded content may be identified by a publisher operating the computing device as a new content item. In some embodiments, the content-creation module 1130 may also be configured to associate a temporal factor with a new content item (e.g., time transmitted from a source to the computing device, time uploaded to the server from the computing device).

In some embodiments, the publisher may include information about the content item. For example, the content items can include an identifier, title, description, keywords, time to display the content item, or destination. The corresponding information may also include product information, promotion details, or institution-level notifications and can dynamically change in time.

In some embodiments, the publisher can periodically update content (e.g., images, videos or text) based on, e.g., current or future promotions, new product launches, or recent events. For example, a particular publisher may provide promotions based on a holiday season, so that the content items provided via the content-creation module 1130 in March may relate to Saint Patrick's Day while the content items provided via the content-creation module 1130 in July may relate to Independence Day. In another example, the publisher can periodically upload content items for a golf channel (e.g., images identifying results of recent golf tournaments, videos promoting sales on golf clubs, text about golfers, or text and images identifying weather conditions at nearby golf courses).

The content-creation module 1130 may also be configured to alter an existing content item. For example, the user may access a graphical user interface (GUI) that allows the user to search for uploaded content item(s), retrieve information provided about the content item, and/or provide updated information about the content item (e.g., a new destination, a new default display duration).

The content-creation module 1130 may also be configured to specify a destination of a content item. For example, the publisher can specify a destination (e.g., a webpage, such as an ordering webpage, an event-registration webpage, or an informational webpage) for each of one or more content items.

The content-creation module 1130 may also be configured to specify instances that can cause a user device to be directed to the destination. For example, pressing a particular key during a display of a content item can cause the user device to request and display a destination webpage. The webpage may provide additional information pertaining to the content item displayed.

The content-creation module 1130 may also be configured to provide feedback to a publisher. For example, a user may interact with a content item provided by a particular publisher and cause the device to route to the destination. A server and/or computing device may track the interaction and, when the server and/or device supports the generation of, e.g., marketing statistics for a publisher, the content-creation module 1130 may receive this information from the server and provide the marketing statistics to the publisher. It should be appreciated that the marketing statistics may be provided via a webpage, software “app”, or other method other than the content-creation module 1130.

The content-creation module 1130 may also be configured to generate and/or transmit an invitation to join a channel. For example, the invitation can include an identification of the channel and/or content item(s) provided by the channel. In some embodiments, the invitation may be based in part on an analysis and/or recommendation for one or more particular channels for the one or more content-display computing devices to accept or reject.

Turning to the contents of the content-display computing device 150 memory in more detail, the memory may include an operating system, one or more application programs or services for implementing the features disclosed herein including at least requesting, receiving, and/or displaying content (e.g., through a content-request module 1170 and/or a content-display module 1180), such as via a browser application or dedicated applications (e.g., smart phone applications, tablet applications, etc.). The browser application may be configured to receive, store, and/or display a website or other interface for interacting with the servers. Additionally, the memory may store access credentials and/or other user information such as, but not limited to, user IDs, passwords, and/or other user information. In some examples, the user information may include information for authenticating an account access request such as, but not limited to, a device ID, a cookie, an IP address, a location, or the like.

In some embodiments, the content/channel request module 1170 can be configured generate a subscription request. For example, the computing device accesses an application (e.g., a web browser, a software “app” on a mobile device) to communicate with one or more servers via the network to submit the subscription request. The application can present a form (e.g., via an application programming interface (API)) or similar type of graphical user interface (GUI) to accept user input that is relevant to the one or more content items.

In some embodiments, the subscription request can cause content items for the channel to be periodically sent to the computing device for display on the computing device. For example, the subscription request can contain information about the requester or request, including one or more identifiers of the user (e.g., name, email address, phone number), identifiers of the computing device (e.g., an IP address), identifiers of a type of device (e.g., mobile device, laptop, desktop, tablet or particular brand thereof), identifiers of the content item(s) and/or channel, operating system(s), channel-related preferences (e.g., when content items are to be received, a limit on a number of content items, a type of content item such as image or video, whether to accept sound-inclusive content items, size of screen, a number of current channel subscriptions, historical time in display mode, where the channel will be ranked amongst other channels, etc.), or other information.

The content/channel request module 1170 may also be configured to identify a user, so that the subscription request corresponds with a user for one or more computing devices, rather than corresponding with a particular computing device.

The content/channel request module 1170 may also be configured 1111 to transmit a subscription request to subscribe to a channel. For example, the computing device accesses an application (e.g., a web browser, a software “app” on a mobile device provided by the content/channel request module 1170) to communicate with one or more servers via the network to submit the subscription request. The application can present a form (e.g., via an application programming interface (API)) or similar type of graphical user interface (GUI) to accept user input that is relevant to the one or more content items. The user may interact with the application and prompt a generation of a subscription request that includes the information. The subscription request can be transmitted to the server via a network (e.g., the Internet). In other examples, the user can send a communication message (e.g., email, phone call) that includes the relevant information, which the server can analyze (e.g., parse, store).

The content/channel request module 1170 may also be configured to determine a playlist. For example, the subscription request may request weather information when the device enters an idle state. The content/channel request module 1170 may be configured to identify a weather rule and alter an existing playlist (e.g., adding the rule) or generate a new playlist that includes the rule. In some embodiments, as shown above, the server (e.g., the user module 420 at the publishing server 110) may alternatively determine a playlist.

The content/channel request module 1170 may also be configured to request additional information from a server. For example, the computing device can transmit a communication (e.g., including an identification of the content item) to the server. The server may respond to the communication with an identifier of the destination.

The content/channel request module 1170 may also be configured to provide information to a server and/or publisher to enable a server and/or publisher to generate a recommendation. For example, the recommendation can be based in part on a content-display computing device's past history (e.g., subscription, destination access), past preferences (e.g., priorities, playlists), likes/dislikes, explicit searches (e.g., received prior to a subscription request), or location-based searches (e.g., zip code of the location of a computing device, address of a user, identification of nearby stores to a user that provide content items).

In some examples, the content-display module 1180 may be configured to receive content items sent to the computing device from a server. In some embodiments, the content-display module 1180 may be configured to receive content items when the device is in a channel state (e.g., via a network). In some embodiments, the content items may be received periodically at the content-display computing device 150.

The content-display module 1180 may also be configured to present the content item (e.g., while the computing device is in the display state). For example, the content-display module 1180 may interact with the display 1150-B to display the content item(s) via a user interface. In another example, the computing device may display the content item so that the content item is actively running on the computing device on top of the previously actively running application. The content item may be actively running when a content item is presented at the computing device. For example, the graphic, text, or series of graphics (e.g., in a video) can be presented on all or part of a display. When portions of the display are used to provide different content items at the same time, one or more of the portions of the display may provide one or more content items. When the content item includes sounds (e.g., an audio track, an audio/visual file), the sound can be output via a speaker at the computing device. In some examples, portions of the display at the computing device can be turned into a link area, such that an input corresponding to the area (e.g., a cursor click on the area) can cause destination information to be presented (e.g., an ecommerce page associated with the item presented as a content item).

The content-display module 1180 may also be configured to present content item(s) sequentially, in a particular order (e.g., based on a playlist or based on a priority rating provided by the computing device). For example, if a user subscribes to two channels, including a medicine channel that provides information on new drugs and clinical trials and a company event channel that provides information from a user's employer about new events provided by the company, the computing device may present the content items associated with the medicine channel before the any content items associated with the company event channel.

The content-display module 1180 may also be configured to present the content items according to a playlist. As discussed, a playlist may include one or more identifiers, where an identifier can identify one or more content items received through a channel that are displayed by the computing device. For example, the playlist may include one identifier for a content item from the golf channel, two identifiers for two content items from a company events channel, and one identifier for a content item from an internal medicine channel.

The content-display module 1180 may also be configured to determine which items to present. For example, upon detecting the event, the computing device may access the stored location of the received content items and present (e.g., display on the entire screen or a portion of the screen associated with the computing device, play audio content items via a speaker) any received content items. The presented content items can include a sequential or interleaved presentation of all content items received from the server, all content items associated with a particular channel, a subset of the content items in one or more channels, only new content items (e.g., content items received in the most recent transmission), recently received content items (e.g., over the past day regardless of the number of content items received the most recent transmission), or a specific number of content items.

The determination of which content items to present can consider a variety of factors. For example, one or more channels may be ranked (e.g., based on the user's priority for viewing the content associated with the channel), and the content items associated with a particular highly-ranked channel may be displayed before other channels that are not as highly-ranked. In another example, the content items within the channel may be ranked (e.g., based on the user's priority for viewing particular types of content within a particular channel, including weather content items before player statistic content items in a golf channel), and the content items associated with a particular high ranking in the channel may be displayed before other content items in the same or other channels that are not as highly-ranked.

In some embodiments, the determination of which content items to present can be based on a user's past interaction with the computing device. For example, a content item associated with women's shoes may be displayed and selected by the user, directing the computing device to access the destination associated with the content item to purchase the shoes (e.g., an ecommerce shopping webpage). The content display module 1180 can be configured to determine that the user is more interested in women's shoes than weather. In a subsequent presentation of content items, the content items associated with women's shoes, women's fashion, and/or another related topic can be ranked higher than other content items and displayed before other content items.

In some embodiments, the presenting of content items at the computing device can be associated with a temporal factor. For example, the temporal factor can include a time (e.g., an hour, minute, day, or date) at which the content item was uploaded to or otherwise received at the server (e.g., from a publisher), a time at which the content item was transmitted to or received at the computing device, a time at which the content item was displayed at the computing device, or the time at which the content item was transmitted from the server to the computing device. These times can be used (globally or within a channel) to, e.g., bias towards showing older content items first or showing newer content items first. In some examples, the higher ranked content items may be presented in association with the time. In some examples, the content items can be presented in association with upcoming sales, events, or other specified times.

The content-display module 1180 may also be configured to randomly select content items for presentation. The determination of which content items to present may include a random selection and/or sequential ordering. For example, the content items may be presented in the order that the items were received from the server during the channel state (e.g., most recent items first). In another example, the content items may be presented based on alphabetical listing, identifier ordering, or purely random ordering.

The content-display module 111180 may also be configured to detect an event indicative of entering a display state. For example, the event may include a period of inactivity, interaction with a keyboard (e.g., a selection of a predefined key, like an F10 key to enter the display state), cursor movement, voice command, or a pre-determined amount of time.

The content-display module 1180 may also be configured to detect an event indicative of exiting a display state. For example, the event may include an interaction with a keyboard (e.g., a selection of a predefined key, like an F9 key to exit the display state), cursor movement, voice command, or a pre-determined amount of time. In another example, the computing device can cease display of the content item(s) (e.g., the content items are, at least temporarily, no longer displayed on a screen of the computing device, audio is no longer played by the computing device speakers, and other forms of presentation are terminated).

The content-display module 1180 may also be configured to detect an interaction with the content item, including an interaction that identifies that the user would like to access a destination associated with the content item. For example, the interaction may include a selection of a predefined key, like an enter key or spacebar. In some embodiments, the user may press Alt-Tab to activate a graphical user interface (GUI) that allows the user to provide commands to interact with the content item and/or access the destination.

The content-display module 111180 may also be configured to enable the computing device to display content from a destination. In some embodiments, the destination may include a webpage, such as an ordering webpage, an event-registration webpage, or an informational webpage.

The content-display module 1180 may also be configured to determine a user's interests and/or adjust the priority/sequence of presentation. For example, the computing device can display content items related to weather and women's shoes. The user may access the destination associated with the content item to purchase the shoes (e.g., an ecommerce shopping webpage). The computing device can determine that the user is more interested in women's shoes than weather. In a subsequent presentation of content items, the content items associated with women's shoes, women's fashion, and/or another related topic can be ranked higher than other content items and displayed before other content items.

The content-display module 1180 may also be configured to help track displays and/or interactions with one or more content items. The tracking may support generation of, e.g., marketing statistics for a publisher and/or may be transmitted to a server to compile with other information.

The computing device may also be configured to include one or more input elements 1140 to allow a user to input information into the computing device (e.g., keyboard, a mouse, a pen, a voice input device, a touch input device, and the like). In some embodiments, the one or more input elements may also include elements to accept wired or wireless data transfer (e.g., data transmission).

The content-creation computing device 110 and content-display computing device 150 may also include other features. For example, the computing device may also be configured to include a display 1150 to allow a user to view one or more content items, message, and other information provided by the computing device.

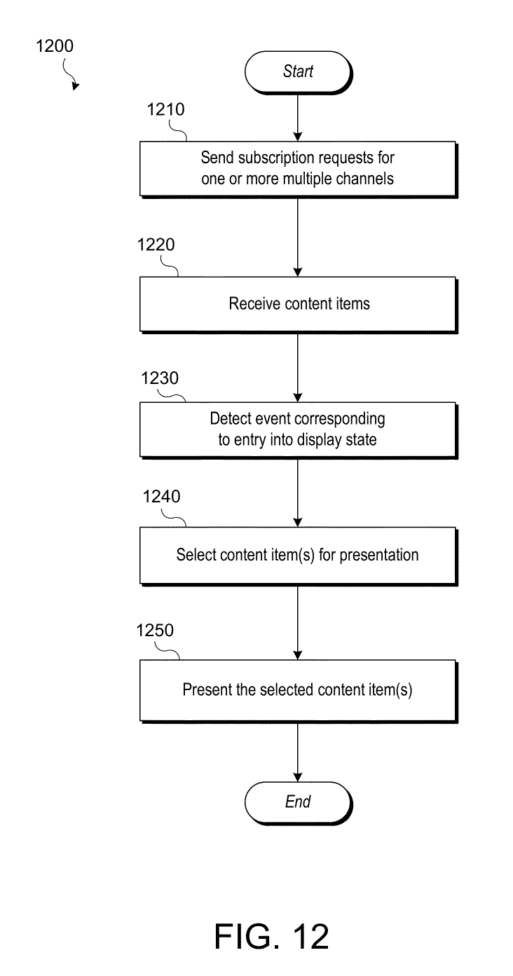

FIG. 12 illustrates an example flow diagram of a process 1200 for presenting channel content items according to an embodiment of the present invention. Process 1200 can be performed, e.g., by a computing device (e.g., of a user).

The process 1200 may begin at block 1210 by sending one or more subscription requests (e.g., to a server). Each subscription request can identify one or more channels. Each subscription request can further identify a user and/or computing device. In some instances, the subscription request identifies a user ranking or priority level for the channel. A subscription request can further include one or more limitations, such as types of content items or content categories to exclude or to be restricted to.

At block 1220, one or more content items can be received. The content item(s) can be responsive to the subscription request(s). In some instances, multiple content items are received (e.g., simultaneously or at different times), with at least some content items corresponding to different channels.

In some instances, at least one received content item is stored and not immediately displayed. In this instance, it can be hidden from other programs behind active content. Thus, a current display of a computing device can be focused on other active content or other screens (e.g., a desktop screen).

In some embodiments, the content item(s) associated with multiple channels may be stored in one or more locations. For example, the content items associated with one channel may be stored in a first data store (e.g., while the active content is displayed and the content items are hidden) and content items associated with a second channel may be stored in a second data store. In some examples, the content items may be stored in the same location with additional information to identify the channel association for the content item. For example, the data store can include a particular file structure to store and organize the content item(s) (e.g., by file name, date, size, file type, channel-type). The content items may be sorted or retrieved dynamically from the data store. In yet another example, the data store can be a transitive data store where content items are stored temporarily (e.g., cache) and/or deleted after a determined amount of time.

At block 1230, an event corresponding to the entry into a display state is detected. For example, the event can include passage of a threshold amount of time of inactivity at the computing device or detection of a particular keystroke or cursor selection. The event can cause the computing device to enter the display state.

At block 1240, one or more content items are selected for presentation. The selection can be based on, e.g., a playlist (e.g., selecting all content items in a playlist or selecting a first content item or a first group of content items in the playlist), channel rankings or priority, a publisher's rankings or specifications prioritizing items, pseudo-random selection, times associated with content items, a current time and/or which content items were previously presented to a user or on a computing device. In one instance, a user can dynamically change which channels, from amongst a set of subscribed—to channels, are to be used for presentation. Content—item selections can then be accordingly restricted.

At block 1250, the process presents the identified content item(s). In instances in which multiple content items are selected at block 1240, the items can be presented in an order based on, e.g., a playlist (e.g., selecting all content items in a playlist or selecting a first content item or a first group of content items in the playlist), channel rankings or priority, a publisher's rankings or specifications prioritizing items, pseudo-random selection, times associated with content items, a current time and/or which content items were previously presented to a user or on a computing device. Content items can be seamlessly presented, such that an end of a presentation of one content item substantially coincides with a beginning of a presentation of another content item.

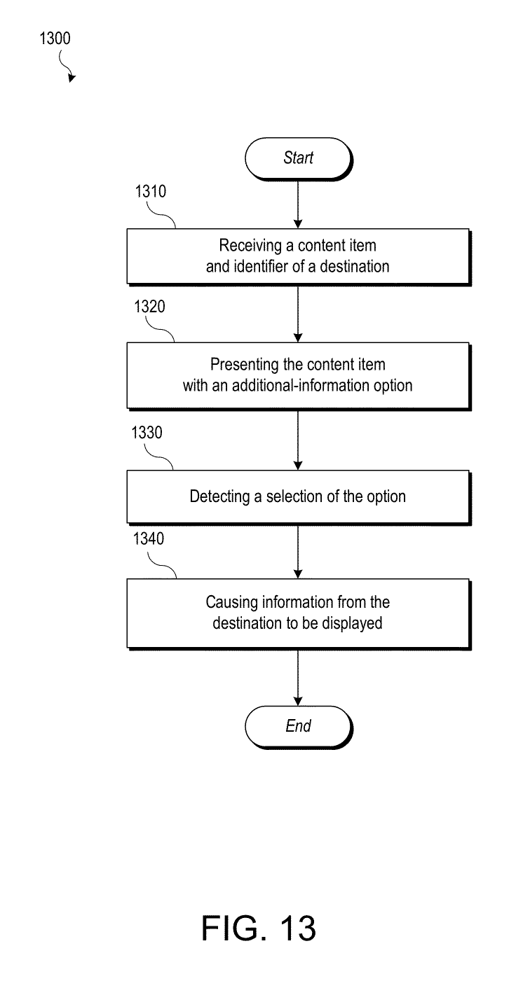

Content items can be presented in an interactive manner, whereby user interactions can influence what material is presented. In one instance, the effect of an interaction can be differentially defined for individual content items. FIG. 13 illustrates an example flow diagram of a process 1300 for displaying interactive channel content at a computing device according to an embodiment of the invention. As shown, various portions of the process can be performed by a computing device and/or a server. For example, blocks 1310-1330 can be performed by a computing device and block 1340 can be performed by a computing device or a server.

The process 1300 may begin at block 1310 by receiving a content item and identifier of a destination from a server. As described herein, the transmission of a content item (e.g., and an associated destination) can be triggered by an event such as entry into a display state, receipt at the server of a new content item, or detection that the computing device has access to the network and can accept content from the content delivery/receiving server 120. In another example, the computing device may receive the content item and identifier of a destination at defined times or intervals (e.g., daily, hourly, upon request to receive a content item, upon request to push a content item, based on a recurring subscription/rule).

As described herein, the content item may include an image, video, stream of data, audio, text, or other data provided to a computing device in an electronic format. The content item can include, e.g., product information, promotion details, event details, news, educational information and/or institution-level notifications and can dynamically change in time. In one instance, a computing device can periodically receive content based on current or future promotions, new product launches, or recent events from a publisher/server.

The identifier of a destination may be a location on a network page that is provided to the computing device when the computing device interacts with a content item. For example, a content item may include an item for sale, such as a pair of shoes. When a specific interaction with the computing device is detected, the computing device may be directed to the destination that sells the shoes, including a network page at a particular uniform resource locator (URL).

The computing device can receive the content item and identifier of a destination as a message from the server via a transmission channel. In some embodiments, the message may include additional information, including information about the publisher, an identifier of a user (e.g., name, email address, phone number), an identifier of an originating computing device (e.g., an IP address), an identifiers of the content item(s) and/or channel, or other information.

At block 1320, the process presents the content item. The content item can be presented in accordance with one or more applicable playlists. The content item can be presented for a duration as identified in correspondence with the content item or in a playlist. The presentation can include a visual and/or audio presentation.

The content item can be presented upon detecting a display event. For example, when the user is interacting with the computing device (e.g., by opening a document), the user may leave the document open while the device becomes inactive. The process may display one or more content items as active content, instead of or on top of the document on the display screen.

In some embodiments, the presentation of content item(s) and/or additional information may be displayed according to a playlist. For example, when the playlist identifies Image A as the first image to present for 5 seconds and identifies Image B as the second image to present for 10 seconds, the computing device may display the images as instructed.

The presentation can include an visible or invisible option to access additional information. For example, an explicit option can include presentation of a button or text indicating that selection of the button or entry of particular commands can direct the user to information related to the content item. An implicit option can allow for user interaction to direct the user to the destination but the display can lack any particular button, text or other indication about the commands necessary to prompt such action. In either scenario, the presentation can (but need not) include an interactive portion (e.g., box, link, image), where interaction with the interactive portion (any interaction or specific interaction) can direct the computing device to the destination. Additional information option can identify that additional information is available to a user. The additional information option may also or alternatively identify that a destination is associated with a particular content item.

At block 1330, the process detects a selection of the option. For example, the user can interact with the interactive portion by e.g., clicking, tapping, selecting, or swiping the interactive portion. In some instances, the user enters one or more keystrokes.

At block 1340, the process causes information from the destination to be displayed. For example, when the selection of the option is detected, the computing device may identify a destination provided by a publisher (e.g., a webpage, such as an ordering webpage, an event-registration webpage, or an informational webpage) for each of one or more content items. The computing device can communicate with the destination and/or receive information from the destination. The computing device can display the information received from the destination. In one instance, the computing device is directed to the destination. For example, a user can be directed to a destination webpage, such that it is displayed in a browser. In some (but not all) embodiments, display of destination information causes display mode to end.

FIG. 14 illustrates an interaction between a computing device and server for displaying a destination according to an embodiment of the present invention. A computing device 1402 may communicate through a network 1404 with a server 1406 (e.g., via a web browser, via a software “app”). For example, the computing device 1402 can submit a subscription request to receive content item(s) from one or more channels. The server 1406 can identify one or more content items associated with the subscription request and prepare the content items to transmit to the computing device. The content items may be transmitted by the server 1406 to the computing device 1402, including one or more content items (e.g., during a channel state).

The computing device 1402 may present a content item 1410 via an application (e.g., during a display state). The application 1410 may include a web browser or software “app,” so that the content item is noticeable when it is presented (e.g., displayed with a border, identified as a content item with a title or description). In some embodiments, the application 1410 may be unnoticeable (e.g., no border or splash screen before the application starts presenting content items). In some embodiments, the application 1410 may present the content item (e.g., image or video) at a full-screen so that a border of the application 1410 is not visible when presenting the content item(s).

The computing device 1402 may interact with the content item. For example, the user may press a key (e.g., space bar, enter key) to direct the computing device to display a destination 1412. The computing device may present the destination in the application 1410 (not shown).

In some embodiments, the destination 1412 is provided in a secondary application. For example, when the application that presents the content items is an app, the secondary application that presents the destination associated with the content item is a web browser. In some embodiments, the destination 1412 may be presented on top of application 1410.

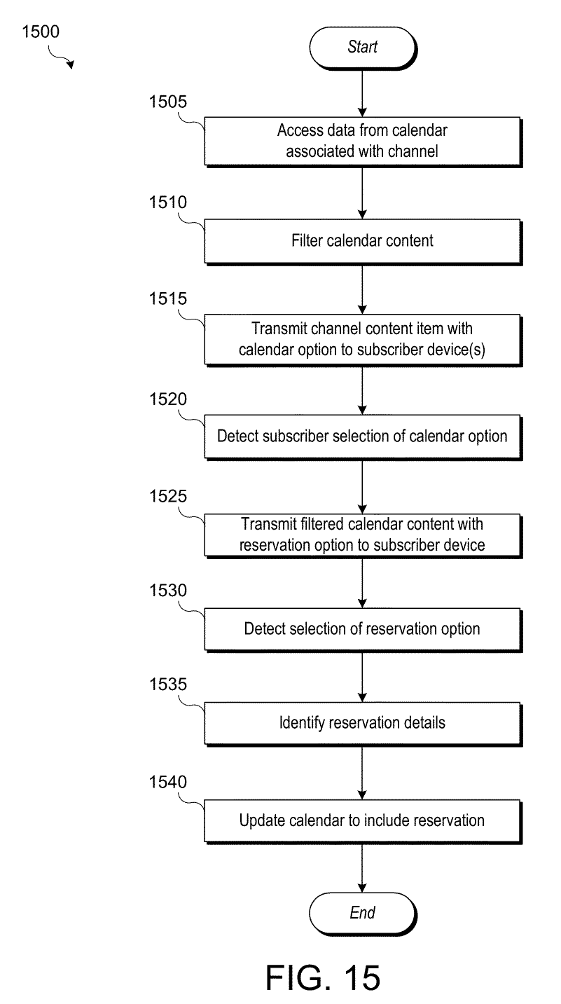

FIG. 15 illustrates an example flow diagram of a process 1500 for updating a channel-associated calendar based on subscriber input according to an embodiment of the present invention. All or part of process 1500 can be performed by a server (e.g. a publishing server 110 and/or a content delivery/receiving server 120). Process 1500 begins at block 1505 where data from an electronic calendar associated with a channel is accessed. The calendar can include one hosted by a server performing part or all of process 1500 or another server (e.g., a server providing an email service). Accessing the calendar data can include accessing part of data in the calendar, which may include (for example) accessing events within given hour and/or date ranges, accessing events having one or more particular categories, etc. The calendar data can be accessed, e.g., by executing or using a script, plug-in, application programing interface (API) and/or app. Accessing the calendar data can include retrieving calendar data from local storage, requesting calendar data from a remote source (e.g., a remote server) and/or receiving calendar data from a remote source. In some instances, the calendar data can be accessed at least partly due to a client's previous download or execution of script, plug-in, API and/or app. In some instances, the calendar data can be accessed at least partly due to a client having previously provided identifying and/or security information (e.g., a calendar identifier, a login, and/or password).

The accessed calendar data can add any of a variety of types of specificity. For example, calendar data can include the general availability, such as time blocks associated existing appointments in which time blocks are not. As another example, calendar data can include moderate detail, such that data can identify appointment dates and times and can further identify the appointment purpose (e.g., haircut, animal checkup, massage, etc.). As yet another example, calendar data can include specific detail, such as appointment dates and times, appointment purposes, and information about appointment attendees (e.g., names, email addresses, phone numbers, etc.). In some instances, the degree of specificity varies across access data. For example, specific detail can be collected for work appointments, and only general availability can be determined based on non-work appointments.

At block 1510, the calendar data can be filtered. The filtering can include, for example, filtering based on time (e.g., such that only work hours are represented), filtering to remove detail (e.g., such that appointment attendees and appointment purposes are not reflected), changing a time increment the calendar, filtering to representations of appointments such that the filtered calendar only identifies some or all available time blocks, etc.

At block 1515, a channel content item the calendar option is transmitted to each of one or more subscriber devices, each subscriber device being associated with a subscriber of the channel. The channel content item can include an item as described in various embodiments disclosed herein, such as one that includes a promotion, a notification, news, a new-product alert, etc.

Transmitting the content item with a calendar option can include transmitting the content item along with an indication that the calendar option is to be presented, transmitting the content item along with a calendar destination or identifier, transmitting a content item that includes a calendar option, etc. In some instances, the content item is not transmitted with any explicit calendar option, but a rule (e.g., a general rule or one based on a publisher preference or channel configuration) indicates that the content item is to be presented with the calendar option (e.g., based on its association with a channel or publisher, based on a characteristic of the content item, etc.).

The calendar option may be associated with a visual identifier, such as an icon or text (e.g., “Calendar”, “Reservation” or “Book now”), or may not (e.g., such that the channel is configured such that a known interaction, such as a keystroke, is interpreted as a calendar request). The representation of the calendar option (or lack thereof) may, or may not, vary across channels, subscriber devices, etc.

In some instances, all channel content items are to be presented with a calendar option. In some instances, the calendar option is only to be presented with a subset of channel content items (e.g., those of particular publishers, those for particular channels, those categorized or identified as such by a publisher, etc.). In some instances, whether a channel content item is to be presented with a calendar option depends on a subscriber preference, a subscriber device and/or a condition (e.g., whether there are any calendar openings within a set, publisher-defined or subscriber-defined time period).

At block 1520, a subscriber selection of the calendar option is detected. The detection can include receiving and processing a communication from a subscriber device that identifies a user action associated with the calendar option. The user action can include entry of one or more keystrokes, touching a screen location associated with the calendar option, clicking a mouse while a cursor is at a screen location associated with the calendar option, etc. The communication can include an identification of one or more: a user, a user device, a content item being viewed at the time of selection, an option selected, a selection time, and so on.

In response to the detection, the filtered calendar content is transmitted to the subscribed device at block 1525. The filtered calendar content can include an image, text, a list, a table, etc. For example, the filtered calendar content can include: a calendar graphic with identifications of scheduled events (e.g., appointments) or availability or an identification of one or more (e.g., a list of) available time slots (for reservations or appointments) or events.

In some instance, an image, text, list or table is generated locally at a subscriber device based on transmitted filtered calendar content. For example, the transmitted calendar content can include identifications of upcoming availability on a calendar, and the content can be used to generate a calendar graphic representing the availability. As another example, the transmitted calendar content can be processed along with a subscriber calendar and the image, text, list or table can be generated based on a result of the processing (e.g., identifying shared available time slots, identifying events of a type pertinent to the user, etc.).

Transmitting the filtered calendar content with a reservation option can include transmitting the calendar content along with an indication that the reservation option is to be presented, transmitting the calendar content along with a reservation destination or identifier, transmitting a content item that includes a reservation option, etc.

The reservation option may be associated with a visual identifier, such as an icon or text (e.g., “Reservation” or “Book now”), or may not (e.g., such that the channel is configured such that a known interaction, such as a keystroke, is interpreted as a calendar request).

At block 1530, a subscriber selection of the reservation option is detected. The detection can include receiving and processing a communication from a subscriber device that identifies a user action associated with the reservation option. The user action can include entry of one or more keystrokes, touching a screen location associated with the reservation option, clicking a mouse while a cursor is at a screen location associated with the calendar option, etc. The communication can include an identification of one or more: a user, a user device, a content item being viewed at the time of selection, an option selected, a selection time, and so on.

In some instances, in response to the reservation option being selected, a corresponding subscriber device can present a reservation interface to allow the subscriber to select between reservation options and/or enter reservation requests. In some instances, no further information is needed (e.g., the selected reservation option may already correspond to a specific date and/or time).

Reservation details are identified at block 1535. In one instance, a communication is received from a subscriber device that identifies a reservation time and/or date, an identification of the subscriber and/or an identification of the subscriber device. Other details can include, e.g., a requested service, a number of people, a discount code, and so on.

The communication can be sent from the subscriber device upon locally detecting the reservation option or upon receiving additional information. For example, selection of the reservation option may cause a reservation interface to be presented on the subscriber device which can receive inputs from the user. Upon entering information and submitting the reservation request, the communication can be generated and transmitted.

In some instances, identifying reservation details includes associating an identifier of a subscriber or subscriber device with other information. For example, a subscriber identifier may be used to identify an account that includes one or more of a subscriber's: name, residence address, residence city, phone number, credit card number, payment identifier, email address and so on.

At block 1540, the channel calendar is updated to include a reservation. The reservation can include or can be made in accordance with one or more of the identified details. The reservation can be made at a time as identified in the identified details. The reservation can be made for a person as identified in the details. Updating the calendar can include accessing a modifying the calendar using a technique as described in association with block 1505. In some instances, the update is conditioned upon approval by a publisher or calendar manager. Thus, for example, a tentative calendar appointment can be generated and sent to the publisher or calendar manager for approval. A confirmation of the reservation can be sent to the subscriber device associated with the reservation. In some instances, updated calendar data is transmitted to one or more subscriber devices (e.g., upon updating the calendar and/or in response to subsequent detection of calendar-option selections).

It will be appreciated that, in some instances, the channel content item and/or the filtered calendar content can be transmitted at blocks 1515 and 1525, respectively, without the respective calendar and reservation option. In some instances, the transmission can include an indication that the calendar option and/or reservation option are to be presented, or a rule (e.g., a general, client-specific or channel-specific rule) can indicate that the option is to be presented. A subscriber device can then cause the option to be presented with the content item (e.g., by presenting the option on or next to the content item or by modifying the content item to include the respective option).

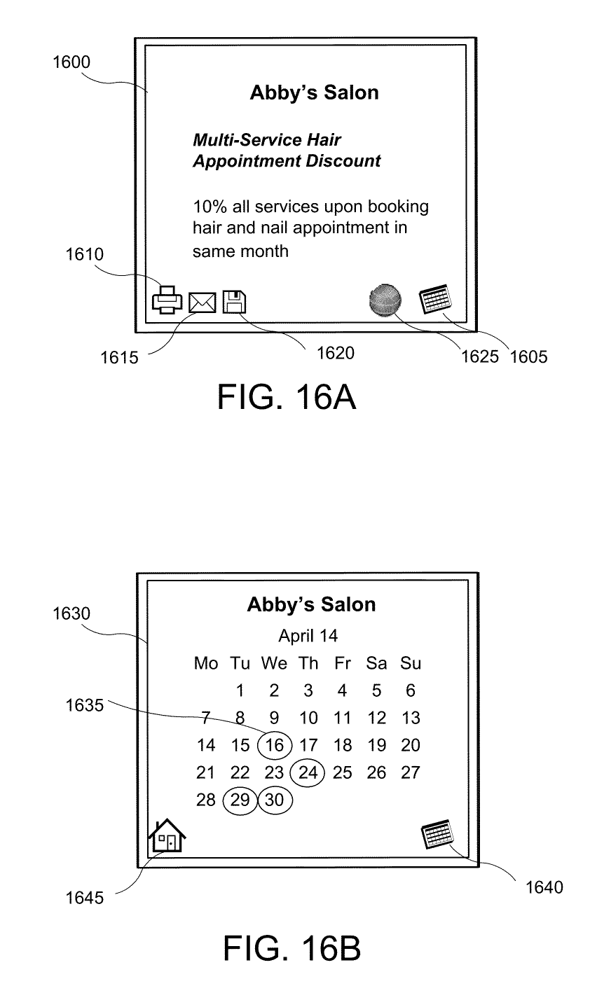

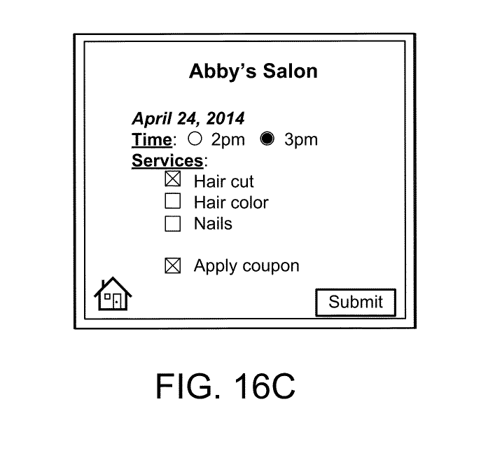

FIG. 16A shows an example of a displayed content item 1600 with a calendar option 1605. In this example, the content item includes text identifying a discount. Calendar option 1605 includes an icon positioned along a bottom border of content item 1600. The icon can include an opaque or transparent icon. The icon may be positioned on a content item or next to a content item.

In the example shown in FIG. 16A, calendar option 1605 is one of a plurality of options. Additional options includes a printing option 1610, sharing option 1615, saving option 1620 and location option 1625. Selection of printing icon 1610 can cause a displayed content item to be printed (e.g., by opening a printing interface filled with default and modifiable printing information). Selection of sharing icon 1615 can present the user with options to send the content items to one or more other devices via, e.g., email, a social networking service, text message, etc. The user may then, or may have previously, entered login information for the user's email account or social networking account. The user can identify recipients by, e.g., name, email address, phone number, contact list, etc. The content item can then be sent and/or posted.

Selection of saving icon 1620 can cause the content item to be saved. For example, the content item may be saved to a local folder on the user's computing device. An interface may allow the subscriber to identify a name for the content item and/or a saving destination (e.g., folder), or a default naming convention and/or saving destination may be used. The user may then be able to locally retrieve the item. As another example, and/or an indication can be sent to a server that identifies the content item, as well as the subscriber and/or subscriber device. The user may then be able to request access to saved content items, and the server can send an indication as to which content items were saved for the particular user or device and/or may send one or more saved content items themselves.

FIG. 16B shows an example of displayed calendar content 1630 displayed in response to selection of calendar option 1605. In this instance, the calendar content includes one or more availability indicators 1635 that indicate dates with appointment availability. In this instance, selection of either an availability indicator 1635 or of a reservation option 1640 (represented by a same icon as the icon for the calendar option, though the representations may instead differ) can cause a reservation interface to be presented. (Alternatively, selection of a return option 1640 can cause a device to return to displaying channel content.)

FIG. 16C shows an example of a reservation interface displayed in response to a user selection of the availability indicator 1635 shown in FIG. 16B in association with April 24. The interface can display one or more available appointment times and available appointment types. It will be appreciated that other options or information may additionally or alternatively be presented (e.g., particular service providers and/or cost). In this instance, the interface does not request identifying information (e.g., name, phone number, email address, etc.) because the user device is already associated with an account that includes such information. However, it will be appreciated that such information may instead by requested and/or required. As shown, the interface further includes a capability for a channel-associated discount to be applied. The discount may be one identified on a content option presented with the selected calendar option, one presented on a saved content item, one independent from the channel (e.g., such that the user may have to identify the discount), one earned based on channel rewards, etc.

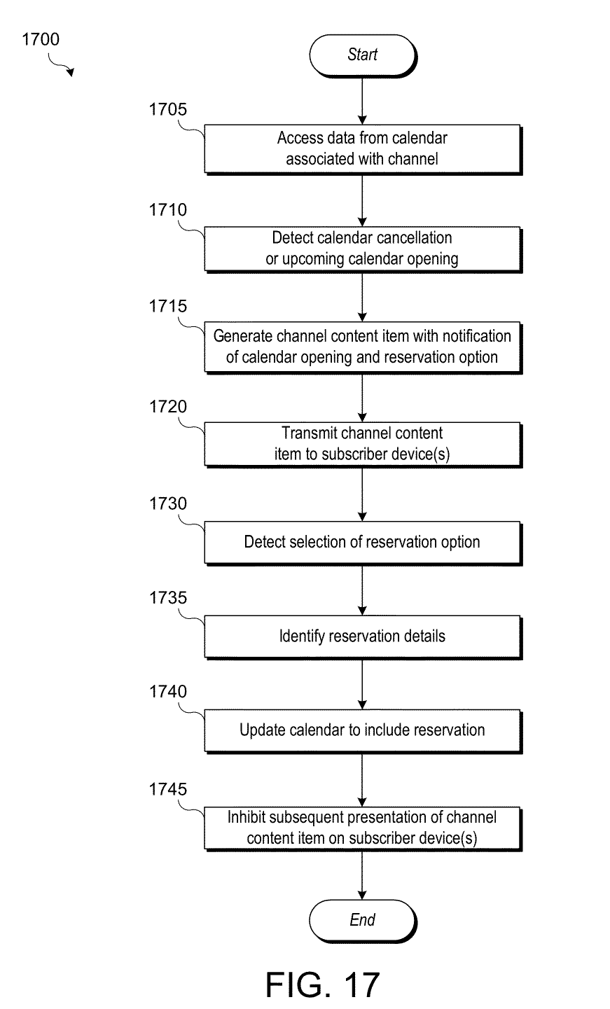

FIG. 17 illustrates an example flow diagram of a process 1700 for updating a channel-associated calendar based on subscriber input according to an embodiment of the present invention. All or part of process 1700 can be performed by a server (e.g. a publishing server 110 and/or a content delivery/receiving server 120). Process 1700 begins at block 1705 where data from a calendar associated with a channel is accessed. Block 1705 can parallel block 1505 of process 1500.

At block 1710, a calendar cancellation or an upcoming calendar opening is detected. For example, a server can receive an indication from a subscriber device, publisher, calendar-managing server or other device indicating that an appointment previously present on the calendar is to be moved or canceled. As another example, a server can monitor a portion of the calendar corresponding to a defined upcoming time period to determine whether there are any openings. For example, the time period can include two weeks following a present time, a time period beginning at a beginning of a next work day and ending one month after the next work day, a present day until 5 pm, etc. The time period can include a default time period or one fully or partly defined by a publisher or calendar manager. Block 1710 may include determining whether an identified calendar opening meets one or more criteria. For example, it may be required that the opening be within working hours and/or be of at least a threshold duration.

A channel content item that includes a notification of the calendar opening is generated at block 1715. The content item can include, e.g., an image, list, text, table, etc. The content item may identify details of the detected cancellation or calendar opening (e.g., a date and/or time of an availability, an available service provider, one or more available types of reservations (e.g., party size, service type, etc.)). In some instances, the content item includes a calendar. The content item may focus on or only identify the availability corresponding to the detected cancellation and/or opening or may include a plurality of availabilities.

The generated channel content item can include or can otherwise be associated with (e.g., at the server or at a subscriber device) a reservation option. Embodiments of potential inclusion or association of the reservation option, properties of the reservation option and/or consequence of selection of the reservation option are further elaborated upon in the description of process 1500 (e.g., the description of block 1525).

The channel content item is transmitted to devices of one or more subscriber devices at block 1720. For example, the channel content item can be transmitted to one, more or all devices subscribed to the channel or to a device (or all devices) associated with each of one, more or all subscribers of a channel.

Upon receiving the channel content item, each subscriber device may immediately present the channel content item, immediately present the channel content item if the device is in a display state, present the channel content item upon completion of a display of a content item currently being displayed, immediately present the channel content item upon device entry into the display state, present the channel content items before (any or some) other content items associated with the channel, present the channel content items before (any or some) other content items associated with some or all other channels, etc. Thus, in some instances, the channel content item is prioritized. In other instances, the channel content item is presented in accordance with normal operations as described herein.

The channel content option can be presented with a reservation option that can enable a subscriber to request or claim a calendar opening, as further described with respect to process 1500. Blocks 1730, 1735 and 1740 can parallel blocks 1530, 1535 and 1540 of process 1500.

At block 1745, subsequent presentation of the channel content item is inhibited on one or more subscriber devices. For example, an updated channel content item can be generated and transmitted to one or more subscriber devices or an instruction can be sent not to present the channel content item. The one or more subscriber devices may, or may not, include the subscriber device associated with the reservation. The inhibition can prevent or reduce in number other subscribers from attempting to request a reservation for the same opening.

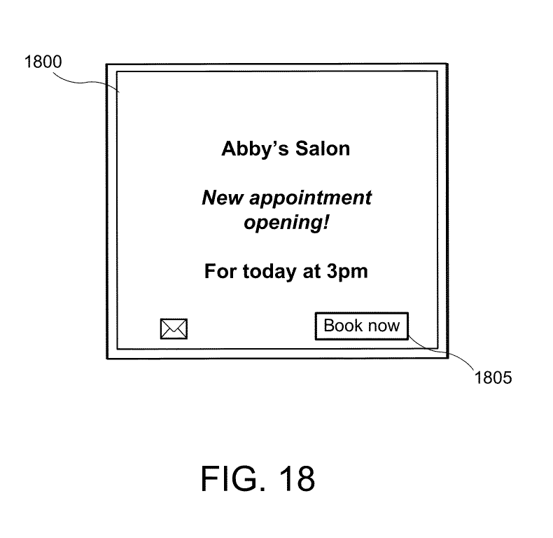

FIG. 18 shows an example of a displayed content item identifying a calendar opening. In this example, the content item identifies an available appointment date and time and an identifier of a service provider. A reservation option 1805 is further presented in association with the content item. In this instance, selection of reservation option 1805 causes a reservation request to be immediately transmitted from a subscriber device (e.g., to a publishing server, a content delivery/receiving server or a server in communication with a publisher). The communication can include an identifier of the subscriber device and/or an associated subscriber and can include data corresponding to the appointment identified in the content item. It will, however, be appreciated that alternatively, additional data may be collected from a subscriber prior to sending the communication.

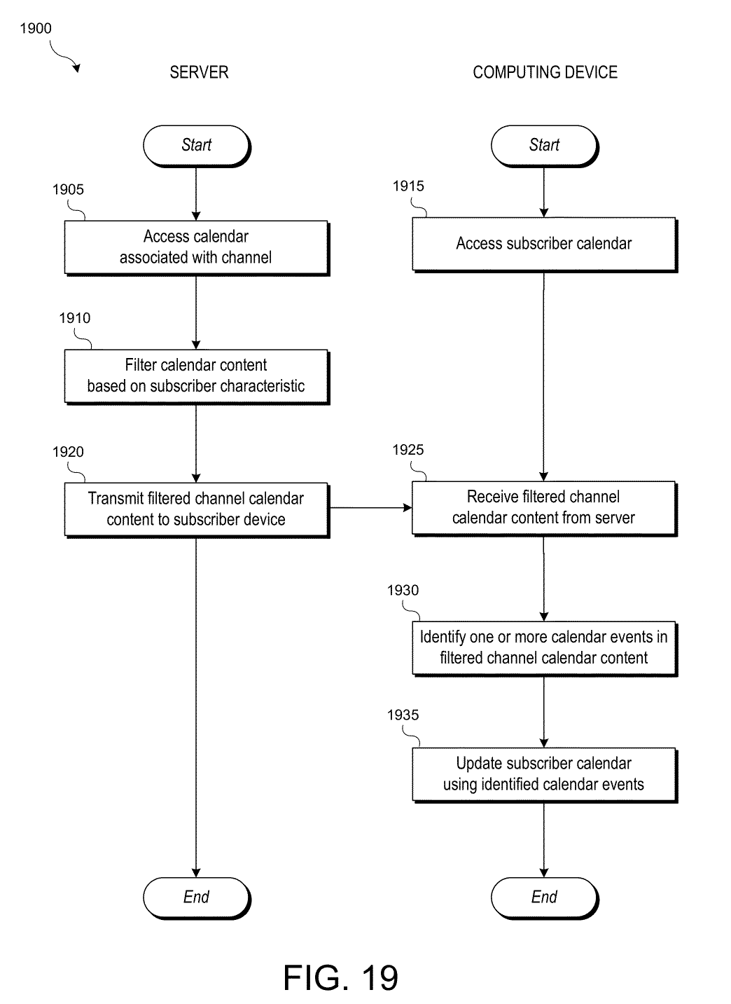

FIG. 19 illustrates an example flow diagram of a process 1900 for using a channel-associated calendar to update a user calendar according to an embodiment of the present invention. As shown, various portions of process 1900 can be performed by a computing device (e.g., a content-creation computing device 140, a content-display computing device 150), and other portions can be performed by a server (e.g. a publishing server 110 and/or a content delivery/receiving server 120).

Process 1900 begins at block 1905 where a server accesses data from a calendar associated with a channel. Block 1905 can parallel block 1505 of process 1500. Events in the calendar can correspond to appointments, practices, competitions, deadlines, exams, meetings, promotion time periods, etc.

In some instances, the server filters calendar content at block 1910 based on a characteristic associated with a subscriber. The characteristic can be automatically determined (e.g., based on communications from a subscriber device), determined based on a subscriber profile, determined based on a subscriber's channel subscriptions, determined based on input from a publisher and/or the subscriber, and so on. The filtering can be performed, for example, based on a subscriber's: preference, membership, enrollment, age, skill level, gender, etc. To illustrate, a calendar may include game and practice times for all county sports. The filtering can filter out game and practice times except for those involving a team on which a subscriber is a member.

At block 1915, a subscriber device associated with a subscriber of the channel accesses data from a calendar associated with a subscriber. For example, the calendar can include one stored on a subscriber device, a calendar associated with an email account of the subscriber, one identified by the subscriber, etc. The calendar can be accessed in a manner similar to that described in relation to block 1505.

The filtered channel calendar content can be transmitted from the server to the subscriber device at block 1920 and can be received by the subscriber device at block 1925. The transmission can occur, e.g., at a scheduled time, upon detecting a change in calendar content, in response to detection of a request by the subscriber for calendar content, etc.

At block 1930, the subscriber device identifies one or more calendar events represented in the filtered channel calendar content. In some instances, all calendar events are identified. In some instances, the calendar events are filtered at the subscriber device (in addition to or instead of the filtering performed at block 1910). The filtering can include filtering of a type described in relation to block 1910. In some instances, the filtering removes some or all calendar events that overlap (e.g., partly or entirely) with calendar events in the subscriber calendar. In some instances, the filtering includes receiving opt-in or opt-out inputs from a subscriber to identify or exclude select events.

At block 1935, the subscriber calendar is updated based on the one or more calendar events. The updating can include adding the one or more events to the subscriber calendar. The one or more events can be added in a manner such that the events are identified as being associated with the channel, a publisher of the channel and so on. Depending on the embodiment, the subscriber may or may not be notified of the update. If such a notification occurs, it may be general (e.g., presenting an icon representing new calendar events, “Calendar update occurred” or “New calendar events from Channel ABC”) or specific (e.g., listing information for each new event).

Thus, merely by subscribing to a channel, a subscriber's calendar may be kept current with some or all events associated with the channel. This may occur across all channels and/or select channels (e.g., depending on whether a publisher and/or subscriber indicated that calendar pushing is to occur).

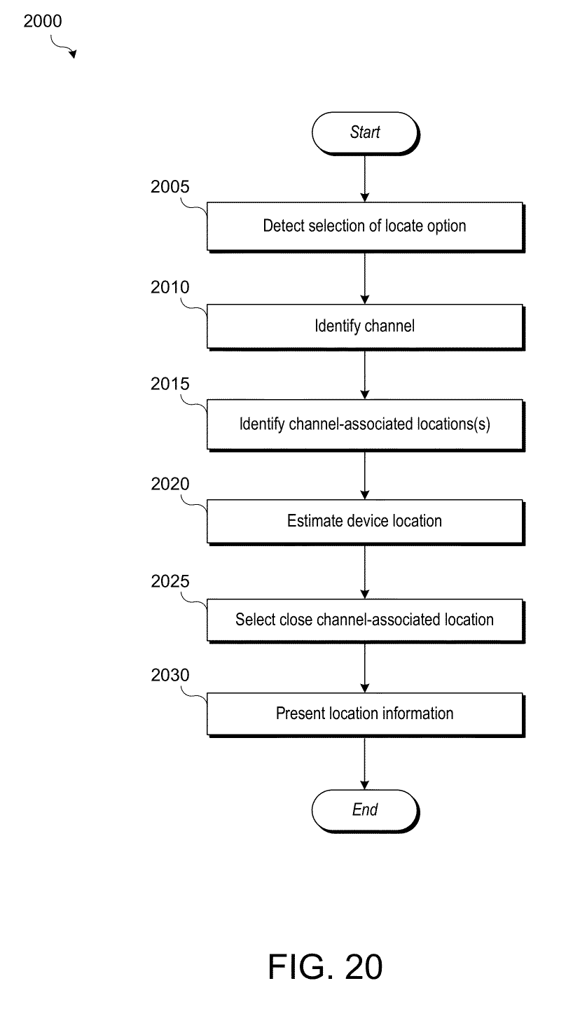

FIG. 20 illustrates an example flow diagram of a process 2000 for identifying a channel-associated physical location according to an embodiment of the present invention. All or part of process 2000 can be performed by a computing device (e.g., a content-creation computing device 140, a content-display computing device 150), such as a computing device of a channel subscriber. Process 2000 begins at block 2005 where the computing device detects a selection of a locate option. The locate option can be one presented in association with (e.g., simultaneously with, next to, on, etc.) a content item from a channel or one presented on a channel management or access page.

The locate option can be presented in association with all content items, all content items associated with select channels, some content items associated with one or more channels, etc. For example, a publisher may be able to indicate whether a locate option is to be presented in associate with all of a given channel's content items, with a channel's content items with a given property or with none of the channel's content items. In another example, the locate option may be presented in association with content items for each channel that is associated with one or more retail locations.

The locate option may be associated with a visual identifier, such as an icon or text (e.g., “Find store”), or may not (e.g., such that the channel is configured such that a known interaction, such as a keystroke, is interpreted as a locate request). The representation of the locate option (or lack thereof) may, or may not, vary across channels, subscriber devices, etc. FIG. 16A shows an example of one locate option 1625.

At block 2010, a channel is identified. The identification can include determining which channel's content item was being presented at the time of the selection or was otherwise identified as being associated with the locate option.

At block 2015, one or more locations associated with the channel are identified. The identification can include retrieving one, more or all locations identified by a publisher as being associated with a channel (e.g., retail locations) or searching a database (e.g., a maps database or directory) using a name (e.g., a store name) associated with the channel.

A device location is estimated at block 2020. The device location may be estimated using device sensors and/or receivers, such as GPS receivers. Estimating the device location can include processing signals from satellites, access points, etc. Estimating the device location can include processing an IP address. Estimating the device location can include processing input. For example, previously or in response to block 2005, the subscriber device may prompt a user to enter an address, city and/or state, which may be used as the location.

The estimated device location can be used to select a channel-associated location at block 2025. For example, when multiple channel-associated locations are identified at block 2015, a location estimated to be closest (in terms of time or distance) to the device location may be identified. In one instance, multiple locations are selected (e.g., a threshold number of closest locations). In one instance, block 2025 involves sorting some or all channel-associated location based on distance or estimated travel time. The selection can also or alternatively include other factors. For example, the selection may be biased towards locations with upcoming appointment availability, with hour openings indicating that the location is or will be open (e.g., upon an estimated arrival of a subscriber), a service offering, etc.

At block 2030, the subscriber device presents location information to based on the result of block 2025. The location information can include, e.g., for each of one or more channel-associated locations (e.g., the selected location(s) or all locations), an address of the location, a geographical distance to the location, an estimated travel time to the location, hours, service offerings, customer review rating, etc. The presentation can include directions to a location.

To illustrate, a subscriber device may be presenting a content item for a retail chain that advertises a current promotion on a product. The presentation can further include a locate option. The subscriber may select the locate option, which may cause the device to identify stores in the chain which are located in a same metro city area as the device. The locations may be sorted based on distance from the device and presented in an order list of addresses to the user.

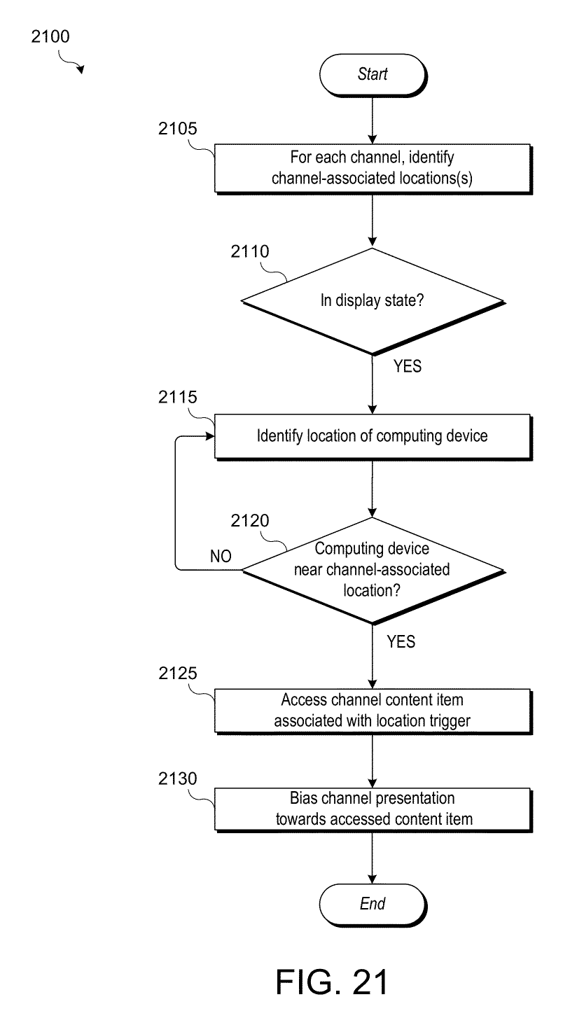

FIG. 21 illustrates an example flow diagram of a process 2100 for selecting and presenting channel content based on a location of a computing device according to an embodiment of the present invention. All or part of process 2100 can be performed by a computing device (e.g., a content-creation computing device 140, a content-display computing device 150).

Process 2100 begins at block 2105 where, for each channel, one or more channel-associated locations are identified. For each channel, the identification can include retrieving one, more or all locations identified by a publisher as being associated with a channel (e.g., retail locations) or searching a database (e.g., a maps database or directory) using a name (e.g., a store name) associated with the channel.

At block 2110, it is determined whether the subscriber device is in a display state. If so, process 2100 continues to block 2115 to estimate a location of the subscriber device. Block 2115 can parallel block 2020 of process 2000.

At block 2120, it is determined whether the subscriber device is near any of the identified channel-associated locations. What constitutes near in this inquiry can be defined based on a general rule or a rule specific to a channel, publisher, subscriber, etc. For example, a channel associated with a coffee house may define near as being within 0.1 miles, while a channel associated with a vet may define near as being within 2 miles. The nearness inquiry can further be evaluated based on distance and/or estimated travel time. In some instances, a positive result can be identified for multiple channels and/or channel-associated locations.

When it is not determined that the device is near any channel-associated location, process 2100 can return to block 2115 such that the device location can continue to be monitored and the proximity evaluation can continue to be assessed.

When the determination of block 2120 is positive, process 2110 continues to block 2125 where a channel content item associated with a location trigger is accessed. In one instance, determining that a device is near a location associated with a channel indicates that a content item for that channel is to be displayed and further, one or more select content items may be flagged to be presented in such situations. For example, a publisher may wish to provide discount content items to entice subscribers to visit a location. In one instance, determining that a device is near a location associated with a channel indicates that a content item for that channel is to be displayed though there are no constraints or biases as to which content items associated with the channel are to be displayed. Thus, in essence, all content items can be location triggered.

In some instances, the determination at block 2120 may indicate that the subscriber device is sufficiently near a location associated with each of a plurality of channels. In this case, block 2125 may include accessing one or more content items for each channel. Alternatively, the channels may be prioritized (e.g., based on user ranking of the channels, device-to-location distance, device-to-location travel time, publisher interest in location-triggered presentation, etc.) and the content item accessed at block 2125 may be one associated with the higher priority channel.

At block 2130, channel presentation is biased towards the accessed channel content item. For example, the content item may be immediately displayed (or displayed after the current content item's display is complete), or the content item may be the first to display when a playlist indicates that content from the channel is to be presented.

For example, a user may be walking downtown. A mobile device that the user is carrying may detect that the user is 0.1 miles away from a book store associated with a book-club channel that the subscriber subscribes to. The 0.1 may be within a 0.5-mile threshold associated with the channel, and a publishing server may then accordingly push a content item to the user that identifies a top-selling list for the book store. The push may cause an icon to appear on the mobile device to appear, such that the user can be alerted of the new channel content and choose to actively change the device state to the display state. The content item may then be presented along with a locate option that, if selected, will identify the location of the nearby book store.

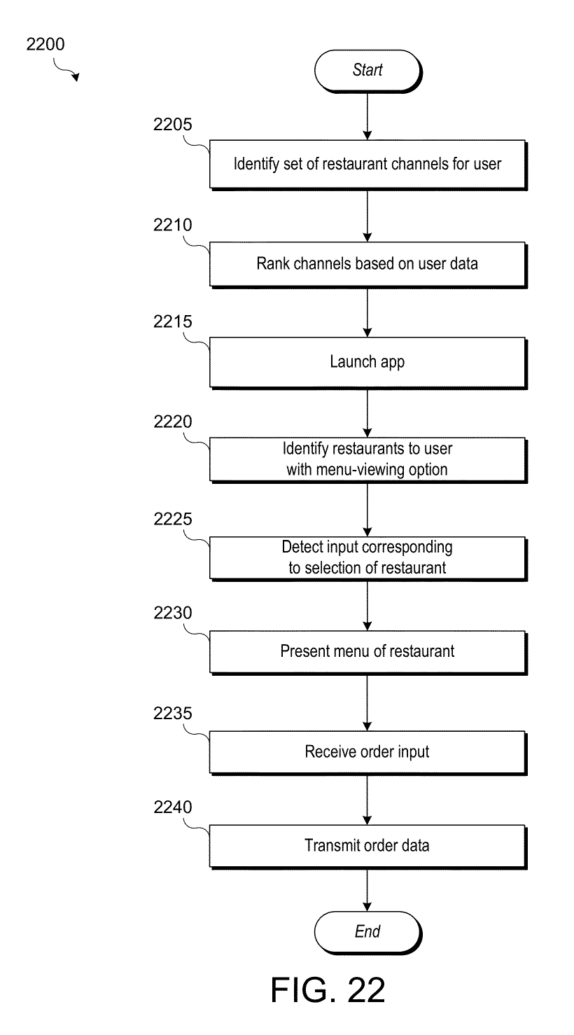

FIG. 22 illustrates an example flow diagram of a process 2200 for availing ordering capabilities from each of a set of restaurant channels according to an embodiment of the present invention. All or part of process 2200 can be performed by a computing device (e.g., a content-creation computing device 140, a content-display computing device 150).

Process 2200 begins at block 2205 where a set of restaurant channels are identified. The restaurant channels can include restaurant channels that a particular user has subscribed to, channels associated with a location near a current location of a user device or a user residential address, and/or channels matching a preference of the user.

At block 2210, the channels are ordered based on user data. The channels may be ranked, for example, based on one or more of: a number of times or a frequency at which a user has ordered from the restaurant using channel-associated means, a number of times or a frequency at which a user has viewed a menu, a user rating of the restaurant, a user profile characteristic, reviews from other users and overall cost of the restaurant, and so on.

A channel app is launched or activated at block 2215. Block 2215 may be performed in response to the user selecting the app. In some instances, block 2215 instead includes entering the display state.

An identification of each restaurant in the set of restaurants is identified to the user at block 2220. The presentation can include an option to view each restaurant's menu. The option can include, for example, an icon. In some instances, the option is the menu's name or other representation.

An input corresponding to selection of a restaurant is detected at block 2225. The detection can include detecting, for example, that a user touched a screen location or clicked when a cursor was at a screen location associated with a representation of the restaurant.

In response to the detection, an electronic menu for the restaurant can be presented at block 2230. The menu can be interactive, such that the user can select which menu items to order and/or order quantities. The menu can include menu items that correspond to various dishes. The menu can include, for each menu item, a price, one or more ingredients, a user ranking, etc. In some instances, one or more discounts are presented due to the user having subscribed to a station for the restaurant. In some instances, one or more discounts identified in a channel content item are applied (e.g., automatically or upon corresponding user action).

At block 2235, order input is received. The order input can include one or more of a selection of one or more menu items, a quantity of each of one or more menu items, a payment authorization, a submission, a tip, an indication as to whether the order is to be delivered or will be picked up, and so on.

Order data is transmitted at block 2240. The order data can reflect the order input. The order data can further include information associated with the a user device and/or user profile. For example, the order data can include a name and address of a user associated with a device receiving the order input.

Thus, a channel-distributing environment can provide the opportunity for a user to receive channel content from a restaurant, make a reservation at the restaurant and/or place an order at the restaurant. If the user is subscribed to channels of multiple restaurants, the channel-distributing environment can further provide the opportunity for the user to be able to view restaurant options efficiently and select amongst preferred options.

It will be appreciated that options discussed thus far to present in association with content items are illustrative. Additional or alternative options can be presented in association with content items, and publishers may be able to select which options to present and/or define options (e.g., identifying a representation of an option and a consequence of selection).

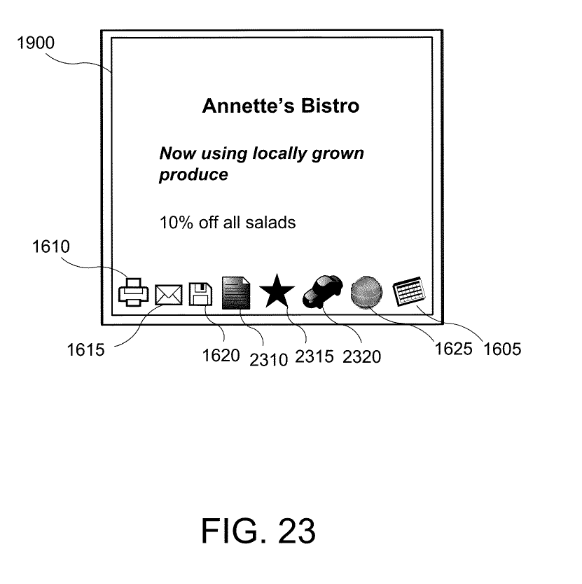

FIG. 23 shows an example of a displayed content item including a variety of options. In this instance, a content item 1900 identifies that an update about a merchant characteristic and a discount. In addition to the options shown in FIG. 16A, FIG. 23 also includes representations of a view-menu option 2310, a view-reviews option 2315 and a delivery option 2320.

Selection of view-menu option 2310 can cause a menu to be displayed, where the menu is associated with a channel associated with displayed content item 1900. Thus, in this case, a menu for Annette's Bistro can be presented. In some instances, the menu is presented as a channel content item. In some instances, the device displays a webpage with the menu. The menu may, or may not, be interactive. The menu may be one corresponding to a time of day at which the option was selected. For example, a selection between a lunch or dinner menu may be made based on the time of the selection.

Selection of view-reviews option 2315 may identify an overall rating of the restaurant and/or specific reviews of the restaurant. The rating may be based on one or more user reviews and/or an estimated review of the user (e.g., based on past reviews from the user, a location of the user, channel selections made by the user, user preferences, etc.).

Selection of delivery option 2320 can cause an interface to be presented where a user can submit a delivery order. In some instances, delivery option 2320 and view-menu option 2310 are combined, such that selection of the combined option presents an interactive menu. In some instances, delivery option 2320 or another option is associated with the capability of placing an order for carry-out.

Thus, FIG. 23 illustrates that channel content presentation may be associated with a variety of action calls. Not only can a channel be used to distribute information to subscribers, but a channel can be used to facilitate user action related to the channel.

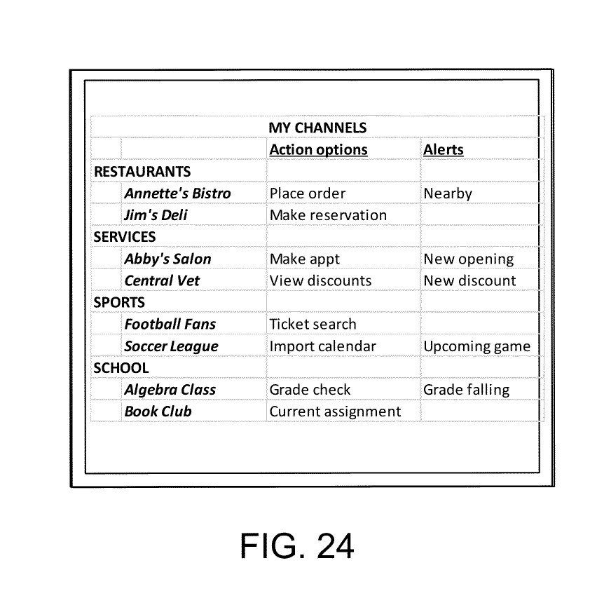

FIG. 23 illustrates an embodiment in which actions are presented in a manner tied to a particular channel. FIG. 24 shows an example of a displayed identifying action options and alerts for a plurality of channels. As shown, the action options and alerts can vary across channels.

In this instance, channels are categorized and presented to indicate their categorization. Each channel may be associated with zero, one or multiple action options. In the illustrated embodiment, each channel is associated with one action option. The action option(s) may be defined based on input from a publisher and/or a channel category.

Each channel may be also or alternatively be associated with zero, one or multiple action alerts. Alerts may be presented upon detection of a particular occurrence (e.g., a new discount offering, a new product offering, an above-threshold change in a value, a publisher input corresponding to an alert trigger, a below-threshold time before an event, etc.). For each channel, an occurrence that is to trigger each of one or more alerts can be defined by a publisher, defined by a subscriber, and/or set to a default, and so on.

In the channel summary presentation shown in FIG. 24, a subscriber may be able to select a representation or enter other input to change a level of detail presented. For example, the user may select the “Restaurants” text, such that increased detail about each restaurant channel is shown (e.g., to show more action options or more information about each channel). Category views may allow the user to choose between similar action options corresponding to different in-category channels. To illustrate, each of some or all restaurant channels may be associated with an option to view a menu and/or place an order. Further, from the summary view, a user may navigate to access saved or unsaved content items from a channel. This may allow the user to determine whether a discount has been offered, whether there is any news for the channel, etc. Such action may change a device's state to a display state (e.g., which may be restricted to or biased towards content items from a selected channel) or the user may be allowed to view the content items without changing a device's state.

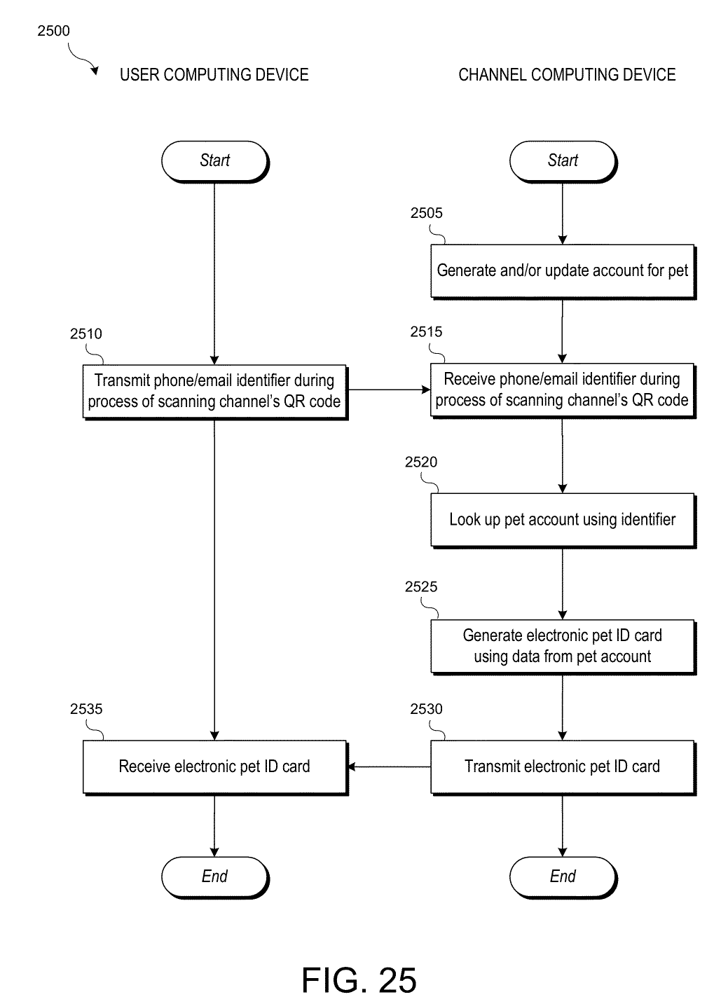

FIG. 25 illustrates an example flow diagram of a process 2500 for using channel technology to distribute electronic pet identification cards. Some portions of process 2500 can be performed by a first user computing device (e.g., a content-creation computing device 140, a content-display computing device 150), and other portions can be performed by a second channel computing device.

The first user computing device may include a mobile device associated with a user. The second channel computing device may include a mobile or non-mobile device that is associated with a channel-associated location. In one instance, the second channel computing device includes one that receives data from the first computing device while (or in response to) the first computing device scanning a channel code and/or subscribing to a channel. In some instances, the second channel computing device is located at a physical location associated with a channel, such as a service-providing and/or retail location. In some instances, the second channel computing device is associated with a pet channel, a vet channel, a vet company, etc.

Process 2500 begins at block 2505 where the channel computing device generates, updates and/or accesses an account for a pet. The account can include, for example, an animal type, an animal name, an animal name, one or more past or current medical conditions experienced by the animal, one or more past or current medications taken by the animal, one or more past or future appointment dates for the animal, an animal age, an animal breed, an owner name, an owner phone number, an owner email address, an owner address, an owner's payment information, and so on. The account can be updated, for example, during or after visits to update health data, appointment history, and/or animal characteristics. Such updating can be the result of transmission from other electronic devices or manually entered inputs.

At blocks 2510 and 2515, an identifier is transmitted from a user computing device to the channel computing device. This transmission can occur, for example, during a process of subscribing to a channel associated with the channel computing device, scanning a code (e.g., a QR code) associated with the channel, requesting or receiving channel content or information using short-range communication, etc.

In one instance, user computing device scans a QR code in order to subscribe to a channel. The scan can automatically cause information to be transmitted from the user computing device to the channel computing device or it can prompt a user of the user computing device to send and/or authorize such transmission (e.g., by displaying a request to enter a phone number and send the phone number to the channel computing device). The transmission may occur using short-range communication, text message, email message, short message service (SMS), etc.

At block 2520, the channel computing device uses the identifier to look up the pet account amongst a plurality of accounts. The pet account can include the identifier (e.g., as an owner phone number or email address), such that a plurality of accounts can be searched for one or more with an identifier match.

At block 2525, an electronic pet identification card is generated using data from the pet account. The electronic pet identification card can include data from the account. The data can relate to the pet and/or an owner. For example, the card can include a name of the pet, a picture of the pet, any conditions of the pet, any medications that the pet is taking or is to take (e.g., and a prescribed regiment), a date and time of a next appointment, a name of the owner, a phone number of the owner, and so on. The electronic pet identification card can also include information about the channel and/or publisher. For example, the card can include a name and phone number of the pet's vet (associated with the channel).

At blocks 2530 and 2535, the electronic pet ID card is transmitted from the channel computing device to user computing device. This transmission also can occur, for example, during a process of subscribing to a channel associated with the channel computing device, scanning a code (e.g., a QR code) associated with the channel, requesting or receiving channel content or information using short-range communication, etc. Thus, the transmission of the pet ID card can occur shortly after the transmission of the identifier in block 2510 (e.g., within a minute or ten seconds).

Subsequent to the transmission, some or all data in the electronic pet ID card and/or a representation of part or all of the card may be presented. The pet ID card may be configured such that a user can select an option to print the card and/or edit data in the card. Fields in the card may be definable by a channel publisher (or other entity associated with a channel), a service provider and/or a user.

In one instance, a user may select an option to share or forward the electronic pet ID card. For example, the user may enter a phone number or email address and the ID card can be forwarded accordingly. As another example, the user may bump a user device with another device, or a code may be displayed on a user device such that it can be read by another device. In some instances, the electronic pet ID card (or data therein) is forwarded upon receiving a request for it from another device. The user may, or may not, be required to enter input approving the share.

Though not shown in FIG. 25, channel computing device can routinely, periodically or conditionally update the electronic pet ID card (e.g., when a new appointment is made, a new conditioned is diagnosed, or a new prescription is prescribed). The updated pet ID card can then be transmitted to the user computing device.

The electronic card can serve a variety of purposes. The card may aid an owner in tracking a pet's conditions, appointment scheduling, prescription regimen, etc. The card may allow the owner to interact with a pet app to view information and/or recommendations tailored to the pet's breed, age, health, etc.

In some instances, the card may be used to customize channel content. For example, select content items may be locally selected for display or select content items may be requested from a content delivery/receiving server based on data in the card. To illustrate, for an owner with a pet ID card that indicates that he owns a dog, only those animal-specific content items from a vet channel that relate to dogs may be shown.

The card may also be used to allow a vet or channel provider to customize a channel. For example, a content item may be generated (e.g., at a server or at a user device) to reflect a date of an appointment or a need to schedule a follow-up appointment. To illustrate, a vet computing device may initiate transmission of each of a set of subscribers next appointment date to a server, which can then send it to individual user computing devices. The server can also send an appointment-reminder content item template to the user computing device, and the user computing device can then generate a custom appointment-reminder content item. This item can be presented on select dates or with varied frequencies or probabilities depending on a present date. In some instances, destinations of the content item may even allow for a user to confirm an appointment, change an appointment or otherwise communicate with a channel entity (e.g., to report an update on a condition or ask a question about a prescription).

In another instance, the user computing device may include an electronic device that can be attached to or worn by a pet (e.g., by attaching it to a collar). The electronic card may be configured such that data from it appears as a home screen or upon receiving particular input (e.g., a button press). Thus, if the pet is lost, the information from the tag can be used by a finder to help reunite the pet with his owner. In such situation, the owner, vet office or other party may be able to further modify the card to reflect that the pet is lost and request assistance.

In yet another instance, the card may serve to provide data to a person or entity with limited familiarity with the pet. For example, a first vet may be a normal vet for a pet. However, when traveling, an owner may need to visit a second vet. Transmission of data from the first vet to an electronic pet ID card on a user device can allow the user to provide pertinent data to the second vet. As another example, an owner may send a pet ID card to a pet-sitter.

While process 2500 focuses on a pet ID card, other types of cards are contemplated. For example, an electronic card may relate to a human patient (e.g., showing medical conditions, contact information for one or more medical providers, allergies, prescriptions, medical history, etc.), to an investment account (e.g., showing current investments, recommended investments, current account amount, etc.), to an academic course (e.g., showing homework, current grade, etc.), etc.

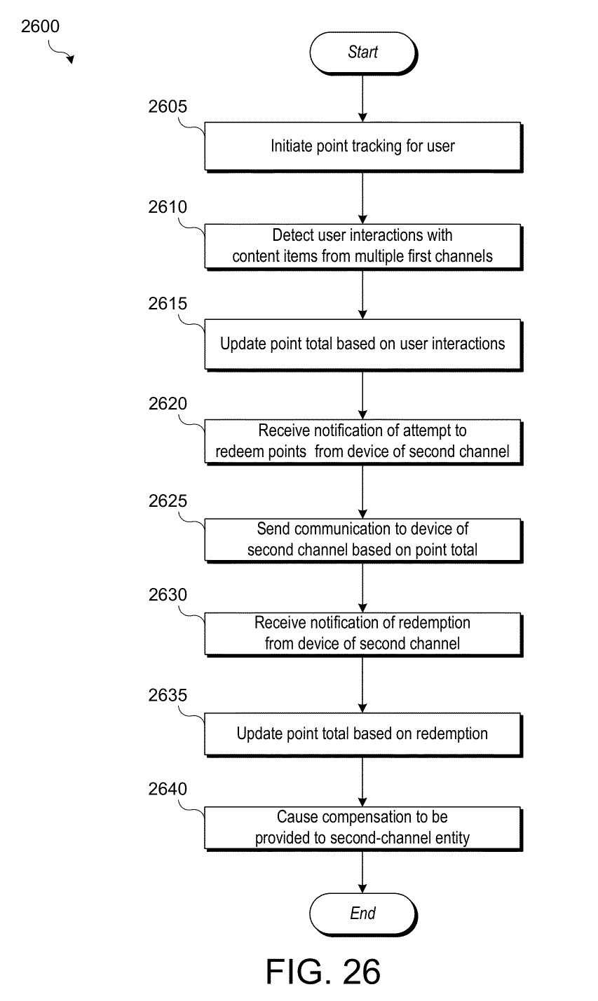

FIG. 26 illustrates an example flow diagram of a process 2600 for managing channel-associated points according to an embodiment of the present invention. As shown, part or all of process 2600 can be performed by a server (e.g. a publishing server 110 and/or a content delivery/receiving server 120).

Process 2600 begins at block 2605 where point tracking for a user is initiated. The initialization can include setting a point total to zero or another value. The initialization can occur, e.g., in response to a user downloading a channel app, setting up a profile, subscribing to a channel, requesting point initialization, etc.

At block 2610, for each of a plurality of first channels, a user interaction with a content item for that channel is detected. Block 2610 may be performed over a period of time. That is, individual interactions may be detected at different times. In some instances, the user or device of the user is subscribed to each of the first channels.

Interactions can include, for example, viewing the item, saving the item, sharing the item, printing the item, requesting a destination for the item, and so on. In some instances, interactions are not tied to individual content items. Rather, for example, an interaction may including viewing channel content (e.g., multiple content items) for a period of time.

Each interaction can be associated with a point quantity. For example, viewing a content item may result in 1 point; saving a content item may result in an additional 2 points; clicking on a content item to visit a destination for the item may result in 3 points; and making a purchase at the destination may result in 10 pointes.

The point quantity for a particular type of interaction (e.g., viewing a content item) may be fixed or may vary across channels. In some instances, a publisher has partial or full control of the point quantity to award for a given type of interaction. Typically, point quantities for a given type of interaction may be fixed generally or for a given channel. However, in some instances, the point quantities may vary. For example, a point quantity may pseudo-randomly vary around a default value to add an element of unpredictability. As another example, a point quantity may relate to a value associated with a content item (e.g., a price of a product or service being advertised, a price paid by the publisher to upload or display the content item, etc.).

At block 2615, a point total for the user is updated based on the user interactions. It will be appreciated that the total may be repeatedly updated upon detection of each interaction. The updating can include adding a point quantity associated with a detected interaction to the point total.

At block 2620, a notification is received or a detection is otherwise made that the user is attempting to redeem points, e.g., to use to purchase a product or service offered in association with a second channel. For example, the user may be attempting to redeem the points to make a purchase at a webpage that the user arrived at by requesting a destination for a content item. As another example, the user may be attempting to redeem the points to make a purchase at a webpage associated with a channel. As yet another example, the user may be attempting to redeem the points at a physical location (e.g., store) associated with a channel.

In some instances, the multiple first channels include the second channel. In some instances, the second channel is different than any of the multiple first channels. The user (or device of the user) may, or may not (depending on the embodiment), be subscribed to the second channel.

While typically, point redemption will include making a purchase, other types of redemption are contemplated. For example, points may be redeemed to improve a shipping speed, to improve a purchasing priority, to become a member of a club, to increase a virtual score, to improve a quality of a product or service, etc.

The notification may include an identification of a user or user device and indication as to how many points the user is attempting to redeem and/or what such a redemption would cause (e.g., offset of product or service price). Upon receiving the notification, a point total for the user or user device can be retrieved. The quantity of points of the attempted redemption can the be compared to the point total.

At block 2625, a communication is sent to the second-channel device, the communication being based on the point total. For example, the communication may include the point total. As another example, the communication may indicate whether the point total exceeds the points of the attempted redemption. As another example, the communication may indicate whether the attempted redemption is authorized or is rejected.

A notification of redemption is received from the device associated with the second channel indicating that the points have been redeemed. This may indicate, e.g., that a merchant provided a discount or other offering to the user. The notification may also include an identification of a user or user device, an identification of an entity that provided the redemption, and/or a quantity of points redeemed.

The point total is updated at block 2630 based on the notification at block 2630. The update can include subtracting the quantity of redeemed points from the point total for the identified user.

At block 2635, the server can cause compensation to be provided to an entity associated with the redemption and/or second channel. The compensation can include, e.g., a discount on a channel-related service, a payment, an upgrade of a channel-related service (e.g., to bias towards presentation of the second channel or to allow a publisher for the second channel to upload more content items or content items of particular types (e.g., videos, high-resolution images, etc.).

While process 2600 can be performed by a server involved in management of a channel service, part or all of process 2600 can alternatively by a user device.

It is understood that the various embodiments described herein are by way of example only, and are not intended to limit the scope of the invention. For example, many of the materials and structures described herein may be substituted with other materials and structures without deviating from the spirit of the invention. The present invention as claimed may therefore include variations from the particular examples and preferred embodiments described herein, as will be apparent to one of skill in the art. It is understood that various theories as to why the invention works are not intended to be limiting.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

Although many embodiments were described above as comprising different features and/or combination of features, a person of ordinary skill in the art after reading this disclosure may understand that in some instances, one or more of these components could be combined with any of the components or features described above. That is, one or more features from any embodiment can be combined with one or more features of any other embodiment without departing from the scope of the invention.

As noted previously, all measurements, dimensions, and materials provided herein within the specification or within the figures are by way of example only.

A recitation of “a,” “an,” or “the” is intended to mean “one or more” unless specifically indicated to the contrary. Reference to a “first” component does not necessarily require that a second component be provided. Moreover reference to a “first” or a “second” component does not limit the referenced component to a particular location unless expressly stated.

1. A computer-implemented method, comprising:
receiving, from each of a set of subscriber computing devices, a request to subscribe to a channel and thereby to periodically receive content items of the channel to be displayed at a subscriber computing device when the subscriber computing device is in a display state, wherein the display state is one entered by the subscriber computing device upon detecting, at least, a lack of user input for a threshold period of time or that a particular program is not active;
transmitting a content item with a calendar option to each of the set of subscriber computing devices, wherein the content item corresponds to the channel, and wherein the transmitting the content item with the calendar option facilitates a concurrent presentation of the content item and the calendar option;
receiving a calendar-option communication from a subscriber computing device in the set of subscriber computing devices that indicates that the calendar option has been selected at the subscriber computing device;
in response to receiving the calendar-option communication, accessing calendar information from an electronic calendar associated with the channel, wherein the calendar information identifies one or more availabilities in the electronic calendar
transmitting the calendar information with a reservation option to the subscriber computing device, wherein the calendar information identifies the availability in the electronic calendar;
receiving one or more reservation communications from the subscriber computing device that indicates that the reservation option has been selected at the subscriber computing device and corresponding to a request to claim an availability of the one or more availabilities in the calendar; and
facilitating adding a reservation o the electronic calendar, such that the calendar no longer includes the availability.

2. (canceled)

3. The computer-implemented method of claim 1, further comprising:
in response to receiving the one or more reservation communications transmitting a second communication to at least one subscriber computing device in the set of subscriber computing devices that inhibits subsequent presentation identifying the availability in the calendar.

4. The computer-implemented method of claim 1, further comprising:
detecting the availability in the calendar;
determining that the availability is associated with a time or date within a defined time period; and
determining that a calendar-option condition is satisfied due to the availability being associated with the time or date within the defined time period,
wherein the transmission of the content item with the calendar option occurs in response to the determining that the condition is satisfied.

5. The computer-implemented method of claim 1, further comprising:
detecting a new cancellation corresponding to the electronic calendar;
in response to detecting the new cancellation, transmitting an identification of a new availability corresponding to the new cancellation to another subscriber computing device in the set of subscriber computing devices.

6. The computer-implemented method of claim 1, wherein the calendar information includes an image of a calendar that identifies, for each of at least one of the one or more availabilities, a part of the calendar corresponding to the availability.

7. (canceled)

8. The computer-implemented method of claim 1, wherein the availability is associated with a date and a time of day.

9. A system, comprising:
one or more data processors; and
a non-transitory computer readable storage medium containing instructions which when executed on the one or more data processors, cause the one or more data processors to perform actions including:
receiving, from each of a set of subscriber computing devices, a request to subscribe to a channel and thereby to periodically receive content items of the channel to be displayed at a subscriber computing device when the subscriber computing device is in a display state, wherein the display state is one entered by the subscriber computing device upon detecting, at least, a lack of user input for a threshold period of time or that a particular program is not active;
transmitting a content item with a calendar option to each of the set of subscriber computing devices, wherein the content item corresponds to the channel, and wherein the transmitting the content item with the calendar option facilitates a concurrent presentation of the content item and the calendar option;
receiving a calendar-option communication from a subscriber computing device in the set of subscriber computing devices that indicates that the calendar option has been selected at the subscriber computing device;
in response to receiving the calendar-option communication, accessing calendar information from an electronic calendar associated with the channel, wherein the calendar information identifies one or more availabilities in the electronic calendar
transmitting the calendar information with a reservation option to the subscriber computing device, wherein the calendar information identifies the availability in the electronic calendar;
receiving one or more reservation communications from the subscriber computing device that indicates that the reservation option has been selected at the subscriber computing device and corresponding to a request to claim an availability of the one or more availabilities in the calendar; and
facilitating adding a reservation o the electronic calendar, such that the calendar no longer includes the availability.

10. (canceled)

11. The system of claim 9, wherein the actions further include:
in response to receiving the one or more reservation communications transmitting a second communication to at least one subscriber computing device in the set of subscriber computing devices that inhibits subsequent presentation identifying the availability in the calendar.

12. The system of claim 9, wherein the actions further include:
detecting the availability in the calendar;
determining that the availability is associated with a time or date within a defined time period; and
determining that a calendar-option condition is satisfied due to the availability being associated with the time or date within the defined time period,
wherein the transmission of the content item with the calendar option occurs in response to the determining that the condition is satisfied.

13. The system of claim 9, wherein the actions further include:
detecting a new cancellation corresponding to the electronic calendar;
in response to detecting the new cancellation, transmitting an identification of a new availability corresponding to the new cancellation to another subscriber computing device in the set of subscriber computing devices.

14. The system of claim 9, wherein the calendar information includes an image of a calendar that identifies, for each of at least one of the one or more availabilities, a part of the calendar corresponding to the availability.

15. (canceled)

16. The system of claim 9, wherein the availability is associated with a date.

17. A computer-program product tangibly embodied in a non-transitory machine-readable storage medium, including instructions configured to cause one or more data processors to perform actions including:
receiving, from each of a set of subscriber computing devices, a request to subscribe to a channel and thereby to periodically receive content items of the channel to be displayed at a subscriber computing device when the subscriber computing device is in a display state, wherein the display state is one entered by the subscriber computing device upon detecting, at least, a lack of user input for a threshold period of time or that a particular program is not active;
transmitting a content item with a calendar option to each of the set of subscriber computing devices, wherein the content item corresponds to the channel, and wherein the transmitting the content item with the calendar option facilitates a concurrent presentation of the content item and the calendar option;
receiving a calendar-option communication from a subscriber computing device in the set of subscriber computing devices that indicates that the calendar option has been selected at the subscriber computing device;
in response to receiving the calendar-option communication, accessing calendar information from an electronic calendar associated with the channel, wherein the calendar information identifies one or more availabilities in the electronic calendar
transmitting the calendar information with a reservation option to the subscriber computing device, wherein the calendar information identifies the availability in the electronic calendar;
receiving one or more reservation communications from the subscriber computing device that indicates that the reservation option has been selected at the subscriber computing device and corresponding to a request to claim an availability of the one or more availabilities in the calendar; and
facilitating adding a reservation o the electronic calendar, such that the calendar no longer includes the availability.

18. (canceled)

19. The computer-program product of claim 17, wherein the actions further include:
detecting the availability in the calendar;
determining that the availability is associated with a time or date within a defined time period; and
determining that a calendar-option condition is satisfied due to the availability being associated with the time or date within the defined time period,
wherein the transmission of the content item with the calendar option occurs in response to the determining that the condition is satisfied.

20. The computer-program product of claim 17, wherein the actions further include:
detecting a new cancellation corresponding to the electronic calendar;
in response to detecting the new cancellation, transmitting an identification of a new availability corresponding to the new cancellation to another subscriber computing device in the set of subscriber computing devices.

21. The computer-implemented method of claim 1, wherein the concurrent presentation of the content item and the calendar option includes concurrently presenting a graphical representation of the calendar option and the content item.

22. The computer-implemented method of claim 1, wherein the content item identifies a promotion or notification.

23. The computer-implemented method of claim 1, wherein the one or more availabilities includes a plurality of availabilities.

24. The computer-implemented method of claim 1, wherein the one or more reservation communications indicate that a discount that was been presented on the subscribing computing device via another content item of the channel is to be applied in association with the reservation.

25. The system of claim 9, wherein the concurrent presentation of the content item and the calendar option includes concurrently presenting a graphical representation of the calendar option and the content item.

26. The system of claim 9, wherein the content item identifies a promotion or notification.

27. The system of claim 9, wherein the one or more availabilities includes a plurality of availabilities.

28. The system of claim 9, wherein the one or more reservation communications indicate that a discount that was been presented on the subscribing computing device via another content item of the channel is to be applied in association with the reservation.
